(19) United States
(12) Patent Application Publication
(10) Pub. No.: US 2009/0177607 A1
(43) Pub. Date: Jul. 9, 2009

(54) SITUATION PRESENTATION SYSTEM, SERVER, AND COMPUTER-READABLE MEDIUM STORING SERVER PROGRAM

(75) Inventor: Mika MATSUSHIMA, Inazawa-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/409,319

(22) Filed: Mar. 23, 2009

Related U.S. Application Data
(63) Continuation-in-part of application No. PCT/JP2007/066004, filed on Aug. 17, 2007.

(30) Foreign Application Priority Data
Sep. 29, 2006 (JP) 2006-269188

(51) Int. Cl. G06N 5/02; G06F 15/16; G06F 17/00; G06F 7/06

(52) U.S. Cl. 706/46; 709/203; 707/100; 707/4; 715/233; 715/205; 709/206; 707/E17.044; 707/E17.014

(57) ABSTRACT

A situation presentation system includes a terminal and a server. The terminal includes a situation data acquisition device that acquires situation data and a terminal transmission device that transmits the situation data to the server. The server includes a server situation data storage device that stores the situation data transmitted from the terminal, a content storage device that stores a content including a character string, a condition determination device that analyzes the character string included in the content to determine a situation data condition, a situation data extraction device that extracts the situation data that satisfies the situation data condition from the server situation data storage device, a content update device that stores the analyzed content into the content storage device after adding at least one of edited data and the extracted situation data to the content, and a presentation device that presents the content.

### CROSS-REFERENCE TO RELATED APPLICATION

This application is a continuation-in-part of International Application No. PCT/JP2007/066004, filed Aug. 17, 2007, which claims priority from Japanese Patent Application No. 2006-269188, filed on Sep. 29, 2006. The disclosure of the foregoing application is hereby incorporated by reference in its entirety.

### BACKGROUND OF THE INVENTION

The present disclosure relates to a situation presentation system that presents situation data including emotion information about a user holding a terminal and/or environment information about an environment around the terminal, a server, and a computer-readable medium storing a server program.

A content on the World Wide Web (hereinafter, referred to simply as a “Web content”) such as a Weblog and Web news is known. Such a Web content can now be referenced by a mobile communication terminal and is widely used as an information exchange means or an information dissemination means. There may a desire to construct a system that easily allows a reader to know emotions of a person who posted an article in such a Web content, who appears in the article, or who lives in a neighborhood of a place that appears in the article, so that the reader can feel closer to the article. The reader may also wish to know an environment of the place that appears in the article. To make it easier for the reader to know the emotions of the person or the environment of the place that appears in the article, for example, emotion information such as delight, anger, sorrow and pleasure, or environment information such as liveliness or stillness in the surroundings of the place may be displayed. According to such a system, because the reader may know the emotions of the person or the environment of the place by referencing the Web content, the reader may feel closer to the Web content.

Thus, in recent years, various services have been proposed to represent emotions of a user in a Web content. For example, an information communication system including a mobile communication terminal and a non-language information control server, an information communication method, and a computer program are proposed (See Japanese Patent Application Laid-Open Publication No. 2003-110703). The non-language information control server includes a database storing non-language information (emotion information) of a user of each terminal and a database storing map information. In the information communication system, the non-language control server transmits the non-language information of each user and the map information to the mobile communication terminal, in response to a request from the mobile communication terminal. The mobile communication terminal receives the non-language information and the map information transmitted from the non-language control server. Then, the mobile communication terminal creates distribution data of the non-language information based on the received non-language information, and displays the distribution data on the map information. According to the information communication system, the user of the mobile communication terminal may easily know emotions of others by making a request to the non-language control server via the mobile communication terminal.

### SUMMARY OF THE INVENTION

According to the above conventional technology, however, only when the non-language control server is requested of the non-language information via the mobile communication terminal, the distribution data of the non-language information created based on the non-language information may be displayed on the map information. Thus, when, for example, a substance of the Web content is updated or added, display of the emotion information and the environment information may not be updated or added automatically in accordance with the substance of the update or addition. Thus, to add the emotion information or the environment information to the Web content, the user may need to select suitable information in accordance with the substance of the Web content and add the selected information to the content, which may be troublesome work for the user.

It is an object of the present disclosure to provide a situation presentation system, a server, and a computer-readable medium storing a server program capable of reducing labors of a user to add information about an emotion or a surrounding environment of the user to a content stored in a server, in accordance with a substance of the content.

Various exemplary embodiments of the general principles described herein provide a situation presentation system that includes a terminal and a server that accumulates information transmitted from the terminal. The terminal includes a situation data acquisition device and a terminal transmission device. The situation data acquisition device acquires situation data including at least one of body information of a user holding the terminal, emotion information inferred from the body information, surrounding information of the terminal, and environment information inferred from the surrounding information. The terminal transmission device transmits the situation data acquired by the situation data acquisition device and terminal identification information to the server. The terminal identification information is information to distinguish the terminal from other terminals. The server includes a server situation data storage device, a content storage device, a condition determination device, a situation data extraction device, a content update device, and a presentation device. The server situation data storage device stores the situation data transmitted from the terminal transmission device. The content storage device stores a content including a character string. The condition determination device analyzes the character string included in the content stored in the content storage device to determine a situation data condition. The situation data condition is an extraction condition for extracting the situation data. The situation data extraction device extracts the situation data that satisfies the situation data condition determined by the condition determination device as extracted situation data from the situation data stored in the server situation data storage device. The content update device stores the content analyzed by the condition determination device into the content storage device after adding at least one of edited data and the extracted situation data extracted by the situation data extraction device to the content. The edited data is obtained by performing editing processing on the extracted situation data by a predetermined method. The presentation device presents the content stored in the content storage device.

Exemplary embodiments also provide a server that accumulates information transmitted from a terminal. The server includes a situation data storage device, a content storage device, a condition determination device, a situation data extraction device, a content update device, and a presentation device. The situation data storage device stores situation data transmitted from the terminal. The situation data includes at least one of body information of a user holding the terminal, emotion information inferred from the body information, surrounding information of the terminal, and environment information inferred from the surrounding information. The content storage device stores a content including at least a character string. The condition determination device analyzes the character string included in the content stored in the content storage device to determine at least one situation data condition. The situation data condition is an extraction condition for extracting the situation data. The situation data extraction device extracts the situation data that satisfies the situation data condition determined by the condition determination device as extracted situation data from the situation data stored in the server situation data storage device. The content update device stores the content analyzed by the condition determination device after adding at least one of edited data and the extracted situation data extracted by the situation data extraction device to the content. The edited data is obtained by performing editing processing on the extracted situation data by a predetermined method. The presentation device that presents the content stored in the content storage device.

Other objects, features, and advantages of the present disclosure will be apparent to persons of ordinary skill in the art in view of the following detailed description of embodiments of the invention and the accompanying drawings.

Exemplary embodiments further provide a computer-readable medium storing a server program that causes a controller of a server that accumulates information transmitted from a terminal to execute an instruction of analyzing a character string included in a content stored in a content storage device to determine at least one situation data condition. The situation data condition is an extraction condition for extracting situation data from a situation data storage device that stores situation data transmitted from the terminal. The situation data includes at least one of body information of a user holding the terminal, emotion information inferred from the body information, surrounding information of the terminal, and environment information inferred from the surrounding information. The program also causes the controller to execute instructions of extracting the situation data that satisfies the determined situation data condition as extracted situation data from the situation data stored in the situation data storage device, and storing the analyzed content after adding at least one of edited data and the extracted situation data. The edited data is obtained by performing editing processing on the extracted situation data by a predetermined method. The program further causes the controller to execute an instruction of presenting the content stored in the content storage device.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

FIG. 1 is an explanatory diagram for illustrating a configuration of a situation presentation system.

FIG. 2 is an outline view of a terminal in an unfolded state.

FIG. 3 is a bottom view of the terminal in a folded state.

FIG. 4 is a block diagram illustrating an electrical configuration of the terminal.

FIG. 5 is a conceptual diagram illustrating a configuration of storage areas of a RAM.

FIG. 6 is a conceptual diagram illustrating a configuration of storage areas of a hard disk drive.

FIG. 7 is a conceptual diagram illustrating an electrical configuration of a management server.

FIG. 8 is a conceptual diagram illustrating an electrical configuration of a content server.

FIG. 9 is a flowchart of main processing of the terminal.

FIG. 10 is a flowchart of measurement processing started in the main processing.

FIG. 11 is an explanatory diagram exemplifying measured values of various sensors acquired during the measurement processing.

FIG. 12 is a flowchart of flag processing performed in the measurement processing.

FIG. 13 is a flowchart of emotion information inference processing performed by the main processing.

FIG. 14 is a flowchart of heart rate classification processing performed in the emotion information inference processing shown in FIG. 13.

FIG. 15 is a flowchart of body temperature classification processing performed in the emotion information inference processing shown in FIG. 13.

FIG. 16 is a flowchart of sweat rate classification processing performed in the emotion information inference processing shown in FIG. 13.

FIG. 17 is an explanatory diagram illustrating an emotion information table to be referenced in the emotion information inference processing shown in FIG. 13.

FIG. 18 is a flowchart of environment information inference processing performed in the main processing.

FIG. 19 is an explanatory diagram exemplifying measured values of the various sensors acquired during the measurement processing.

FIG. 20 is a flowchart of temperature classification processing performed in the environment information inference processing shown in FIG. 18.

FIG. 21 is a flowchart of humidity classification processing performed in the environment information inference processing shown in FIG. 18.

FIG. 22 is a flowchart of illuminance classification processing performed in the environment information inference processing shown in FIG. 18.

FIG. 23 is a flowchart of volume classification processing performed in the environment information inference processing shown in FIG. 18.

FIG. 24 is an explanatory diagram illustrating an environment information table to be referenced in the environment information inference processing shown in FIG. 18.

FIG. 25 is an explanatory diagram illustrating situation data stored in the management server.

FIG. 26 is a flowchart of main processing of the content server.

FIG. 27 is a flowchart of update determination processing performed in the main processing shown in FIG. 26.

FIG. 28 is an explanatory diagram exemplifying a content updated by the content server of Example 3.

FIG. 29 is a flowchart of updated data analysis processing performed in the main processing shown in FIG. 26.

FIG. 30 is an explanatory diagram illustrating a terminal analysis dictionary to be referenced in the updated data analysis processing in FIG. 29.

FIG. 31 is an explanatory diagram illustrating a time analysis dictionary to be referenced in the updated data analysis processing in FIG. 29.

FIG. 32 is an explanatory diagram illustrating a position analysis dictionary to be referenced in the updated data analysis processing in FIG. 29.

FIG. 33 is an explanatory diagram illustrating an icon table.

FIG. 34 is an explanatory diagram illustrating a screen displayed on a browser that shows a content to which icons as edited data are added.

FIG. 35 is an explanatory diagram illustrating a screen displayed on the browser that shows a content to which link information indicating a location of an icon is added.

FIG. 36 is a flowchart of comment processing performed by the content server in a third embodiment.

FIG. 37 is an explanatory diagram illustrating a comment to an entry in Example 3.

FIG. 38 is an explanatory diagram illustrating a screen displayed on the browser that shows comments to which icons as edited data are added.

FIG. 39 is a flowchart of first main processing of the management server.

FIG. 40 is a flowchart of second main processing of the management server.

FIG. 41 is a flowchart of situation data extraction processing performed in the second main processing shown in FIG. 40.

FIG. 42 is a flowchart of edited data creation processing performed in the second main processing shown in FIG. 40.

FIG. 43 is a flowchart of edited data creation processing in a second embodiment performed in the second main processing shown in FIG. 40.

FIG. 44 is an explanatory diagram illustrating a graph created in the edited data creation processing shown in FIG. 43.

FIG. 45 is an explanatory diagram illustrating a screen displayed on the browser that shows a Weblog content to which edited data is added.

FIG. 46 is an explanatory diagram illustrating a screen displayed on the browser that shows the Weblog content to which edited data is added in processing of a sixth modified embodiment.

FIG. 47 is an explanatory diagram illustrating a screen displayed on the browser that shows a Weblog content to which edited data is added in processing of a seventh modified embodiment.

FIG. 48 is an explanatory diagram illustrating a screen displayed on the browser that shows news articles to which edited data is added in processing of the modification 7.

FIG. 49 is an explanatory diagram illustrating main processing of the content server in the third embodiment.

FIG. 50 is a flowchart of blank processing performed in the main processing in FIG. 49.

FIG. 51 is an explanatory diagram illustrating a screen for transmitting an entry to the content server.

FIG. 52 is an explanatory diagram illustrating edited data transmitted to a mobile terminal specified by an author of the content in the blank processing.

FIG. 53 is an explanatory diagram illustrating a screen 820 in which position information and time information corresponding to extracted edited data are provided.

### DETAILED DESCRIPTION OF THE EXEMPLARY EMBODIMENTS

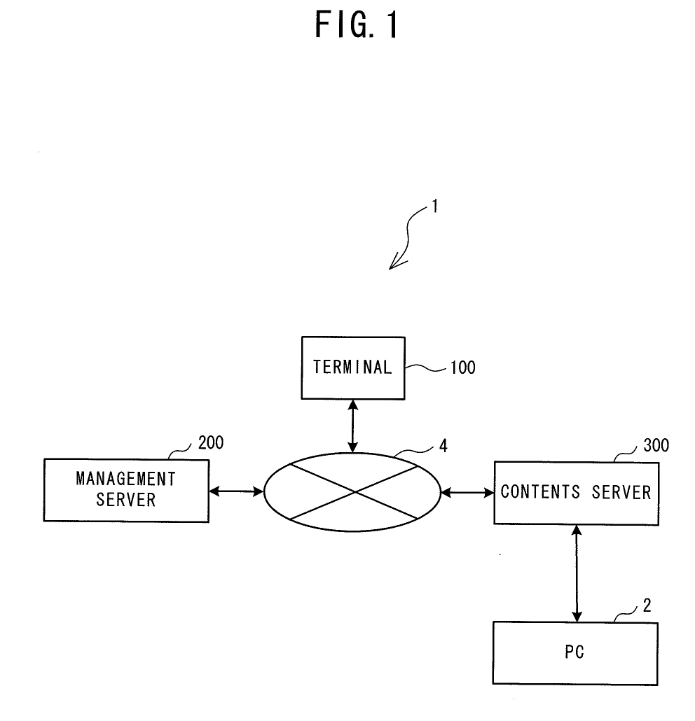

Embodiments of the present invention and their features and technical advantages may be understood by referring to FIGS. 1 to 53, like numerals being used for like corresponding portions in the various drawings.

First to third exemplary embodiments will be described below with reference to the drawings. First, a configuration of a situation presentation system 1 in the first embodiment will be described with reference to FIGS. 1 to 8. As shown in FIG. 1, the situation presentation system 1 in the first embodiment includes a terminal 100 and servers, that is, a management server 200 and a content server 300. The terminal 100, the management server 200, and the content server 300 may be connected via an Internet 4. Further, the content server 300 is configured so that a personal computer (hereinafter abbreviated as “PC”) 2 may be connected thereto. Although the number of each of the terminal 100, the management server 200, the content server 300, and the PC 2 shown in FIG. 1 is only one, the number of each component may be increased as necessary. The terminal 100, the management server 200, and the content server 300 included in the situation presentation system 1 will be described below in detail.

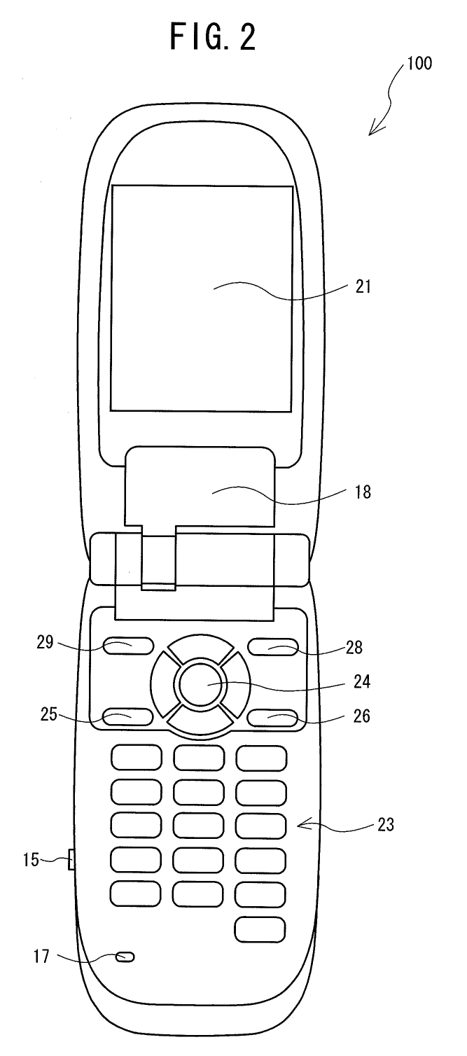

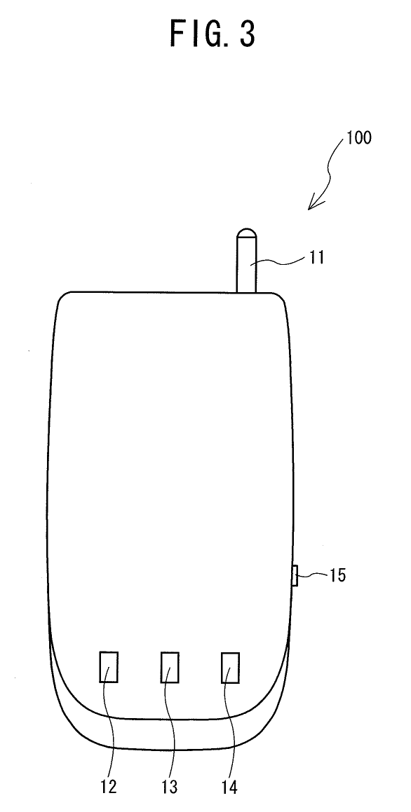

First, the physical configuration of the terminal 100 will be described with reference to FIGS. 2 and 3. The terminal 100 shown in FIGS. 2 and 3 may have a function as a mobile phone. In addition, the terminal 100 may obtain body information of a user using the terminal 100, or surrounding information of the terminal 100 from various sensors 12 to 17 provided to the terminal 100. Then, the terminal 100 may perform processing to transmit situation data to the management server 200. The situation data herein refers to information that includes at least one of the body information of the user, emotion information inferred from the body information, the surrounding information of the terminal 100, and environment information inferred from the surrounding information.

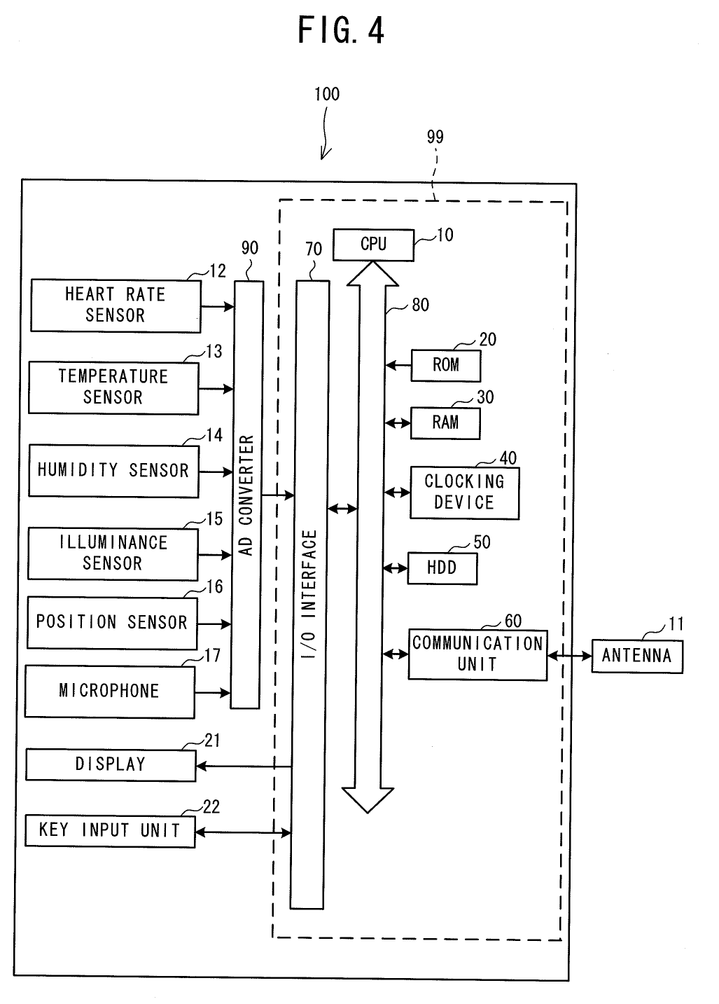

As shown in FIG. 2, the terminal 100 may be provided with a display 21, a microphone 17, a speaker 18, and an antenna 11 (See FIG. 3). Also, the terminal 100 may be provided with a key input unit 22 (See FIG. 4) including a ten-key input unit 23, a multi-button 24 including buttons in four directions and a decision button, a call start button 25, a call end button 26, a power-on button 29, and a power-off button 28. On a left-side surface of the terminal 100, an illuminance sensor 15 may be provided.

As shown in FIG. 3, a temperature sensor 13, a heart rate sensor 12 to obtain a heart rate of the user, and a humidity sensor 14 to measure a sweat rate of the user or a humidity around the terminal 100 may be provided on a bottom surface of the terminal 100 in a folded state. As shown in FIG. 3, the sensors 12 to 14 may be disposed where a palm of the user may touch when the user grips the terminal 100 to perform key operations.

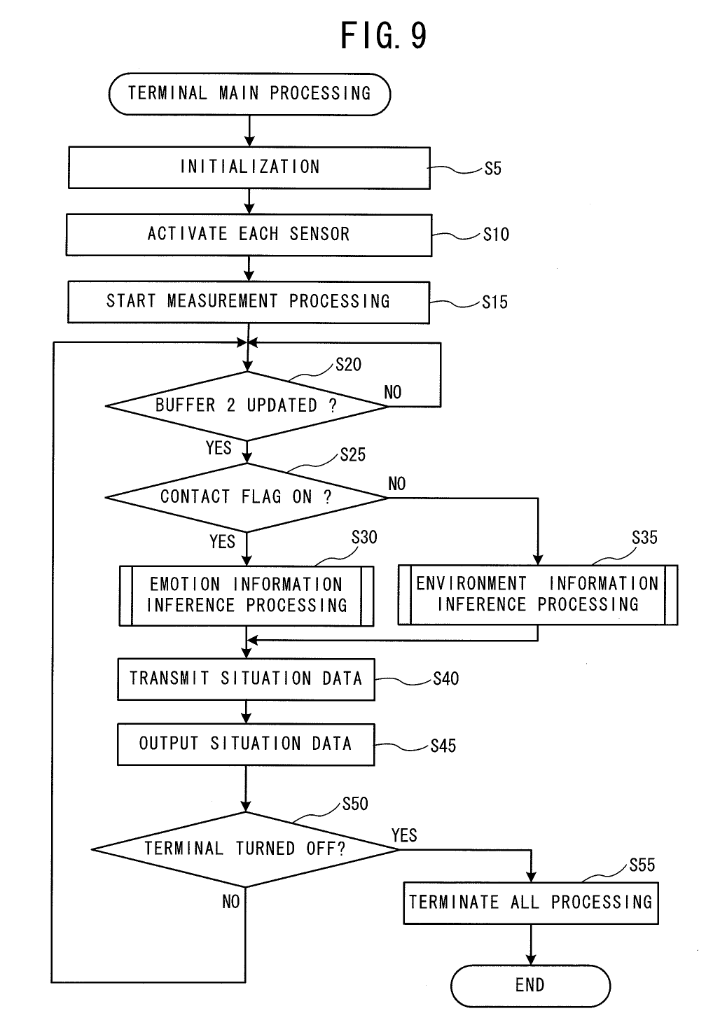

Next, an electrical configuration of the terminal 100 will be described with reference to FIG. 4. As shown in FIG. 4, the terminal 100 may be provided with a control unit 99. The control unit 99 may include a CPU 10 for controlling the terminal 100, a ROM 20, and the RAM 30, a clocking device 40 for measuring the time, a hard disk drive (HDD) 50, a communication unit 60, an I/O interface 70 for connecting various modules and the like. In the control unit 99, the ROM 20, the RAM 30, the clocking device 40, the hard disk drive (HDD) 50, the communication unit 60, and the I/O interface 70 may be connected to the CPU 10 via a bus 80. The communication unit 60 may be used for communication with the management server 200 and the content server 300 and connectable to the Internet 4 via the antenna 11. Although not shown, power may be supplied to the terminal 100 by a battery. A situation presentation program for executing various processing of the terminal 100 may be stored in the ROM 20. The processing will be described later with reference to FIGS. 9 to 25. The terminal 100 may have a flash memory, instead of the hard disk drive (HDD) 50.

The terminal 100 may also include an AD converter, 90 to which the various sensors 12 to 17 may be connected. The AD converter 90 may be connected to the CPU 10 via the I/O interface 70 and the bus 80. Measured values of analog data inputted from the various sensors 12 to 17 may be inputted into the control unit 99 after being converted into digital data by the AD converter 90. A display 21 and a key input unit 22 may also be connected to the I/O interface 70. The various sensors 12 to 17 can be detached from or added to the AD converter 90, or replaced. The RAM 30, the hard disk drive 50, and the various sensors 12 to 17 included in the terminal 100 will be described below in detail.

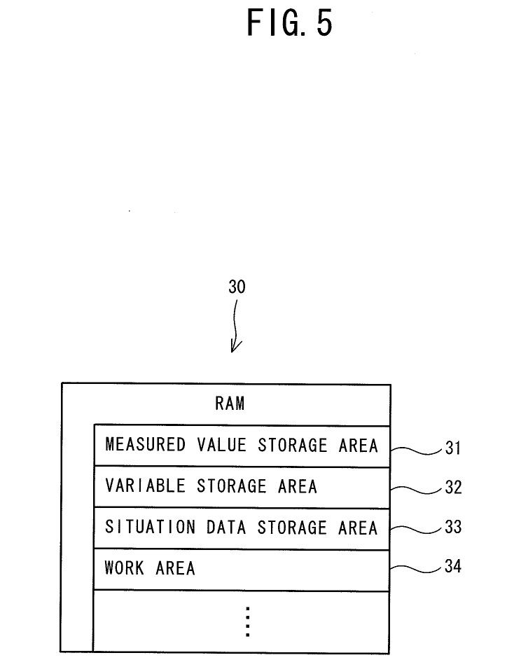

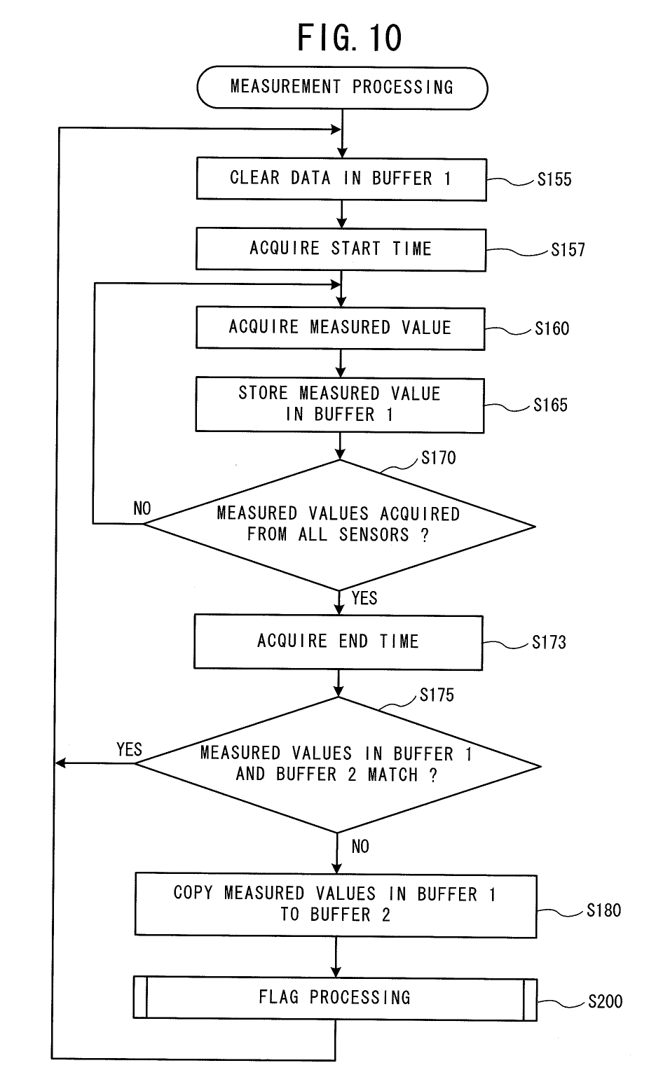

The RAM 30 is a readable and writable storage element. The RAM 30 may be provided with various storage areas for storing computation results obtained by the CPU 10 as necessary. Details of the storage areas of the RAM 30 will be described with reference to FIG. 5. As shown in FIG. 5, the RAM 30 may include a measured value storage area 31, a variable storage area 32, a situation data storage area 33, and a work area 34. The measured value storage area 31 may temporarily store a measured value obtained from each sensor in measurement processing, which will be described later with reference to FIG. 10. The variable storage area 32 may store a variable computed in emotion information inference processing or environment information inference processing. The situation data storage area 33 stores the situation data. The work area 34 may be used in execution of each piece of processing described later by the CPU 10.

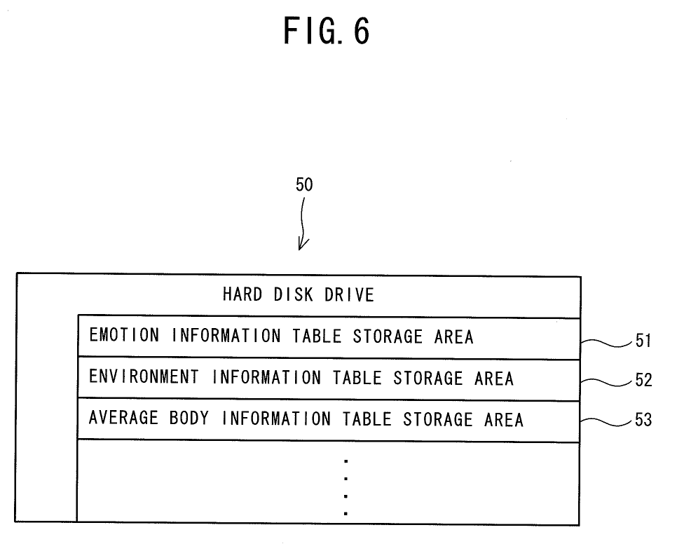

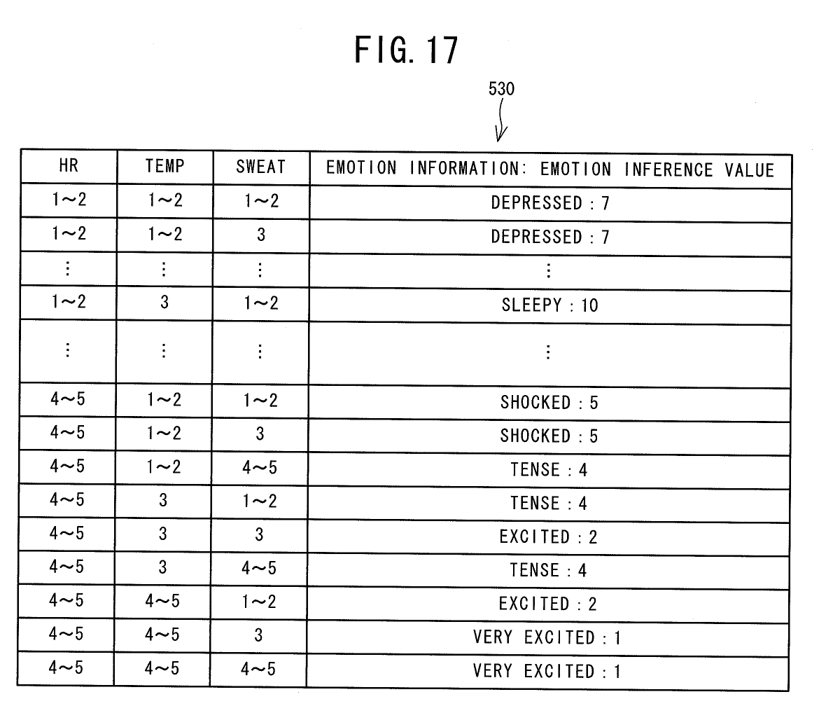

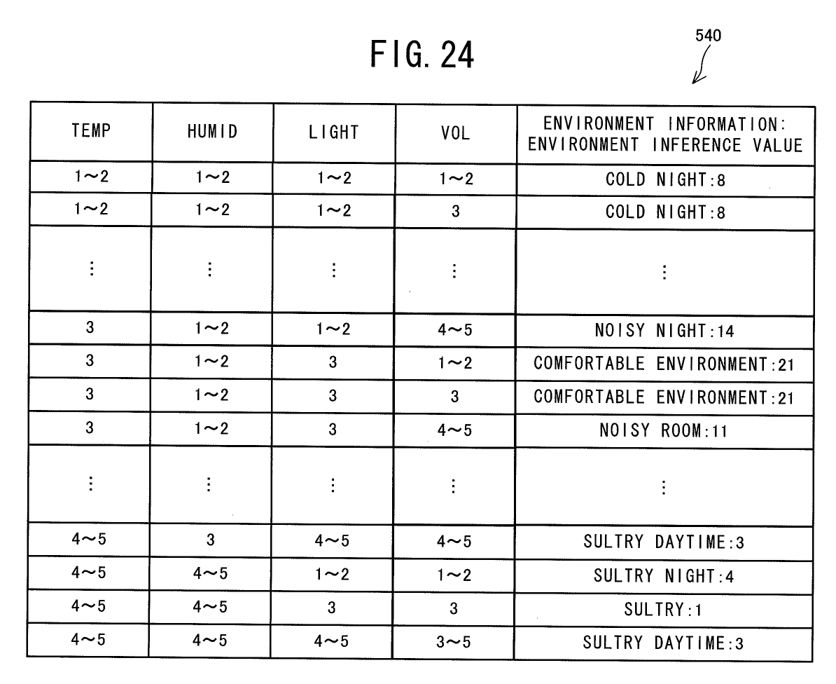

The hard disk drive 50 is a readable and writable storage device and may be provided with storage areas to store information used by the terminal 100. Details of the storage areas of the hard disk drive 50 will be described with reference to FIG. 6. As shown in FIG. 6, the hard disk drive 50 may include an emotion information table storage area 51, an environment information table storage area 52, and an average body information table storage area 53. The emotion information table storage area 51 may store an emotion information table 530 (See FIG. 17) to be referenced in processing to infer the emotion information based on the body information obtained from a predetermined sensor. The environment information table storage area 52 may store an environment information table 540 (See FIG. 24) to be referenced in processing to infer environment information of the terminal 100 based on the surrounding information of the terminal 100 obtained from a predetermined sensor. The average body information table storage area 53 may store average body information to be referenced in processing to infer the emotion information. The emotion information table 530 will be described later with reference to FIG. 17, and the environment information table 540 will be described later with reference to FIG. 24.

Next, the various sensors 12 to 17 will be described. The heart rate sensor 12 may be a so-called pressure-sensitive sensor and may measure a heart rate (pulse rate) of a person touching the terminal 100 by measuring the pressure of a blood flow. A so-called infrared sensor may be employed as the heart rate sensor 12, which measures the heart rate (pulse rate) of a person touching the terminal 100 by detecting a difference between distances caused by swelling/shrinking of a blood.

The temperature sensor 13 may be a so-called thermometer that employs, for example, a platinum resistance thermometer bulb, thermistor, thermocouple or the like. The temperature sensor 13 may measure a temperature around the terminal 100 or a temperature of a palm or a finger in contact with the terminal 100. The humidity sensor 14 may measure moisture content in the air around the terminal 100, using ceramic or polymers, for example. The illuminance sensor 15 may be a sensor to measure intensity of light using photo transistors, CdS (cadmium sulfide) or the like. The illuminance sensor 15 may be provided on the left-side surface of the terminal 100. A position sensor 16 may employ, for example, a GPS (Global Positioning System) receiver for receiving a signal from a GPS satellite. The microphone 17 is a sound volume sensor, into which a sound such as a voice around the terminal 100 may be input.

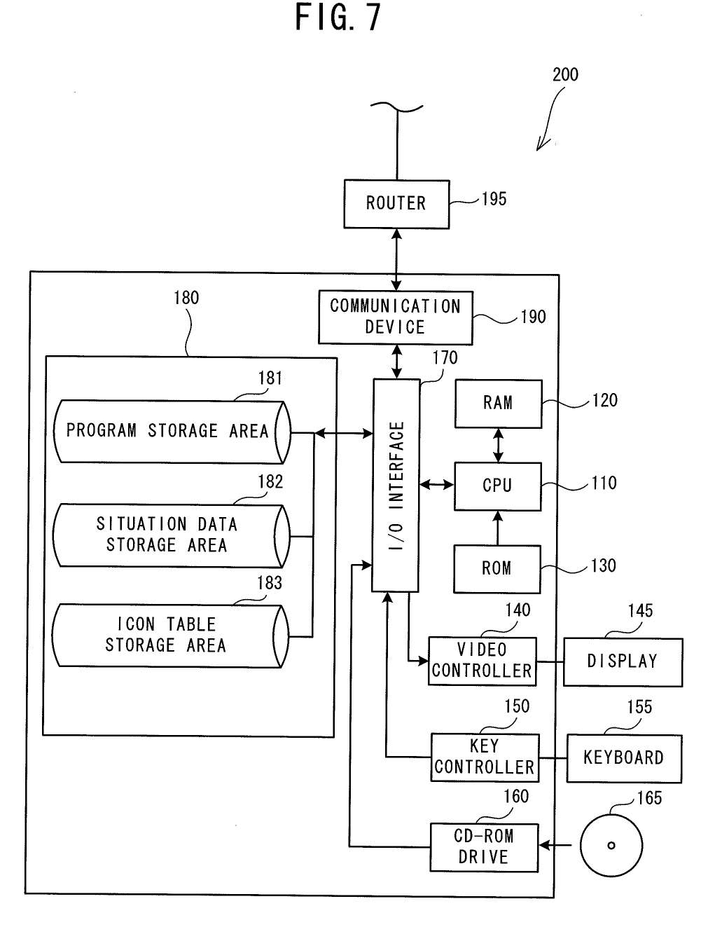

Next, an electrical configuration of the management server 200 will be described with reference to FIG. 7. The management server 200 may store the situation data transmitted from the terminal 100. The management server 200 may have a function to extract situation data satisfying a situation data condition and to transmit the extracted situation data to the content server 300, if the server receives instructions from the content server 300 to extract situation data satisfying the situation data condition.

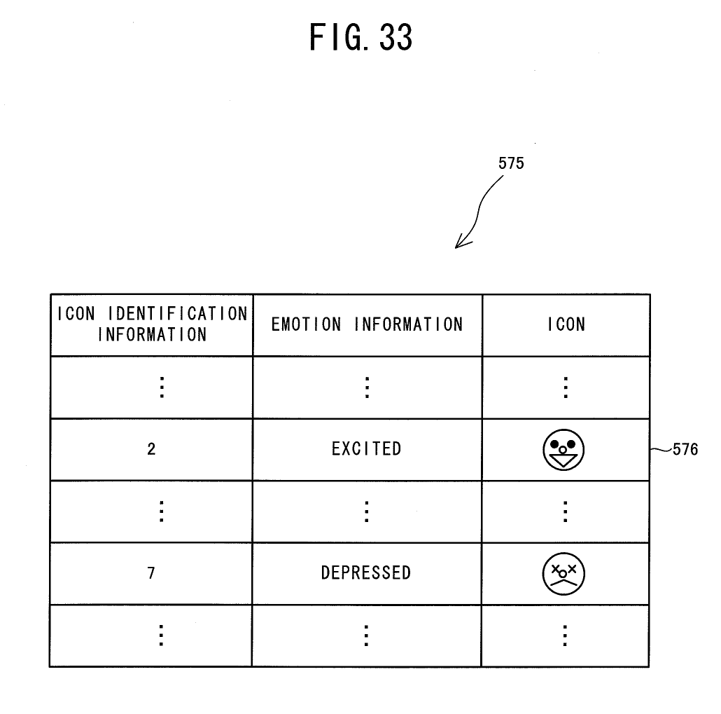

As shown in FIG. 7, the management server 200 may include a CPU 110 to control the management server 200. A RAM 120 for temporarily storing various kinds of data, a ROM 130 for storing BIOS and the like, and an I/O interface 170 for mediating interchange of data may be connected to the CPU 110. A hard disk drive 180 may be connected to the I/O interface 170. The hard disk drive 180 may have a program storage area 181, a situation data storage area 182, an icon table storage area 183, and other information storage areas (not shown). The program storage area 181 may store various programs including a server program to be executed by the CPU 110. The situation data storage area 182 may store the situation data transmitted from each of the terminals 100. The icon table storage area 183 may store an icon table 575 shown in FIG. 33.

Also, a video controller 140, a key controller 150, a CD-ROM drive 160, and a communication device 190 may be connected to the I/O interface 170. A display 145 may be connected to the video controller 140, a keyboard 155 may be connected to the key controller 150, and the communication device 190 may be connectable to the Internet 4 via a router 195. A CD-ROM 165 that stores a control program for the management server 200 may be inserted into the CD-ROM drive 160. The control program may be set up into the hard disk drive 180 from the CD-ROM 165 for installation and stored into the program storage area 181.

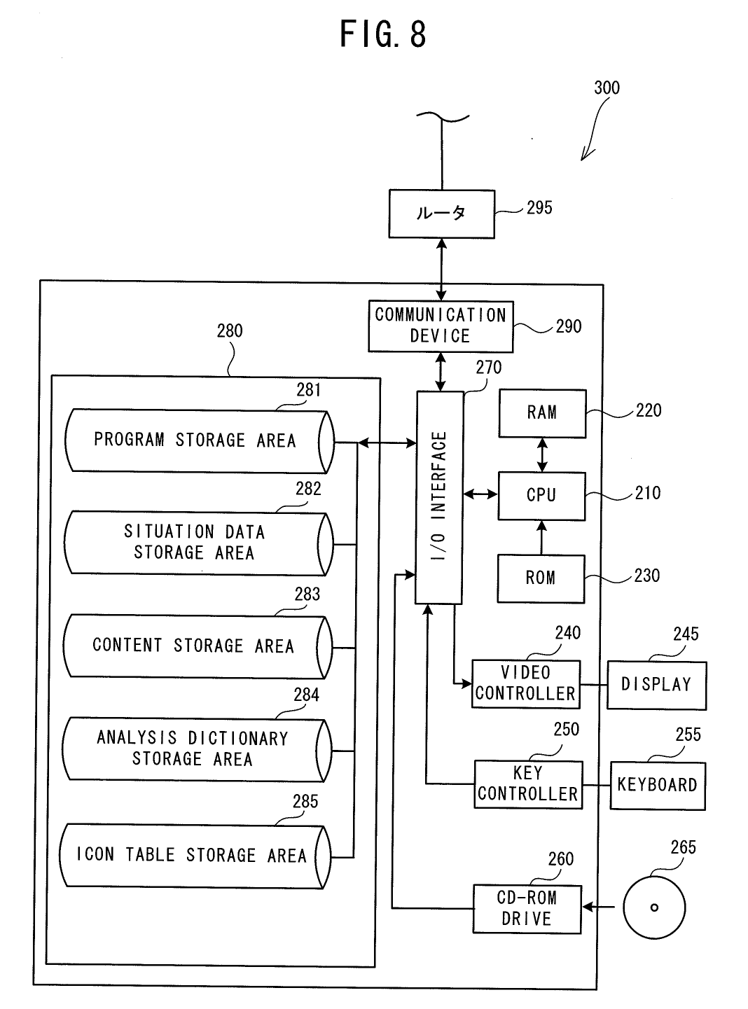

Next, an electrical configuration of the content server 300 will be described with reference to FIG. 8. The content server 300 may be configured to be connectable to a communication terminal such as the PC 2, and may store a content transmitted from communication terminal such as the PC 2. The content server 300 may analyze a character string of an updated content to determine the situation data condition, which is a condition for extracting situation data stored in the management server 200. The content server 300 may have a function to transmit an instruction to extract situation data satisfying the situation data condition to the management server 200. The content server 300 may also have a function to add edited data to a content. The edited data may be obtained by performing edit processing on the extracted situation data transmitted from the management server 200 by a predetermined method.

As shown in FIG. 8, the content server 300 may include a CPU 210 to control the content server 300. A RAM 220 for temporarily storing various kinds of data, a ROM 230 for storing BIOS and the like, and an I/O interface 270 for mediating interchange of data may be connected to the CPU 210. A hard disk drive 280 may be connected to the I/O interface 270. The hard disk drive 280 may have a program storage area 281, a situation data storage area 282, a content storage area 283, an analysis dictionary storage area 284, an icon table storage area 285, and other information storage areas (not shown). The program storage area 281 may store various programs including a server program to be executed by the CPU 210. The situation data storage area 282 may store the situation data transmitted from the management server 200. The content storage area 283 may store a content transmitted from a communication terminal, such as the PC 2. The analysis dictionary storage area 284 may store an analysis dictionary to be referenced for analyzing character strings in the contents. The icon table storage area 285 may store an icon table that is similar to the icon table 575 shown in FIG. 33.

Also, a video controller 240, a key controller 250, a CD-ROM drive 260, and a communication device 290 may be connected to the I/O interface 270. A display 245 may be connected to the video controller 240, a keyboard 255 may be connected to the key controller 250, and the communication device 290 may connectable to the Internet 4 via a router 295. A CD-ROM 265 that stores a control program for the content server 300 may be inserted into the CD-ROM drive 260. The control program may be set up into the hard disk drive 280 from the CD-ROM 265 for installation and stored into the program storage area 281.

Next, a description will be given of the first to third embodiments of processing procedure in which the edited data obtained by editing the extracted situation data is added to an updated content using the above-described situation presentation system 1. First, various kinds of processing of the situation presentation system 1 in the first embodiment will be described with reference to FIGS. 9 to 42.

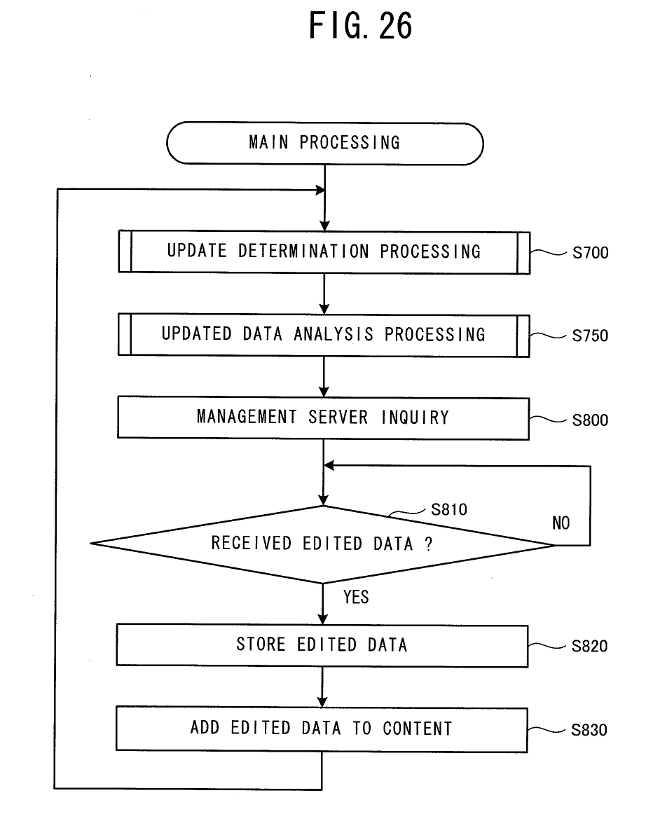

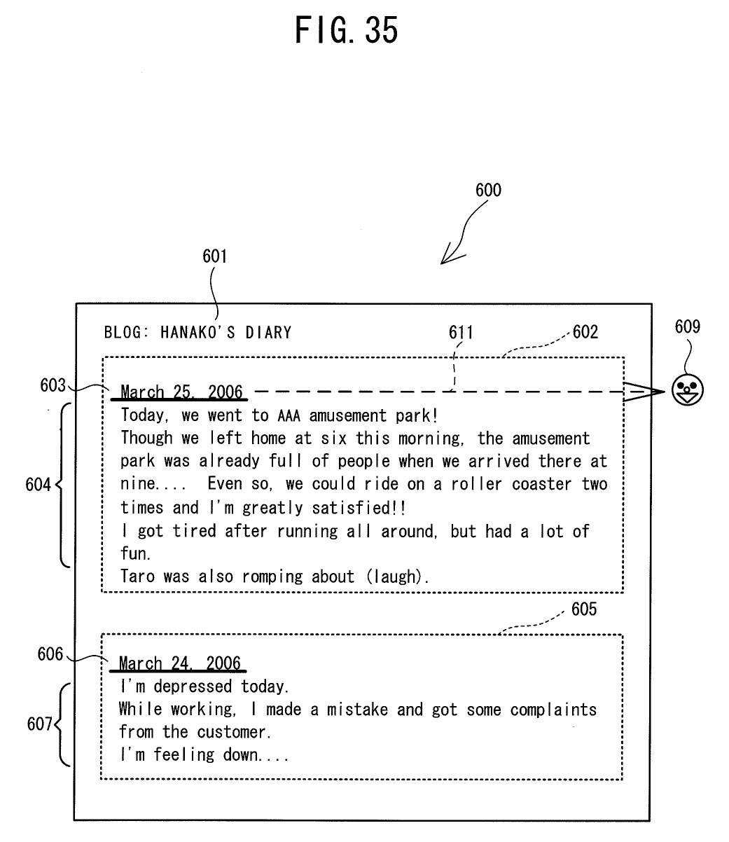

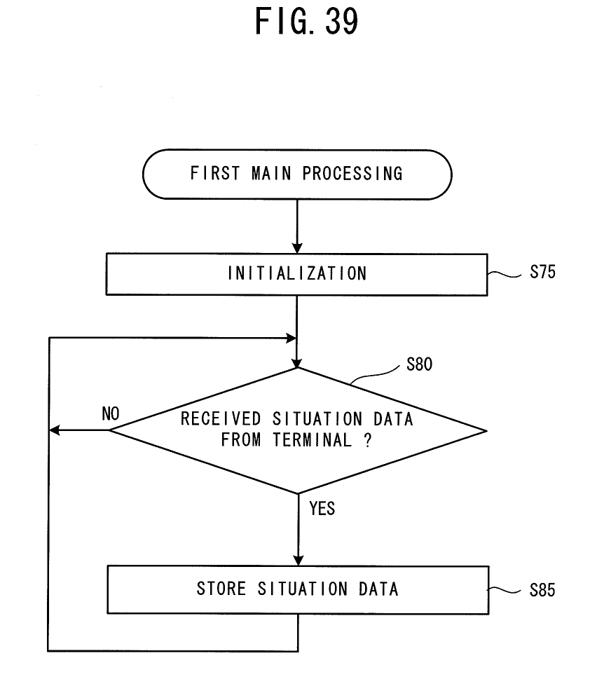

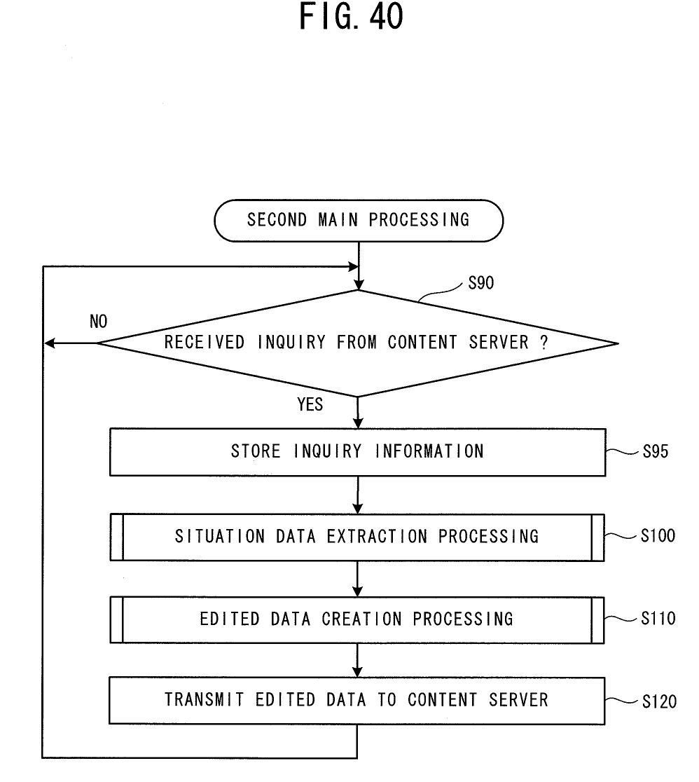

The first embodiment will be described in the order as follows. First, main processing of the terminal 100 will be described with reference FIGS. 9 to 25. Second, first to third modified embodiments of the main processing of the terminal 100 will be described. Third, main processing of the content server 300 will be described with reference to FIGS. 26 to 34. Fourth, fourth and fifth modified embodiments of the main processing of the content server 300 will be described with reference to FIGS. 35 to 38. Fifth, first main processing of the management server 200 will be described with reference to FIG. 39. Finally, second main processing of the management server 200 will be described with reference to FIGS. 40 to 42.

First, a description will be given of the main processing of the terminal 100 to acquire situation data and to transmit the situation data to the management server 200, with reference to FIGS. 7 and 9 to 25. The terminal 100 in the first embodiment may transmit the situation data to the management server 200 each time the situation data is acquired (S40 in FIG. 9).

The main processing in the first embodiment shown in FIG. 9 may be performed continuously by the CPU 10 of the terminal 100 after the terminal 100 is turned on to activate a situation data transmission program.

As shown in FIG. 9, various kinds of data and flags are first initialized in the main processing of the terminal 100 (S5). For example, the measured value storage area 31 and the variable storage area 32 in the RAM 30 shown in FIG. 7 may be initialized.

After initialization (S5), the various sensors 12 to 17 may be activated (S10). This step may be performed to acquire measured values respectively obtained from the various sensors 12 to 17 as body information of a user of the terminal 100 or surrounding information of the terminal 100. Then, measurement processing may be started (S15). In the measurement processing, the measured values of the various sensors 12 to 17 may be acquired and whether the user is touching a casing of the terminal 100 is detected. Details of the measurement processing will be described later with reference to FIG. 10. The measurement processing may be repeatedly performed after being started until an end instruction is issued.

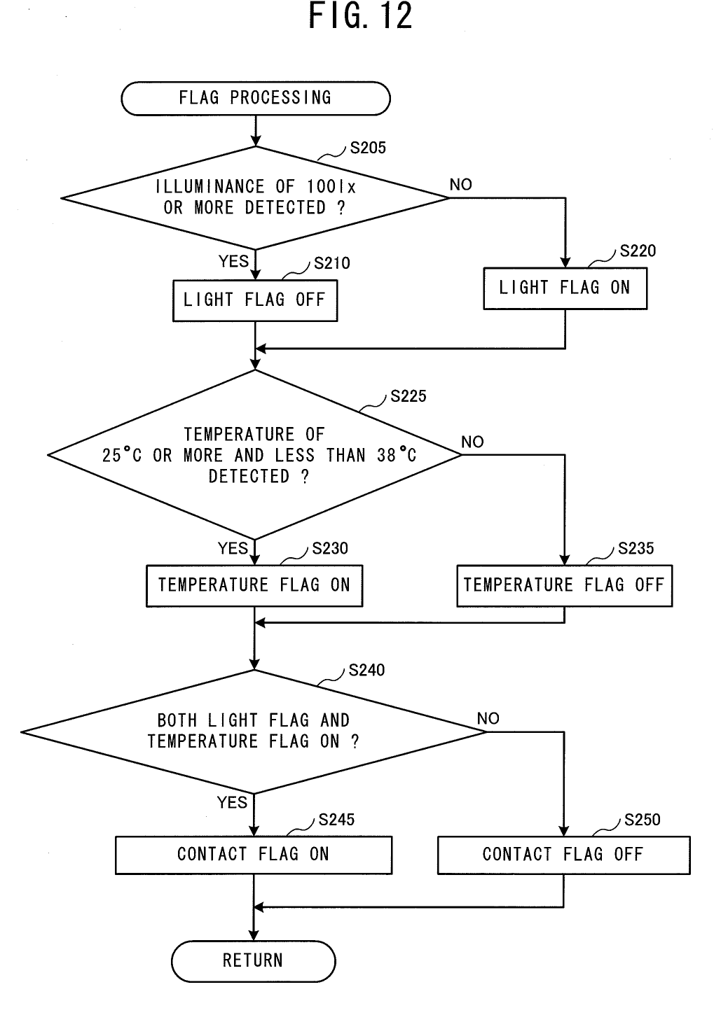

Subsequently, it may be determined whether a buffer 2 in the measured value storage area 31 has been updated, that is, whether an update flag stored in the RAM 30 is one (1) (S20). As described later, new measured values may be acquired from all the sensors 12 to 17 and stored into the buffer 2 of the measured value storage area 31 in the measurement processing. If it is determined that measured values stored in a buffer 1 and the measured values stored in the buffer 2 are different, the values in the buffer 1 may be copied into the buffer 2 for updating, and detection of touching may be performed based on the updated measured values (See FIG. 12). In other words, if the buffer 2 has been updated, new measured values have been acquired. Therefore, based on the new measured values, it may be determined whether the user is touching the terminal 100, and the emotion information or the environment information may be detected. Thus, if the buffer 2 has not been updated (No at S20), the determination at step S20 may be repeated until the buffer 2 is updated.

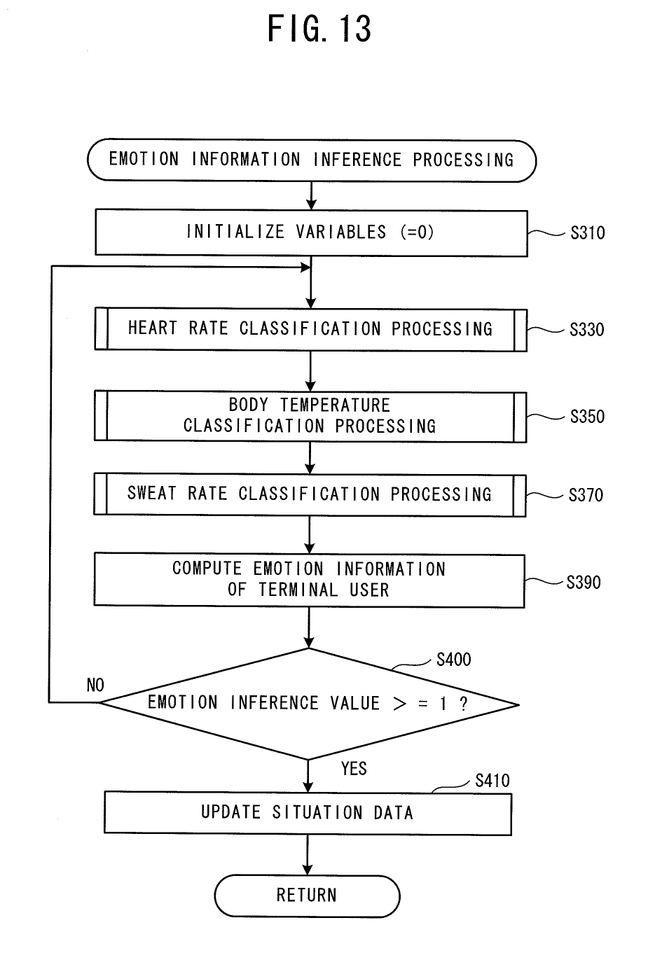

If the buffer 2 has been updated (Yes at S20), then, it may be determined whether the user is touching the terminal 100 by checking a contact flag processed in the measurement processing (S25). If the contact flag is ON (Yes at S25), the emotion information inference processing may be performed based on data acquired in the measurement processing (S30). Through this processing, measured values obtained from the various sensors 12 to 17 may be taken as the body information. The emotion information may be inferred from the body information. If, on the other hand, the contact flag is OFF (No at S25), the environment information inference processing may be performed based on data acquired in the measurement processing (S35). Through this processing, measured values obtained from the various sensors 12 to 17 may be taken as the surrounding information. The environment information may be inferred from the surrounding information. Details of the emotion information inference processing and the environment information inference processing will be described later with reference to FIGS. 13 to 17, and FIGS. 18 to 24, respectively.

Next, the situation data may be transmitted to the management server 200 via the communication unit 60 (S40). The situation data may contain the emotion information or the environment information computed in the emotion information inference processing (S30) or in the environment information inference processing (S35) respectively and stored in the situation data storage area 33. This step (S40) may be performed to cause the management server 200 to store and accumulate the situation data. Then, the situation data may be output (S45). Here, for example, the situation data may be displayed on the display 21 to notify the user of the terminal 100 of the situation data. The processing of outputting the situation data may be omitted according to circumstances.

Subsequently, it may be determined whether the terminal 100 has been turned off (S50). If the terminal 100 is not turned off (No at S50), the above processing may be repeated after returning to step S20. If the terminal 100 is turned off (Yes at S50), all active processing may be terminated (S55), thereby terminating the main processing.

Next, the measurement processing started in the main processing will be described with reference to FIG. 10. Following the start of the measurement processing shown in FIG. 10, data stored in the buffer 1 may be cleared (S155) so that the buffer 1 may store new measured values. At this step, an update flag (not shown) in the RAM 30 indicating whether or not measured values have been updated may be set to zero (0), which indicates no update. Then, a start time may be acquired from the clocking device 40 and stored into the measured value storage area 31 of the RAM 30 (S157). The start time herein refers to a time at which acquisition of measured values from the various sensors 12 to 17 is started. Then, a measured value from any of the various sensors 12 to 17 may be acquired (S160), and the acquired measured value may be stored into the buffer 1 of the measured value storage area 31 (S165). Through this processing, for example, heart rate data and humidity data may be acquired and stored into the buffer 1.

Next, it may be determined whether the measured values have been acquired from all sensors and stored in the buffer 1 (S170). If measured values have not been acquired from all sensors (No at S170), the processing may return to step S160 to acquire a measured value that has been measured. If, for example, only heart rate data and humidity data are stored in the buffer 1 of the measured value storage area 31 as described above, acquisition of other measured values may be repeated until temperature data, illuminance data, sound volume data, and position data are stored.

When measured values have been acquired from all sensors and stored into the buffer 1 (Yes at S170), an end time may be acquired from the clocking device 40 and stored into the measured value storage area 31 of the RAM 30 (S173). The end time herein refers to a time at which acquisition of measured values from the various sensors 12 to 17 is ended. Then, it may be determined whether predetermined measured values respectively stored in the buffer 1 and the buffer 2 match with each other (S175). If the predetermined measured values stored in the buffer 1 and the buffer 2 match each other (Yes at S175), it may be determined that the measured values have not changed. In such a case, the processing of steps S155 to S175 may be repeated to acquire the measured values, until it is determined that the predetermined measured values have changed (No at S175). If the predetermined measured values respectively stored in the buffer 1 and the buffer 2 do not match (No at S175), it is determined that the predetermined measured values have changed. Therefore, the data in the buffer 1 may be copied into the buffer 2 (S180). At this step, the update flag of the measured value storage area 31 in the RAM 30 may be set to one (1), which indicates that the measured values have been updated and the contact flag indicating whether or not the user is touching the terminal 100 may be set to zero (0), which indicates that the user is not touching the terminal 100.

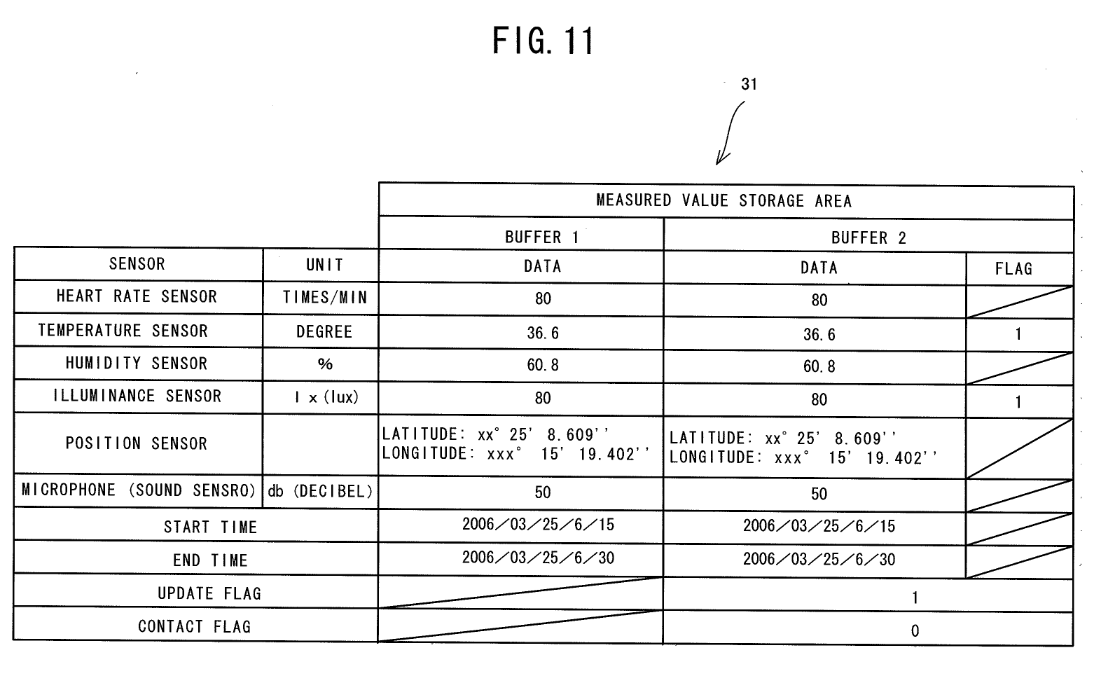

Then, a temperature flag, which is a flag corresponding to the temperature sensor 14, and a light flag, which is a flag corresponding to the illuminance sensor 15, are each set to zero (0). The temperature flag and the light flag may be referenced in the flag processing to set the contact flag, which will be described later with reference to FIG. 12. FIG. 11 shows an example in which measured values acquired by the various sensors 12 to 17 were copied from the buffer 1 into the buffer 2 and each flag was set in the measured value storage area 31. Based on the measured values, the flag processing to determine whether the user is touching the terminal 100 may be performed (S200). Details of the flag processing will be described later with reference to FIG. 12.

Following the flag processing, processing returns to step S155, the data in the buffer 1 may be cleared for a next acquisition of the measured values (S155), and the processing of acquiring and storing the measured values may be repeated.

Since the measurement processing may be performed continuously, as described above, available measured values may always be stored in the buffer 2 of the measured value storage area 31. Thus, the emotion information inference processing (S30 in FIG. 9) or the environment information inference processing (S35 in FIG. 9) may be performed in the main processing based on the measured values.

Next, the flag processing performed in the measurement processing shown in FIG. 10 will be described with reference to FIG. 12. In the flag processing, it may be determined whether the measured values acquired from the various sensors 12 to 17 are to be taken as the body information of the user of the terminal 100 or as the surrounding information of the terminal 100, based on the measured values obtained from the temperature sensor 13 and the illuminance sensor 15.

In the flag processing shown in FIG. 12, the measured value of the illuminance sensor 15 stored in the buffer 2 of the measured value storage area 31 may be referenced first to determine whether a light having an intensity equal to or more than a predetermined value (for example, 100 lux (lx)) has been detected (S205). If a light having an intensity equal to 100 lx or more has been detected (Yes at S205), the light flag may be turned off. Specifically, zero (0) may be set to the light flag and stored in the buffer 2 of the measured value storage area 31 shown in FIG. 11 (S210). If, on the other hand, the measured value of the illuminance sensor 15 is 80 lx, as shown in the example of FIG. 11, that is, the illuminance is less than 100 lx (No at S205), the light flag may be turned on. Specifically, one (1) may be set to the light flag and stored in the buffer 2 of the measured value storage area 31 (S220).

After the processing of the light flag is completed, it may be determined whether the temperature detected by the temperature sensor 13 is 25° C. or more and less than 38° C. (S225). If the measured value of the temperature sensor 13 is 36.6° C., as shown in the example of FIG. 11, that is, the temperature is 25° C. or more and less than 38° C. (Yes at S225), the temperature flag may be set to ON. Specifically, one (1) may be set to the temperature flag and stored in the buffer 2 of the measured value storage area 31 (S230). If, on the other hand, the temperature is not 25° C. or more and less than 38° C. (No at S225), the temperature flag may be set to OFF. Specifically, zero (0) may be set to the temperature flag and stored in the buffer 2 of the measured value storage area 31 (S235).

After processing of the temperature flag is completed, then the buffer 2 of the measured value storage area 31 may be referenced to determine whether the light flag and temperature flag have both been set to ON through the above-described processing (S240).

As in the example shown in FIG. 11, if both the light flag and the temperature flag are ON (Yes at S240), the contact flag may be turned on (S245), which indicates that the user is touching the terminal 100. Specifically, one (1) may be set to the contact flag and stored in the buffer 2 of the measured value storage area 31 (S245). If, on the other hand, the number of flags that have been turned on is less than 2, (No at S240), the contact flag may be turned off (S250), which indicates that the user is not touching the terminal 100. Specifically, zero (0) may be set to the contact flag and stored in the buffer 2 of the measured value storage area 31 (S250). This completes the flag processing, and the processing returns to step S155 of the measurement processing shown in FIG. 10 to repeat the processing.

In the above-described flag processing, it may be determined that the user is touching the terminal 100 if both of the light flag and the temperature flag have been turned on (S240). However, if the terminal 100 is provided with a pressure sensor, priority may be given to a detection result from the pressure sensor. In such a case, a pressure flag may be turned on when a measured value of the pressure sensor is equal to a predetermined value or more. Then, it may be determined that the user is touching the terminal 100 when the pressure flag is ON and one of the light flag and the temperature flag is ON. Alternatively, it may be determined that the user is touching the terminal 100 when two or more flags of the pressure flag, the light flag, and the temperature flag are ON. In the first embodiment, it may be determined through the flag processing whether the measured values acquired from the various sensors 12 to 17 are to be taken as the body information of the user of the terminal 100 or as the surrounding information of the terminal 100. The determination method, however, is not limited to the above example. For example, if the user gives an instruction as to which information the measured values correspond, it may be determined according to the instruction whether the measured values may be taken as the body information of the user of the terminal 100 or as the surrounding information of the terminal 100. In such a case, the flag processing may be omitted.

Next, the emotion information inference processing performed in the main processing will be described with reference to FIGS. 11 and 13 to 17. The emotion information inference processing may be performed to infer the emotion information of the user of the terminal 100 from the measured values, when the contact flag is determined as ON at step S25 shown in FIG. 9, that is, the measured values obtained from the various sensors 12 to 17 are determined to be the body information. Example 1, in which the measured values from the various sensors 12 to 17 are as shown in FIG. 11, will be employed to describe the processing. In Example 1, as described above, it may be determined that the user is touching the casing of the terminal 100 based on the measured values shown in FIG. 11.

As shown in FIG. 13, following the start of the emotion information inference processing, variables stored in the variable storage area 32 of the RAM 30 may be initialized (S310). Trough this processing, zero (0) may be set to each of variables “HR”, “TEMP”, and “SWEAT” stored in the variable storage area 32 (S310). “HR” is an indicator of the heart rate, “TEMP” is an indicator of the body temperature, and SWEAT is an indicator of the sweat rate. “HR”, “TEMP”, and “SWEAT” may be determined in accordance with the various sensors 12 to 17, and may be used to infer the emotion information of the user.

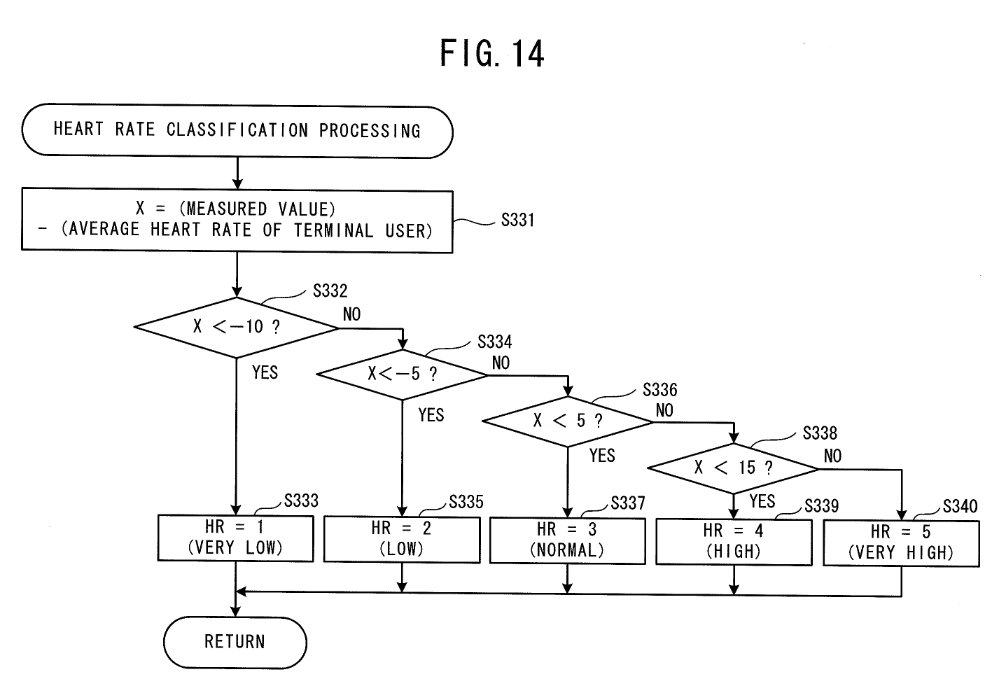

Subsequently, heart rate classification processing to classify heart rate data stored in the buffer 2 is performed (S330). The heart rate classification processing will be described with reference to FIG. 14. In the heart rate classification processing shown in FIG. 14, the buffer 2 in the measured value storage area 31 of the RAM 30 and the average body information table storage area 53 in the hard disk drive 50 may be referenced first to compute a value X (S331). The value X may be obtained by subtracting an average heart rate of the user of the terminal 100 from the measured value acquired by the heart rate sensor 12. This step may be performed to determine conditions of the user of the terminal 100 by comparing the average heart rate of the user and the measured value acquired by the heart rate sensor 12. In Example 1, if it is assumed that a value 60 is stored in the hard disk drive 50 as the average heart rate of the user of the terminal 100, the value X may be computed as 20 by subtracting the average value 60 from the measured value 80 shown in FIG. 11 (S331).

Subsequently, the variable HR, which is an indicator of the heart rate, may be set in accordance with the value X. If the value X is less than −10 (Yes at S332), a value one (1), which indicates the hear rate is very low, may be set to HR and stored into the variable storage area 32 of the RAM 30(S333). If the value X is −10 or more and less than −5 (No at S332, Yes at S334), a value 2, which indicates that the heart rate is low, may be set to HR and stored into the variable storage area 32 (S335). If the value X is −5 or more and less than 5 (No at S332, No at S334, Yes at S336), a value 3, which indicates that the heart rate is normal, may be set to HR and stored into the variable storage area 32 (S337). If the value X is 5 or more and less than 15 (No at S332, No at S334, No at S336, Yes at S338), a value 4, which indicates that the heart rate is high, may be set to HR and stored into the variable storage area 32 (S339). If, like the value X of 20 in Example 1, the value X is 15 or more (No at S332, No at S334, No at S336, No at S338), a value 5, which indicates that the heart rate is very high, may be set to HR and stored into the variable storage area 32 (S340). When setting of the variable HR is completed, the heart rate classification processing terminates to return to the emotion information inference processing shown in FIG. 13.

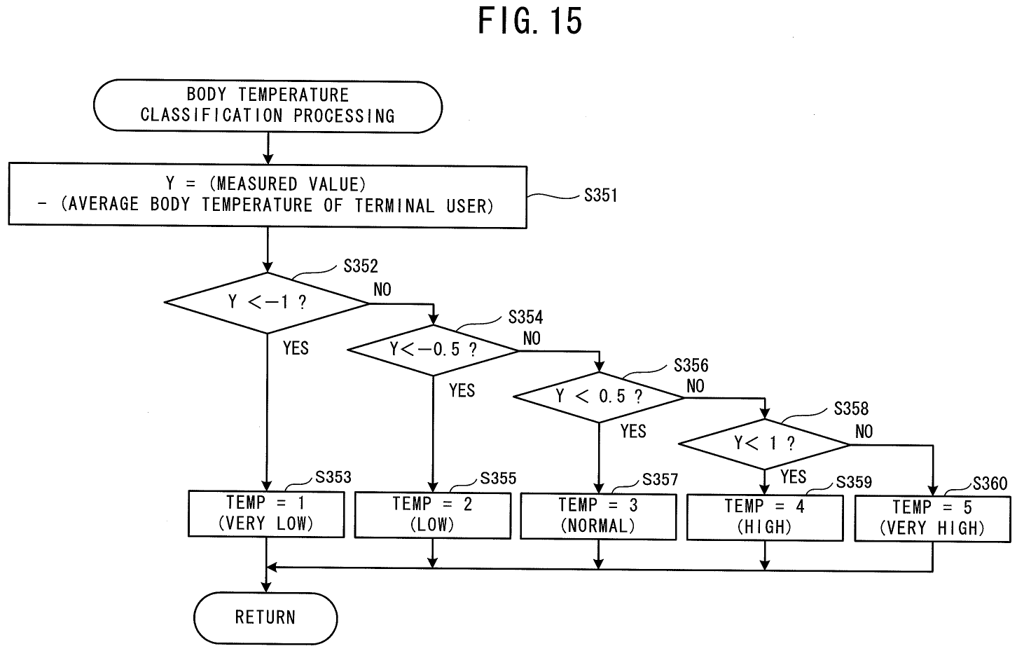

Subsequent to step S330 in FIG. 13, body temperature classification processing may be performed (S350). In the body temperature classification processing, a body temperature may be classified, regarding a measured value obtained from the temperature sensor 13 as the body temperature of the user. The body temperature classification processing will be described with reference to FIG. 15. In the body temperature classification processing in FIG. 15, like the heart rate classification processing, the buffer 2 in the measured value storage area 31 of the RAM 30 and the average body information table storage area 53 in the hard disk drive 50 may be referenced first to compute a value Y (S351). The value Y may be obtained by subtracting an average body temperature of the user of the terminal 100 from the measured value of the temperature sensor 13. This process may be performed to determine conditions of the user of the terminal 100 by comparing the average body temperature of the user and the measured value acquired by the temperature sensor 13. In Example 1, if it is assumed that a value 36.0° C. is stored in the hard disk drive 50 as the average body temperature of the user of the terminal 100, the value Y may be computed as 0.6 by subtracting the average value 36.0 from the measured value 36.6 shown in FIG. 11 (S351).

Subsequently, the variable TEMP, which may be used as an indicator of the body temperature in the emotion information inference processing, may be set in accordance with the value Y. If the value of Y is less than −1 (Yes at S352), a value one (1), which indicates that the body temperature is very low, may be set to TEMP and stored into the variable storage area 32 of the RAM 30 (S353). If the value Y is −1 or more and less than −0.5 (No at S352, Yes at S354), a value 2, which indicates that the body temperature is low, may be set to TEMP and stored into the variable storage area 32 (S355). If the value Y is −0.5 or more and less than 0.5 (No at S352, No at S354, Yes at S356), a value 3, which indicates that the body temperature is normal, may be set to TEMP and stored into the variable storage area 32 (S357). If, like the value Y of 0.6 in Example 1, the value Y is 0.5 or more and less than 1 (No at S352, No at S354, No at S356, Yes at S358), a value 4, which indicates that the body temperature is high, may be set to TEMP and stored into the variable storage area 32 (S359). If the value Y is 1 or more (No at S352, No at S354, No at S356, No at S358), a value 5, which indicates that the body temperature is very high, may be set to TEMP and stored into the variable storage area 32 (S360). When setting of TEMP is completed, the body temperature classification processing terminates to return to the emotion information inference processing shown in FIG. 13.

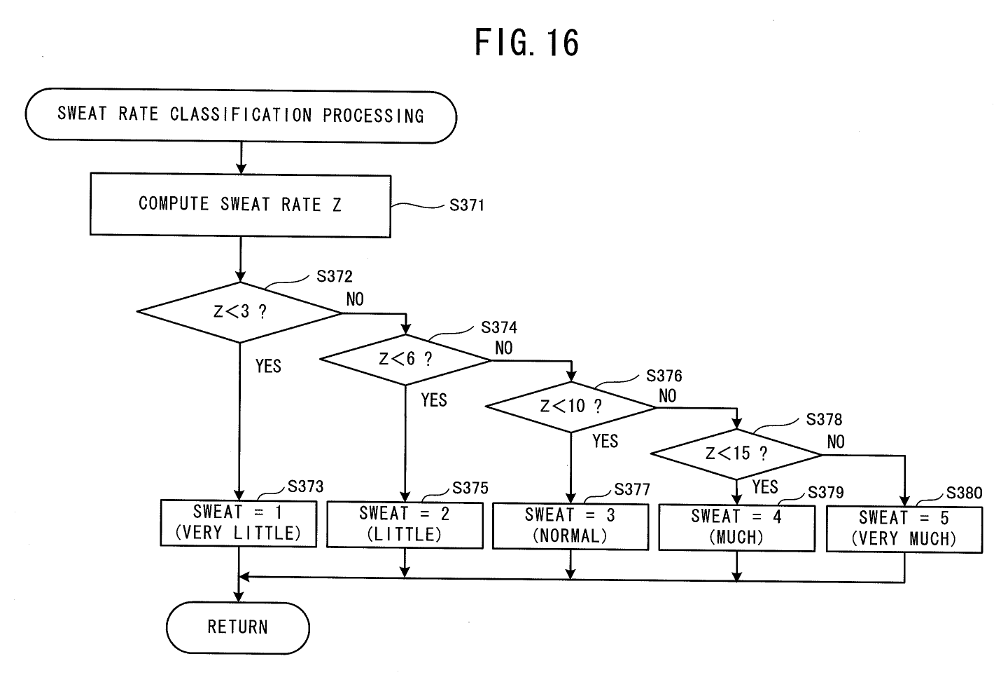

Subsequent to step S350 in FIG. 13, sweat rate classification processing may be performed (S370). In the sweat rate classification processing, a sweat rate of the user may be classified, regarding a measured value obtained from the humidity sensor 14 as the sweat rate of the user. The sweat rate classification processing will be described with reference to FIG. 16. In the sweat rate classification processing in FIG. 16, the buffer 2 in the measured value storage area 31 of the RAM 30 may be referenced to compute a sweat rate Z of the user of the terminal 100 from a measured value of the humidity sensor 14 (S371). The sweat rate Z may be computed using a predetermined relational expression between a sweat rate and humidity. In this example, it may be assumed that 4 g is obtained as the sweat rate Z from the measured value 60.8% of the humidity sensor 14 shown in FIG. 11.

Subsequently, the variable SWEAT, which is an indicator of the sweat rate, may be set in accordance with the value Z. If the value Z is less than 3 (Yes at S372), a value one (1), which indicates that the user is sweating very little, may be set to SWEAT and stored into the variable storage area 32 of the RAM 30 (S373). If, like the value Z of 4 in Example 1, the value Z is 3 or more and less than 6 (No at S372, Yes at S374), a value 2, which indicates that the user is sweating a little, may be set to SWEAT and stored into the variable storage area 32 (S375). If the value Z is 6 or more and less than 10 (No at S372, No at S374, Yes at S376), a value 3, which indicates that the user is sweating normally, is set to SWEAT and stored into the variable storage area 32 (S377). If the value Z is 10 or more and less than 15 (No at S372, No at S374, No at S376, Yes at S378), a value 4, which indicates that the user is sweating much, may be set to SWEAT and stored into the variable storage area 32 (S379). If the value Z is 15 or more (No at S372, No at S374, No at S376, No at S378), a value 5, which indicates that the user is sweating very much, may be set to SWEAT and stored into the variable storage area 32 (S380). When setting of SWEAT is completed, the sweat rate classification processing terminates to return to the emotion information inference processing shown in FIG. 13.

Subsequent to step S370 in FIG. 13, the variable storage area 32 of the RAM 30 and the emotion information table storage area 51 of the hard disk drive 50 may be referenced. Then, the emotion information table 530 shown in FIG. 17 and the variables, that is, the variable HR computed at step S330, the variable TEMP computed at step S350, and the variable SWEAT computed at step S370, may be compared to compute the emotion information of the user of the terminal 100 (S390). The emotion information table 530 to be referenced in the processing will be described with reference to FIG. 17. The emotion information table 530 may be stored in the emotion information table storage area 51 of the hard disk drive 50.

As shown in FIG. 17, the emotion information table 530 in the first embodiment may store the values of HR, TEMP, and SWEAT in association with emotion information of the user that can be inferred from these values. The variable HR may be computed at step S330, the variable TEMP may be computed at step S350, and the variable SWEAT may be computed at step S370. In the first embodiment, as shown in FIG. 17, the emotion information may be classified into one of the emotional states expressed like “depressed”, “sleepy”, “shocked”, “tense”, “excited”, and “very excited”, in accordance with the computed values of HR, TEMP, and SWEAT. Such emotion information may include an emotion inference value representing each state as a number.

The emotion information computed at step S390 in FIG. 13 will be described referring to Example 1 shown in FIG. 11. In Example 1, as described above, the value 5 may be computed as HR at step S330, the value 4 may be computed as TEMP at step S350, and the value 2 may be computed as SWEAT at step S370. Thus, by comparing these variables and the emotion information table 530 shown in FIG. 17, the emotion information of “Excited: 2” associated with HR between 4 and 5, TEMP between 4 and 5, and SWEAT between 1 and 2 may be obtained (S390).

Subsequently, it may be determined whether the emotion inference value included in the emotion information computed at step S390 is equal to one (1) or more (S400). If the value of the emotion information less than 1 (No at S400), the processing may return to step S330 to repeat the processing. Such a case may correspond to a case where the emotion information has not been computed normally. If, on the other hand, the value of the emotion information is equal to 1 or more (Yes at S400), the emotion information computed at step S390 may be stored into the situation data storage area 33 of the RAM 30 as the situation data, together with the start time, the end time and the position data stored in the buffer 2 in the measured value storage area 31 of the RAM 30 (S410). Such a case may correspond to a case where the emotion information has been computed normally. In Example 1, the emotion information “Excited: 2” computed at step S390 may be stored in the situation data storage area 33 of the RAM 30 as the situation data (S410). “2006/03/25/6/15 (year/month/day/hour/minute)” shown in FIG. 11 as the start time and “2006/03/25/6/30 (year/month/day/hour/minute)” shown in FIG. 11 as the end time may each be stored in the situation data storage area 33 as the situation data (S410). Further, the measured value “latitude: xx° 25′ 8.609″; longitude: xxx° 15′ 19.402″” of the position sensor 16 as the position data shown in FIG. 11 may be stored into the situation data storage area 33 as the situation data (S410). Subsequently, the emotion information inference processing may terminate to return to the main processing shown in FIG. 9. Then, at step S40 shown in FIG. 9, the situation data stored in the situation data storage area 33 may be transmitted to the management server 200 together with an ID that identifies the terminal 100 from other terminals (S40).

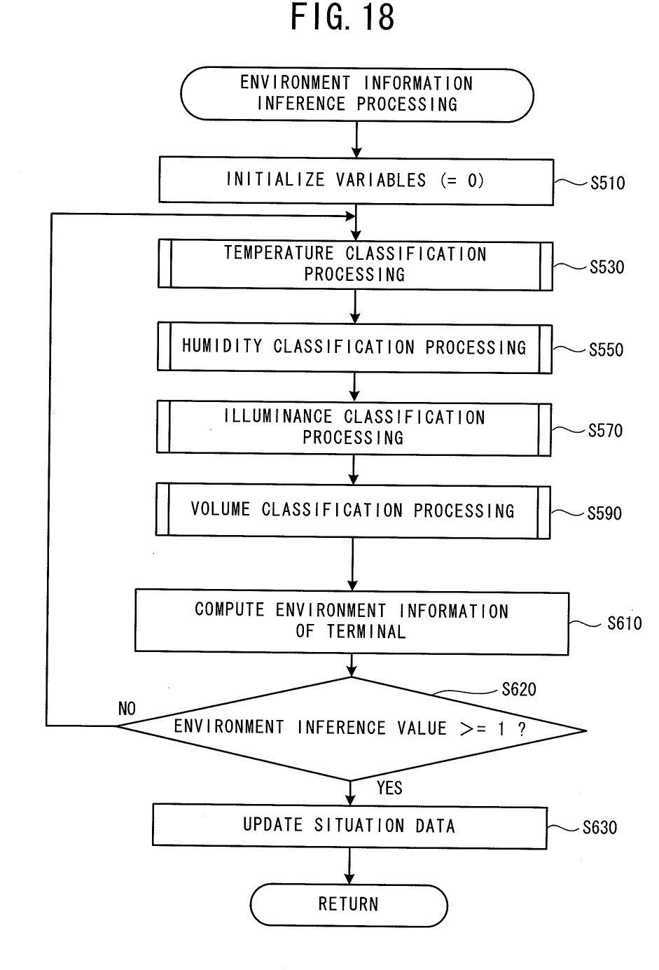

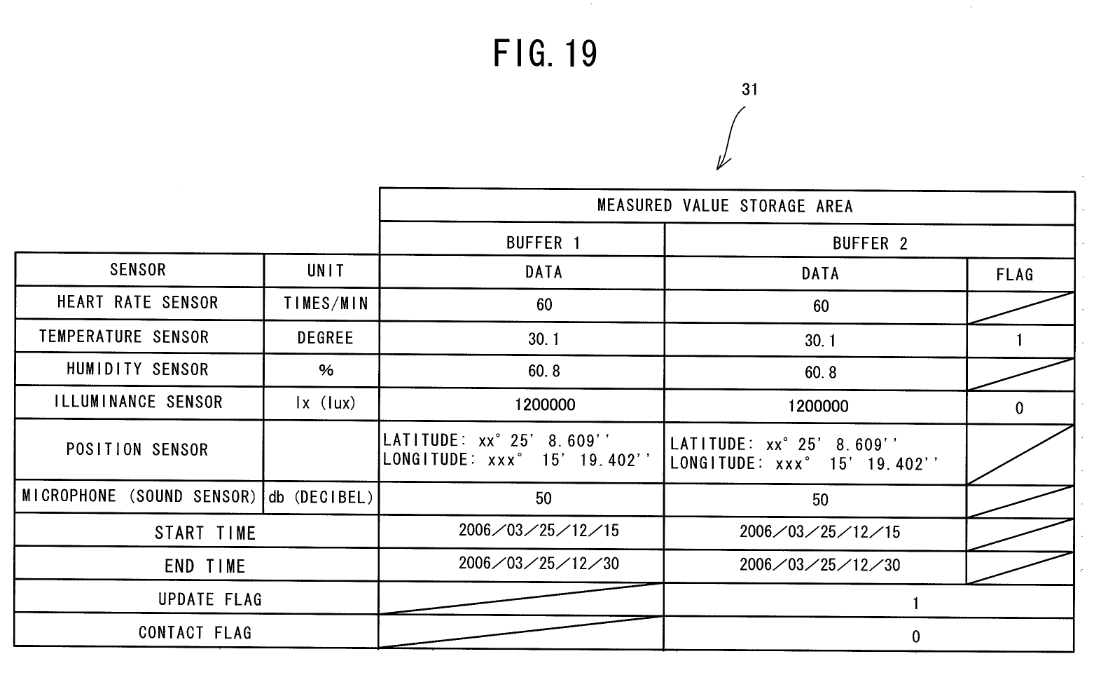

Next, the environment information inference processing performed in the main processing will be described with reference to FIGS. 18 to 24. The environment information inference processing may be performed when the contact flag is determined as OFF at step S25 shown in FIG. 9, that is, the measured values obtained from the various sensors 12 to 17 are determined to be the surrounding information of the terminal 100. In the environment information inference processing, the environment information of the terminal 100 may be inferred from the measured values. Example 2, in which the measured values are as shown in FIG. 19, will be employed to describe the processing.

As shown in FIG. 18, following the start of the environment information inference processing, the variables stored in the variable storage area 32 of the RAM 30 may be initialized (S510). Through this processing, zero (0) may be set to a variable TEMP, which may be used as an indicator of a temperature in the environment information inference processing, a variable HUMID, which is an indicator of a humidity, a variable LIGHT, which is an indicator of an illuminance, and a variable VOL, which is an indicator of a sound volume stored in the variable storage area 32. These variables may be determined in accordance with the various sensors 12 to 17 and may be used to infer the environment information of the terminal 100.

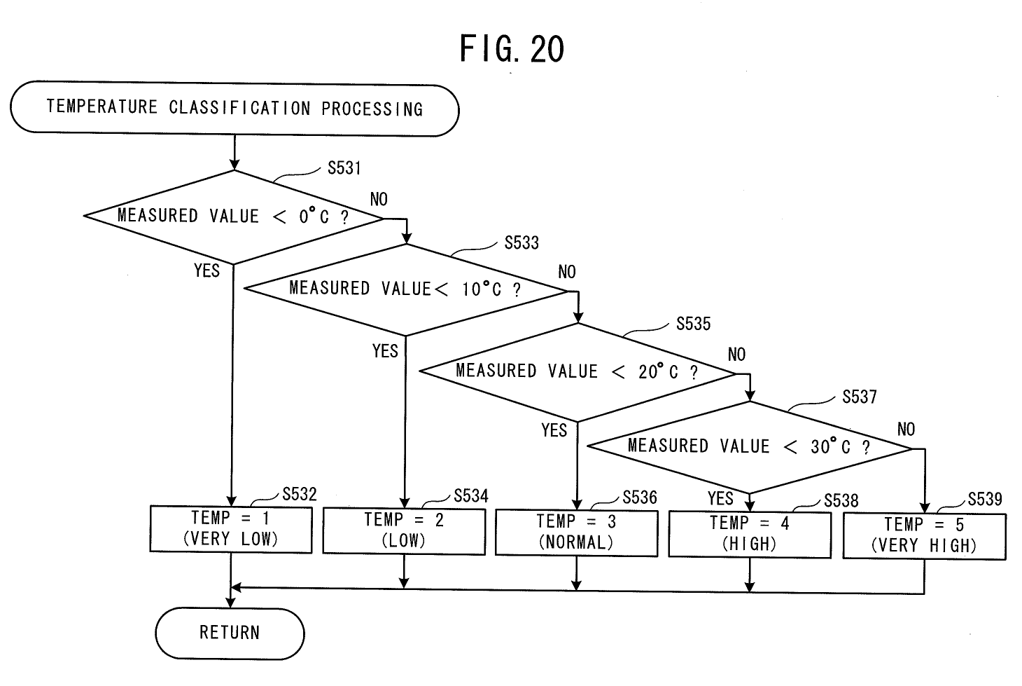

Subsequently, temperature classification processing to classify temperature data stored in the buffer 2 may be performed (S530). The temperature classification processing will be described with reference to FIG. 20. In the temperature classification processing shown in FIG. 20, the buffer 2 in the measured value storage area 31 of the RAM 30 may be referenced first to set the variable TEMP, which serves as an indicator of the temperature in the environment information inference processing, based on the measured value of the temperature sensor 13. If the measured value is less than 0° C. (Yes at S531), a value one (1), which indicates that the temperature is very low, may be set to the variable TEMP and stored into the variable storage area 32 of the RAM 30 (S532). If the measured value is 0° C. or more and less than 10° C. (No at S531, Yes at S533), a value 2, which indicates that the temperature is low, may be set to TEMP and stored into the variable storage area 32 (S534). If the measured value is 10° C. or more and less than 20° C. (No at S531, No at S533, Yes at S535), a value 3, which indicates that the temperature is normal, may be set to TEMP and stored into the variable storage area 32 (S536). If the measured value is 20° C. or more and less than 30° C. (No at S531, No at S533, No at S535, Yes at S537), a value 4, which indicates that the temperature is high, may be set to TEMP and stored into the variable storage area 32 (S538). If, like the measured value 30.1° C. in Example 2 shown in FIG. 19, the measured value is 30° C. or more (No at S531, No at S533, No at S535, No at S537), a value 5, which indicates that the temperature is very high, may be set to TEMP and stored into the variable storage area 32 (S539). When setting of TEMP is completed, the temperature classification processing terminates to return to the environment information inference processing shown in FIG. 18.

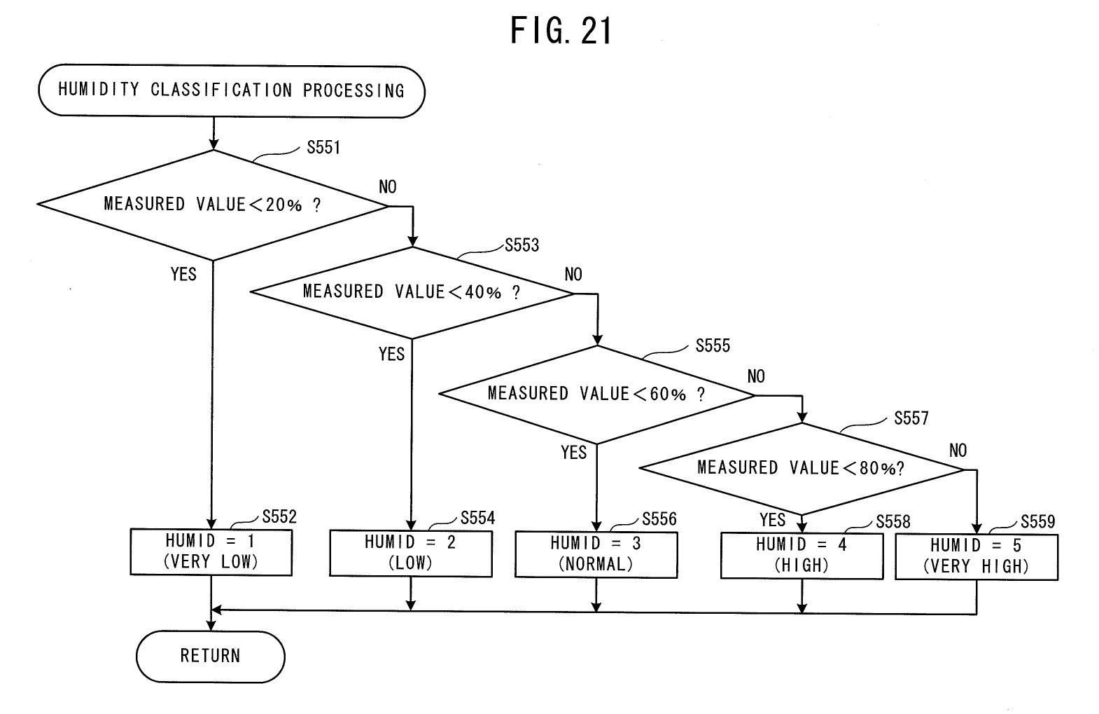

Subsequent to step S530 in FIG. 18, humidity classification processing to classify humidity data stored in the buffer 2 may be performed (S550). The humidity classification processing will be described with reference to FIG. 21. In the humidity classification processing shown in FIG. 21, the buffer 2 in the measured value storage area 31 of the RAM 30 may be referenced first to set the variable HUMID, which serves as an indicator of the humidity, may be set based on the measured value of the humidity sensor 14. If the measured value is less than 20% (Yes at S551), a value one (1), which indicates that the humidity is very low, may be set to HUMID and stored into the variable storage area 32 of the RAM 30 (S552). If the measured value is 20% or more and less than 40% (No at S5551, Yes at S553), a value 2, which indicates that the humidity is low, may be set to HUMID and stored into the variable storage area 32 (S554). If the measured value is 40% or more and less than 60% (No at S551, No at S553, Yes at S555), a value 3, which indicates that the humidity is normal, may be set to HUMID and stored into the variable storage area 32 (S556). If, like the measured value 60.8% in Example 2 shown in FIG. 19, the measured value is 60% or more and less than 80% (No at S551, No at S553, No at S555, Yes at S557), a value 4, which indicates that the humidity is high, may be set to HUMID and stored into the variable storage area 32 (S558). If the measured value is 80% or more (No at S551, No at S553, No at S555, No at S557), a value 5, which indicates that the humidity is very high, may be set to HUMID and stored into the variable storage area 32 (S559). When setting of HUMID is completed, the humidity classification processing terminates to return to the environment information inference processing shown in FIG. 18.

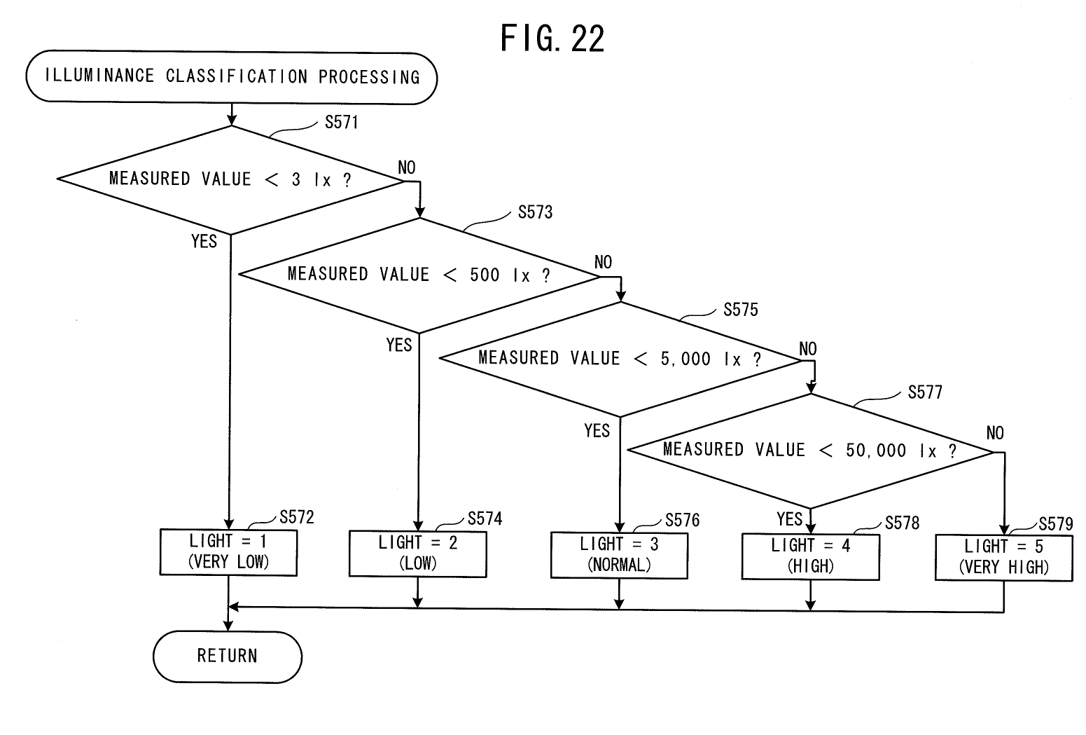

Subsequent to step S550 in FIG. 18, illuminance classification processing to classify illuminance data stored in the buffer 2 may be performed (S570). The illuminance classification processing will be described with reference to FIG. 22. In the illuminance classification processing shown in FIG. 22, the buffer 2 in the measured value storage area 31 of the RAM 30 may be referenced first to set the variable LIGHT, which serves as an indicator of the illuminance, based on the measured value of the illuminance sensor 15. If the measured value is less than 3 lx (Yes at S571), a value one (1), which indicates that the illuminance is very low, may be set to the variable LIGHT and stored into the variable storage area 32 of the RAM 30 (S572). If the measured value is 3 lx or more and less than 500 lx (No at S571, Yes at S573), a value 2, which indicates that the illuminance is low, may be set to LIGHT and stored into the variable storage area 32 (S574). If the measured value is 500 lx or more and less than 5,000 lx (No at S571, No at S573, Yes at S575), s value 3, which indicates that the illuminance is normal, may be set to LIGHT and stored into the variable storage area 32 (S576). If the measured value is 5,000 lx or more and less than 50,000 lx (No at S571, No at S573, No at S575, Yes at S577), a value 4, which indicates that the illuminance is high, may be set to LIGHT and stored into the variable storage area 32 (S578). If, like the measured value 1,200,000 lx in Example 2 shown in FIG. 19, the measured value is 50,000 lx or more (No at S571, No at S573, No at S575, No at S577), a value 5, which indicates that the illuminance is very high, may be set to LIGHT and stored into the variable storage area 32 (S579). When setting of LIGHT is completed, the illuminance classification processing terminates to return to the environment information inference processing shown in FIG. 18.

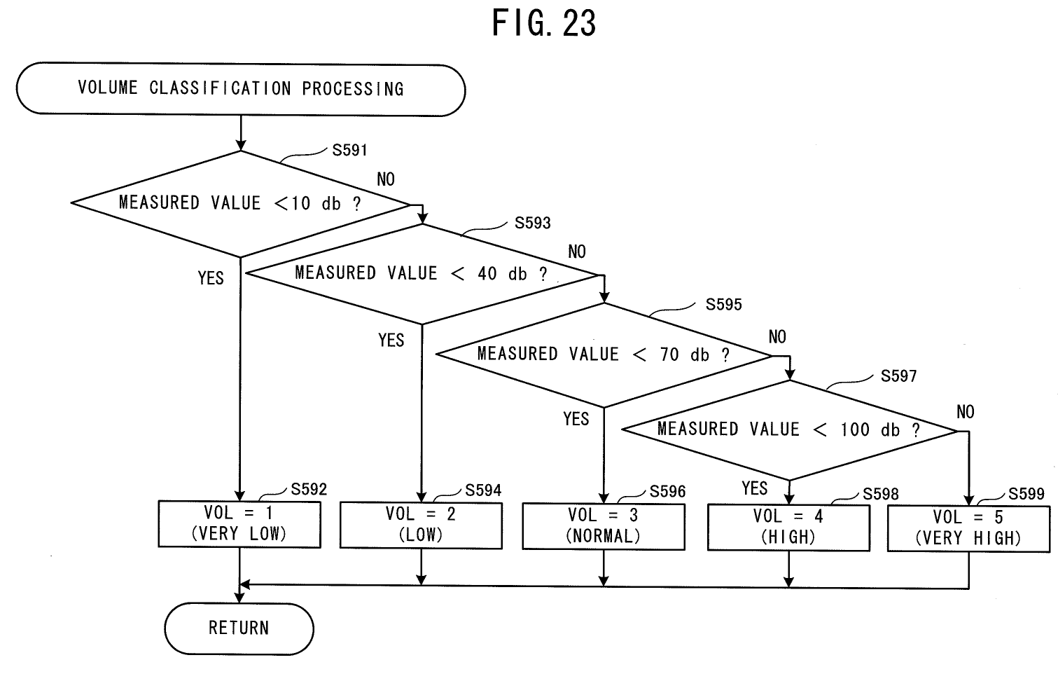

Subsequent to step S570 in FIG. 18, volume classification processing to classify sound volume data stored in the buffer 2 may be performed (S590). The volume classification processing will be described with reference to FIG. 23. In the volume classification processing shown in FIG. 23, the buffer 2 in the measured value storage area 31 of the RAM 30 may be referenced first to set the variable VOL, which serves as an indicator of the sound volume, based on the measured value of the microphone 17. If the measured value is less than 10 decibel (db) (Yes at S591), a value one (1), which indicates that the volume is very low, may be set to the variable VOL, and stored into the variable storage area 32 of the RAM 30(S592). If the measured value is 10 decibel or more and less than 40 decibel (No at S591, Yes at S593), a value 2, which indicates that the volume is low, may be set to VOL and stored into the variable storage area 32 (S594). If, like the measured value 50 decibel in Example 2 shown in FIG. 19, the measured value is 40 decibel or more and less than 70 decibel (No at S591, No at S593, Yes at S595), a value 3, which indicates that the volume is normal, may be set to VOL and stored into the variable storage area 32 (S596). If the measured value is 70 decibel or more and less than 100 decibel (No at S591, No at S593, No at S595, Yes at S597), a value 4, which indicates that the volume is high, may be set to VOL and stored into the variable storage area 32 (S598). If the measured value is 100 decibel or more (No at S591, No at S593, No at S595, No at S597), a value 5, which indicates that the volume is very high, may be set to VOL and stored into the variable storage area 32 (S599). When setting of VOL is completed, the volume classification processing terminates to return to the environment information inference processing shown in FIG. 18.

Subsequent to step S590 in FIG. 18, the variable storage area 32 of the RAM 30 and the environment information table storage area 52 of the hard disk drive 50 may be referenced. Then, the environment information table 540 shown in FIG. 24 and the variables, that is, the variable TEMP computed at step S530, the variable HUMID computed at step S550, the variable LIGHT computed at step S570, and the variable VOL computed at step S590, may be compared to compute the environment information of the terminal 100 (S610). The environment information table 540 to be referenced in this processing will be described with reference to FIG. 24. The environment information table 540 may be stored in the environment information table storage area 52 of the hard disk drive 50.

As shown in FIG. 24, the environment information table 540 in the first embodiment may store values of TEMP, HUMID, LIGHT and VOL in association with the environment information of the terminal 100 that can be inferred from these values. The variable TEMP may be computed at step S530, the variable HUMID may be computed at step S550, the variable LIGHT may be computed at step S570, and the variable VOL may be computed at step S590. In the first embodiment, as shown in FIG. 24, the environment information may be classified into one of the states of environment expressed like “cold night”, “noisy night”, “comfortable environment”, “noisy room”, “sultry daytime”, “sultry night” and “sultry” in accordance with the computed values of TEMP, HUMID, LIGHT and VOL. Such environment information may include an environment inference value representing each state as a number.

The environment information computed at step S610 will be described referring to Example 2 shown in FIG. 19. In Example 2, as described above, the value 5 may be computed as TEMP at step S530, the value 4 may be computed as HUMID at step S550, the value 5 may be computed as LIGHT at step S570, and the value 3 may be computed as VOL at step S590. Thus, by comparing these variables and the environment information table 540 shown in FIG. 24, the environment information “Sultry daytime: 3” associated with TEMP between 4 and 5, HUMID between 4 and 5, LIGHT between 4 and 5, and VOL between 3 and 5 may be obtained (S610).

Subsequently, it may be determined whether the environment inference value included in the environment information computed at step S610 is equal to one (1) or more (S620). If the environment inference value is less than one (1) (No at S620), the processing may return to S530 to repeat the processing. Such a case may correspond to a case where the environment information has not been computed normally. If, on the other hand, the environment inference value of is equal to 1 or more (Yes at S620), the environment information has been computed normally. Thus, the environment information computed at step S610 may be stored into the situation data storage area 33 of the RAM 30 as the situation data, together with the start time, the end time, and the position data stored in the buffer 2 in the measured value storage area 31 of the RAM 30 (S630). In Example 2, the environment information “Sultry daytime: 3” computed at step S610 as the environment information may be stored into the situation data storage area 33 of the RAM 30 as the situation data (S630). “2006/03/25/6/15” shown in FIG. 19 as the start time and “2006/03/25/6/30” shown in FIG. 19 as the end time may each be stored in the situation data storage area 33 as the situation data (S630). Further, the measured value “latitude: xx° 25′ 8.609″; longitude: xxx° 15′ 19.402″” of the position sensor 16 as the position data shown in FIG. 19 may be stored into the situation data storage area 33 as the situation data (S630). Subsequently, the environment information inference processing terminates to return to the main processing shown in FIG. 9. Then, at step S40 shown in FIG. 9, the situation data stored in the situation data storage area 33 may be transmitted to the management server 200 together with an ID that identifies the terminal 100 from other terminals.

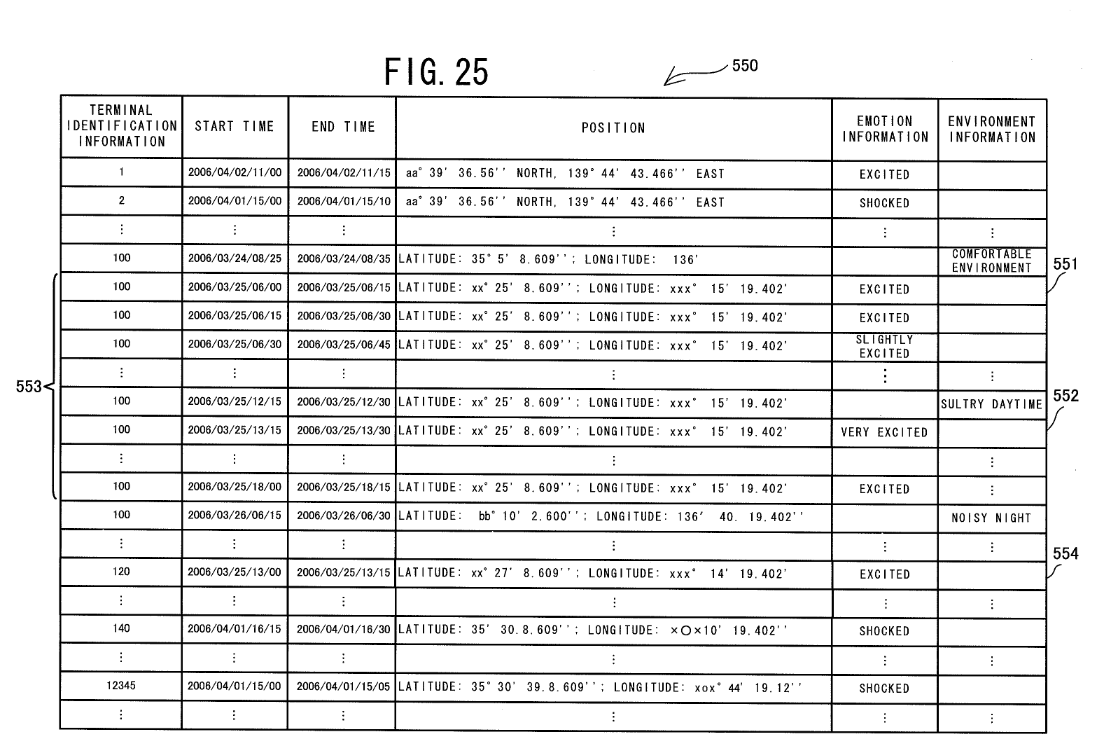

With the processing described above in detail, the emotion information of the user of the terminal 100 (S30 in FIG. 9) or the environment information of the terminal 100 (S35 in FIG. 9) may be determined from the measured values of the various sensors 12 to 17 provided to the terminal 100. Then, the situation data including one of the emotion information and environment information may be transmitted to the management server 200 (S40 in FIG. 9). The situation data may also be output to the display 21 of the terminal 100 (S45 in FIG. 9). The situation data 551 in Example 1 or the situation data 552 in Example 2 received by the management server 200 may be stored in a situation data management table 550 shown in FIG. 25 in the situation data storage area 182 of the management server 200, together with an ID “100” for identifying the terminal 100 from other terminals.

A terminal according to the present disclosure is not limited to the terminal 100 in the first embodiment described above and may suitably be modified without deviating from the scope of the present disclosure. For example, while a mobile phone is employed as an example of the terminal 100, the terminal is not limited to a mobile phone, but may be a mobile information terminal, an information providing terminal installed at a public place, a personal computer, or the like.

In the terminal 100 in the first embodiment, an average body information table is stored in the hard disk drive 50 in advance. Instead of the hard disk drive 50, any device to allow the user to set the above information table may be employed. For example, the terminal 100 may be provided with an “Average body information table setting” menu for an operation so that the user may select the menu when the user is in good physical conditions and in a calm state (a state not out of breath after calming down for a while). In such a case, after the menu is selected by the user, the terminal 100 may obtain the body information from the various sensors 12 to 17 to store values thereof in the average body information table as average body information.

The terminal 100 in the first embodiment is provided with the heart rate sensor 12, the temperature sensor 13, the humidity sensor 14, the illuminance sensor 15, the position sensor 16, and the microphone 17 as the various sensors 12 to 17. However, sensors to be provided to the terminal 100 are not limited to these sensors. For example, a pressure-sensitive sensor may be employed as a sensor, or one or some of the various sensors 12 to 17 included in the terminal 100 may be omitted. The terminal 100 in the first embodiment computes either of the emotion information and the environment information from measured values acquired from the various sensors 12 to 17 shown in FIG. 9. However, the terminal 100 may be configured to be able to compute only one of the emotion information and the environment information. Instead of computing the emotion information or the environment information from measured values acquired from the various sensors 12 to 17, the measured values may be transmitted to the management server 200 as the situation data at step S40 in FIG. 9, together with the identification information of the terminal 100 for distinguishing the terminal 100 from other terminals. In such a case, the measured values of various sensors may be acquired as the body information, the surrounding information, or both the body information and the surrounding information. That is, the situation data may be data including at least one of the body information of the user holding the terminal 100, the emotion information inferred from the body information, and surrounding information of the terminal 100, and the environment information inferred from the surrounding information.

In the above-described embodiment, the emotion information inference processing to infer the emotion information of the user of the terminal 100 or the environment information inference processing to infer the environment information of the terminal 100 is performed based on measured values of the various sensors 12 to 17 in the main processing of the terminal 100 shown in FIG. 9. However, a portion or all of the above processing may be performed by a server. In such a case, if the server is divided into two servers, the management server 200 and the content server 300, as in the case of the first embodiment, a portion or all of the emotion information inference processing and the environment information inference processing may be performed by either of the management server 200 and the content server 300.

The terminal 100 in the first embodiment transmits the situation data to the management server 200 via the communication unit 60 at step S40 shown in FIG. 9 each time the situation data is acquired. However, a timing to transmit the situation data to the management server 200 is not limited to this timing. For example, the following first to third modified embodiments, in which the timing to transmit situation data to the management server 200 is varied, may be employed.

In the first modified embodiment, when a predetermined number of pieces of the situation data that have not yet been transmitted are stored in the situation data storage area 33 of the RAM 30, the situation data pieces that have not yet been transmitted may be transmitted to the management server. Therefore, prior to the processing at step S40 shown in FIG. 9, it may be determined whether the predetermined number of pieces of the situation data that have not yet been transmitted to the management server 200 are stored in the situation data storage area 33 of the RAM 30. If it is determined that the predetermined number of pieces of the situation data are stored in the situation data storage area 33, the situation data pieces that have not yet been transmitted to the management server 200 may be transmitted to the management server 200. If, on the other hand, it is determined that the predetermined number of pieces of the situation data are not stored in the situation data storage area 33, processing to store the situation may be repeated until the predetermined number of pieces of the situation data are stored into the situation data storage area 33. According to the first modified embodiment, if the predetermined number is determined in accordance with a frequency of acquiring the situation data, capacities of a storage device that stores the situation data provided to the terminal and the like, the situation data may be stored into a storage device provided to the server at an appropriate timing.

In the second modified embodiment, an inquiry device may be provided to the server to make an inquiry from the server to the terminal about whether or not the situation data that has not yet been transmitted to a server is stored in the situation data storage area 33 of the RAM 30. Then, when such an inquiry is made from an inquiry device of the server, situation data that has not yet been transmitted and that are stored in the situation data storage area 33 may be transmitted to the server. In such a case, prior to the processing at step S40 shown in FIG. 9, it may be determined whether an inquiry has been received from the server. If it is determined that the inquiry has been received from the server, the situation data that has not yet been transmitted to the management server 200 may be transmitted to the management server 200. If, on the other hand, it is determined that no inquiry has been received from the server, the processing to store the situation data may be repeated until it is determined that the inquiry has been received from the server. According to the second modified embodiment, the situation data may be stored in the storage device provided to the server at an appropriate timing needed by the server.

In the third modified embodiment, the situation data that has not yet been transmitted and that is stored in the situation data storage area 33 of the RAM 30 may be transmitted to the server each time a predetermined time passes. In such a case, prior to the processing at step S40 shown in FIG. 9, for example, it may be determined whether the predetermined time has passed since the situation data was transmitted to the management server 200 last time. If it is determined that the predetermined time has passed, the situation data that has not yet been transmitted to the management server 200 may be transmitted to the management server 200. If, on the other hand, it is determined that the predetermined time has not passed, the processing to store the situation data may be repeated until it is determined that the predetermined time has passed. According to the third modified embodiment, the latest situation data may be stored in a storage device provided to the server each time the predetermined time passes.

Next, main processing performed by the content server 300 will be described with reference to FIGS. 26 to 34. In the main processing of the content server 300, at least one of the edited data and the extracted situation data that satisfies a situation data condition may be added to an updated content. The situation data condition may be determined by analyzing a character string (S) included in the content. A server program for various kinds of processing of the content server 300 shown in FIGS. 26, 27, and 29 may be stored in the ROM 230 and executed by the CPU 210 shown in FIG. 8.

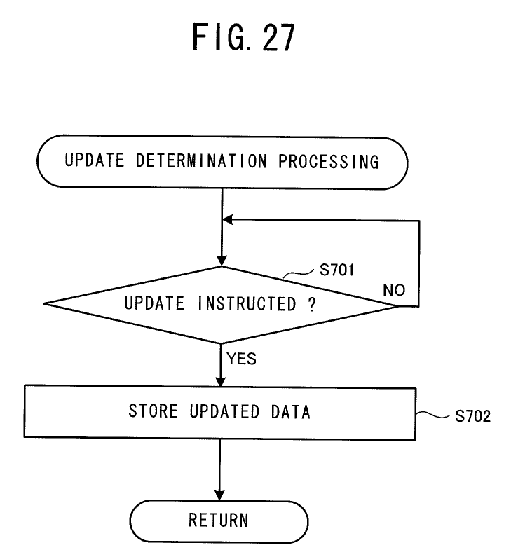

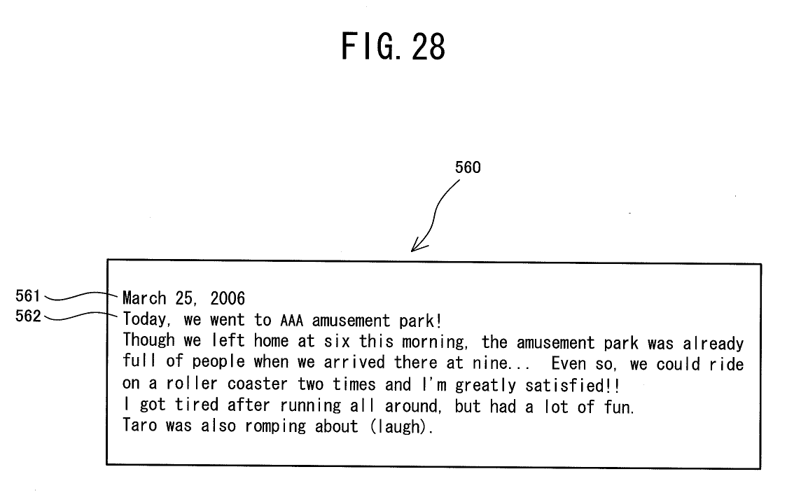

In the main processing shown in FIG. 26, update determination processing to determine whether a content has been updated may be performed (S700). In the first embodiment, if it is determined that a content has been updated, character strings included in the updated content may be analyzed. The processing at step S700 may be performed to determine whether a content to be analyzed has been updated. The update determination processing at step 700 will be described with reference to FIG. 27. In the update determination processing shown in FIG. 27, it is determined whether an update has been instructed (S701). Here, if new data has been received via the communication device 290, it may be determined that an update has been instructed (Yes at S701). If no new data has been received, it may be determined that an update has not been instructed (No at S701). When a new content is written (new data is received via the communication device 290) from a terminal that can be connected to a network such as a PC and a mobile phone, the content server 300 may determine that a new content has been received. Example 3, in which a content shown in FIG. 28 has been received via the communication device 290 (Yes at S701), will be employed to describe the processing. The content shown in FIG. 28 is an entry of a Weblog content, which may include an entry, a comment, and a trackback. The entry 560 includes a title 561 and text 562. In Example 3, the entry 560 has been transmitted to the content server 300 together with identification information of an author of the updated content. The identification information of an author of the updated content in Example 3 is assumed to be “Hanako”.

Subsequently, the content received via the communication device 290 may be stored into the content storage area 283 of the hard disk drive 280 as update data, together with a current time (S702). The current time may represent the time at which the updated content is stored into the content storage area 283 of the hard disk drive 280. Subsequently, the processing may return to the main processing shown in FIG. 26. Although an update instruction may be acquired at step S700 each time a content is updated as described above, whether to acquire an update instruction may be determined each time a fixed time passes. In addition, whether or not a content has been updated may be determined by referencing an update flag indicating an update of a content. Further, whether or not a content has been updated may be determined by computing a difference of a content each time a fixed time passes and, if a difference is detected, the content may be determined to have been updated.

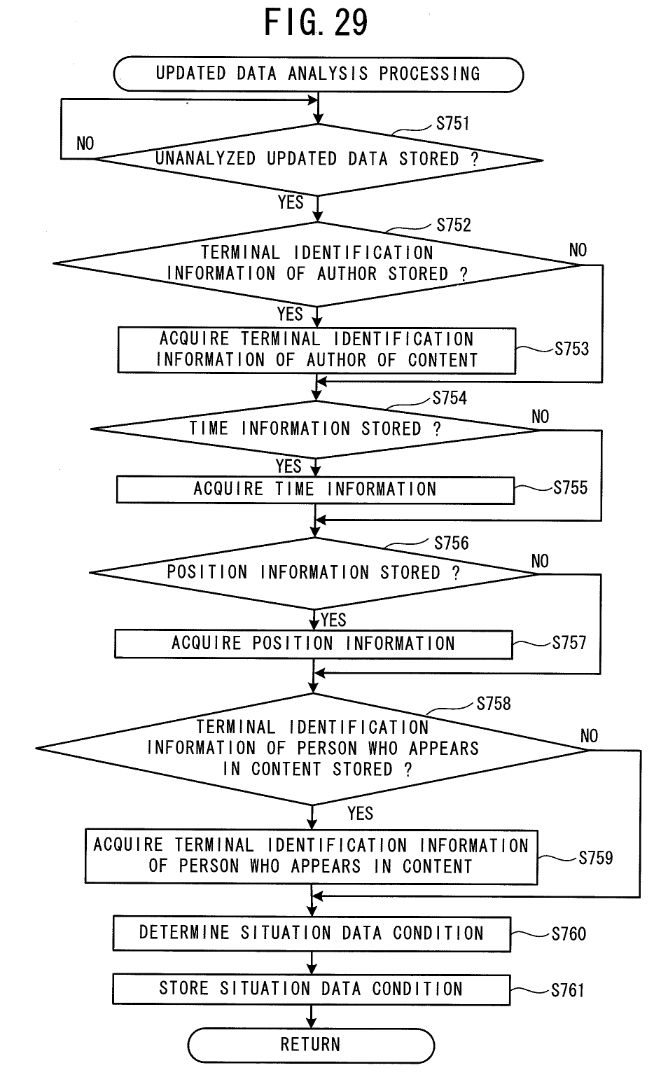

Subsequent to step S700 shown in FIG. 26, the content storage area 283 and the analysis dictionary storage area 284 in the hard disk drive 280 may be referenced to analyze the character strings in the update data (S750). The updated data analysis processing at step 750 will be described with reference to FIGS. 29 to 32. In the updated data analysis processing in FIG. 29, it may be determined whether the update data that has not yet been analyzed (herein after referred to as “unanalyzed update data”) is stored in the content storage area 283 of the hard disk drive 280 (S751). Here, the unanalyzed update data may be identified. Whether or not the update data stored in the content storage area 283 has been analyzed may be determined, for example, by referencing an update flag provided for each piece of the update data to identify whether the update data has been updated. The determination at step S751 may be made each time a fixed time passes or, for example, each time a content is updated. If it is determined that there is no unanalyzed update data (No at S751), the processing may not proceed to the next step until it is determined that unanalyzed update data is present (Yes at S751).

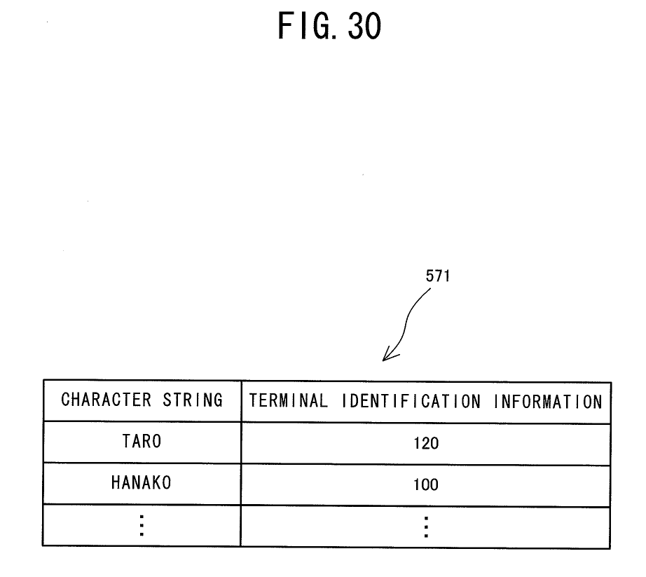

On the other hand, if it is determined that the unanalyzed update data is present (Yes at S751), the analysis dictionary storage area 284 in the hard disk drive 280 may be referenced to determine whether the terminal identification information of the author of the update data to be analyzed is stored in a terminal analysis dictionary 571 (S752). The terminal analysis dictionary 571 to be referenced in this processing may include a correspondence between a character string and the terminal identification information, as shown in FIG. 30. The character string may include identification information of an author of a content. In Example 3, information about the user who updated the entry 561 is not contained in the entry 560 shown in FIG. 28. However, as described above, “Hanako”, which is identification information of the author, may be attached to the entry 560. In such a case, “Hanako” is a character string included in the terminal analysis dictionary 571 and thus, it may be determined that the terminal identification information of the author is included (Yes at S752). Thus, a value 100 corresponding to “Hanako” may be acquired as the terminal identification information of the author (S753). If, on the other hand, the author of the content is not identified, for example, when the content is news or the like, it may be determined that terminal identification information of the author is not included (No at S752).

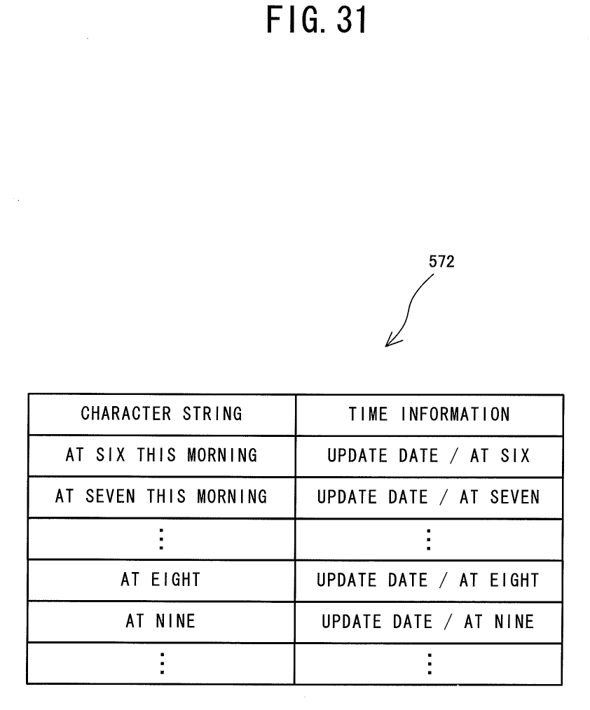

Subsequently, the analysis dictionary storage area 284 in the hard disk drive 280 may be referenced. Then, the character string in the update data stored in the content storage area 283 and character string included in a time analysis dictionary 572 may be compared. The time analysis dictionary 572 may include a correspondence between a character string and time information, as shown in FIG. 31. It may be determined whether the time information that corresponds to a character string included in the content is included in the time analysis dictionary 572 (S754). In Example 3, character strings “at 6 this morning” and “at 9” stored in the time analysis dictionary 572 shown in FIG. 31 are included in the entry 560 shown in FIG. 28. Thus, it may be determined that the time information is present (Yes at S754). Then, “2006/03/25/6/00” corresponding to the character string “at 6 this morning” included in the content and “2006/03/25/9/00” corresponding to the character string “at 9” may be acquired (S755). As the update date of the time information in FIG. 31, the time when the content is stored into the content storage area 283 may be acquired. In the first embodiment, the update date may also be acquired as the time information. Thus, in Example 3, the update date “2006/03/25” may also be acquired as the time information. On the other hand, if it is determined that the content includes no character string in the time analysis dictionary 572 shown in FIG. 31, it may determined that the time information is not present (No at S754).

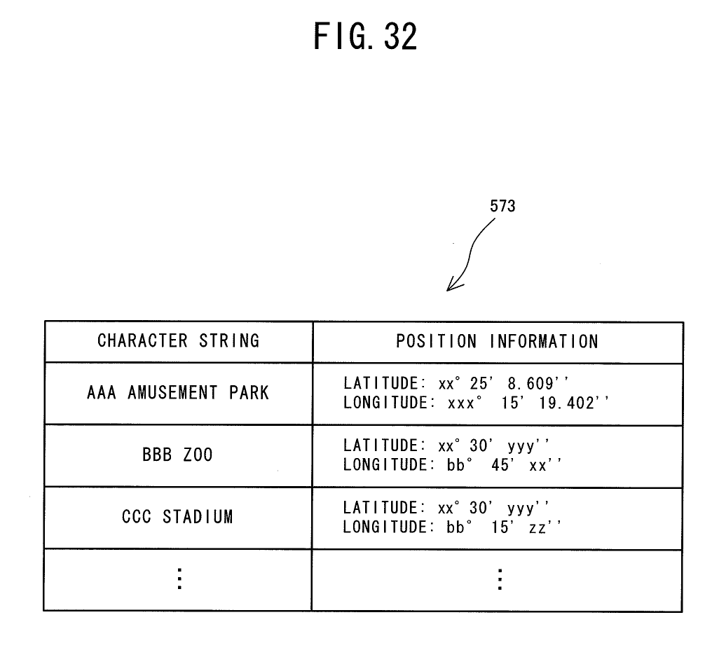

Subsequently, the analysis dictionary storage area 284 in the hard disk drive 280 may be referenced. Then, the character string in the content stored in the content storage area 283 and a character string included in a position analysis dictionary 573 may be compared. The position analysis dictionary 573 may include a correspondence between a character string and position information represented by a latitude and a longitude, as shown in FIG. 32. It may be determined whether position information that corresponds to a character string included in the content is present in the position analysis dictionary 573 (S756). In Example 3, the entry 560 shown in FIG. 28 includes a character string “AAA amusement park” stored in the position analysis dictionary 573 shown in FIG. 32. Thus, it may be determined that the position information is present (Yes at S756). Then, “latitude: xx° 25′ 8.609″; longitude: xxx° 15′ 19.402″” corresponding to the character string “AAA amusement park” included in the content may be acquired (S757). On the other hand, if it is determined that the content includes no character string in the position analysis dictionary 573 shown in FIG. 32, it may be determined that the time information is not present (No at S756).

Subsequently the analysis dictionary storage area 284 in the hard disk drive 280 may be referenced. Then, the character string in the content stored in the content storage area 283 and a character string included in the terminal analysis dictionary 571 shown in FIG. 30 may be compared. It may be determined whether terminal identification information of a person who appears in the content that corresponds to a character string in the content is present (S758). The terminal analysis dictionary to be referenced in this processing may be the same as the terminal analysis dictionary 571 referenced at step S752. Alternatively, a different dictionary from the terminal analysis dictionary 571 referenced at step S752 may be employed. In Example 3, the entry 562 shown in FIG. 28 includes the character string “Taro” stored in the terminal analysis dictionary shown in FIG. 30. Thus, it may be determined that the terminal identification information of a person who appears in the content is present (Yes at S758). Subsequently, a value “120” corresponding to the character string “Taro” included in the content may be acquired (S759). On the other hand, if it is determined that the content includes no character string stored in the terminal analysis dictionary 571 shown in FIG. 30, it may be determined that the terminal identification information of a person in the content is not present (No at S758).

Subsequently, the situation data condition may be determined by combining the information pieces respectively acquired at steps S753, S755, S757, and S759 (S760). The situation data condition refers to an extraction condition for extracting the situation data related to the updated content. In Example 3, the following information has been acquired so far. Specifically, “100” has been acquired as the terminal identification information of the author at step S753. “2006/03/25/6/00”, “2006/03/25/9/00”, and “2006/03/25” have been acquired as the time information at step S755. “Latitude: xx° 25′ 8.609″; longitude: xxx° 15′ 19.402″” has been acquired as the position information at step S757. “120” has been acquired as the terminal identification information of the person who appears in the content at step S759. In this example, the situation data condition may be determined by combining the above information. All information pieces acquired at steps S753, S755, S757, and S759 may be combined, or a part of the information pieces may be combined according to a predetermined rule. The predetermined rule for a combination may be determined arbitrarily. For example, if the terminal identification information of the user is included in the acquired information, the terminal identification information may always be included in the combination. If the terminal identification information of a person in a content is included in the acquired information, the terminal identification information of the person and the time information may be combined. Such a rule may be stored in the hard disk drive 280 or the like in advance or a rule may be specified depending on a character string included in content. In the first embodiment, in order to simplify a description, it is assumed that a rule to determine a combination is stored in the hard disk drive 280. This rule defines that a combination of the terminal identification information and the time information acquired from the update date is determined as the situation data condition. According to the rule, a combination of “100” as the terminal identification information of the user and the time information “2006/03/25” may be determined as a first situation data condition. In addition, a combination of “120” as the terminal identification information of a person who appears in the content and the time information “2006/03/25” may be determined as a second situation data condition (S760).

Subsequently, the situation data condition determined at step S760 may be stored into a situation data condition storage area (not shown) of the RAM 220 (S761), and the updated data analysis processing terminates and the processing returns to the main processing shown in FIG. 26. In the main processing shown in FIG. 26, subsequent to step S750, the situation data condition storage area in the RAM 220 may be referenced and the situation data condition determined at S750 and an inquiry ID may be transmitted to the management server 200 via the communication device 290 (S800). This processing may be performed to make an inquiry at the management server 200 about whether the situation data satisfying the situation data condition determined at step S750 is stored in the management server 200. The inquiry ID may be used to identify the content from which the situation data condition is obtained by analyzing the content.

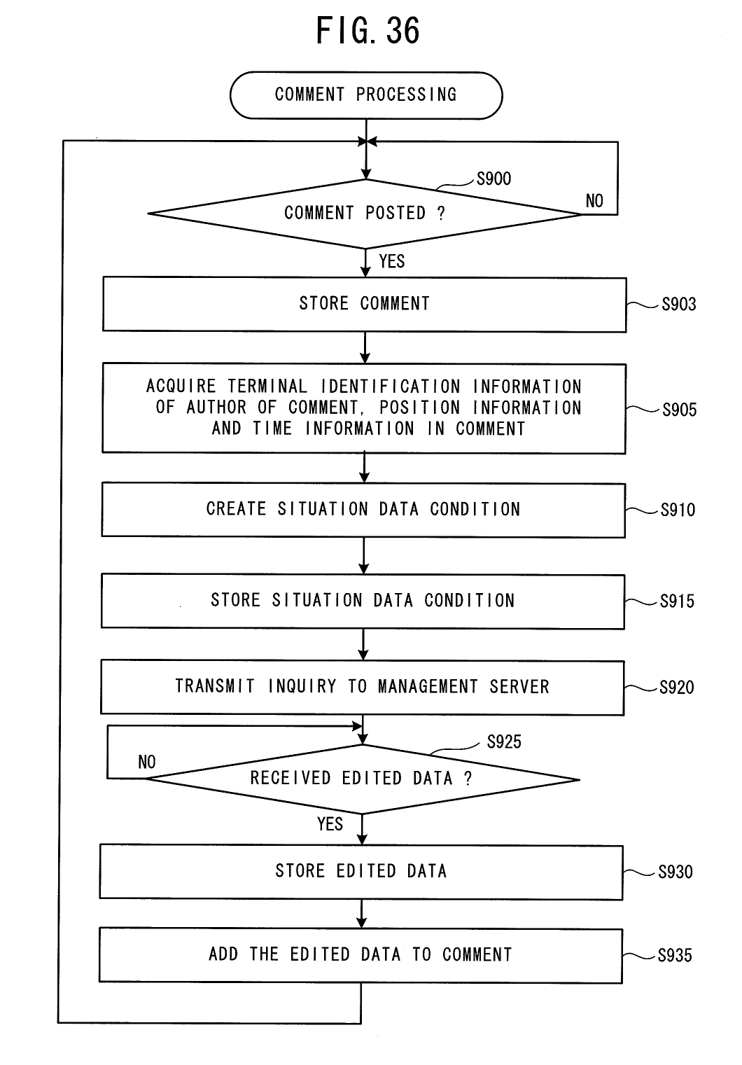

Subsequently, it may be determined whether edited data has been received in response to the inquiry at step S800 (S810). The edited data may be transmitted in second main processing of the management server 200, which will be described later with reference to FIG. 36. The edited data herein refers to data obtained by performing editing processing according to a predetermined method on extracted situation data. The extracted situation data herein refers to data that satisfies the situation data condition transmitted at step S800, among the situation data transmitted from the terminal 100 and stored in the management server 200. The edited data may include, for example, an icon or an illustration corresponding to the extracted situation data, a numerical value obtained by performing statistical processing on the extracted situation data, or a table or a graph created by performing statistical processing on the extracted situation data. If it is determined that no edited data has been received (No at S810), the processing may not proceed to the next step until it is determined that the edited data has been received (Yes at S810). As described later, in the second main processing of the management server 200 shown in FIG. 40, if the situation data that satisfies the situation data condition is not extracted as the extracted situation data, information indicating that no situation data has been extracted may also be transmitted to the content server 300. Thus, a response to the inquiry at step S800 may always be received.

If, on the other hand, it is determined that the edited data has been received (Yes at S810), the edited data may be stored into an edited data storage area (not shown) of the RAM 220 (S820). In Example 3, information about an icon corresponding to the emotion information “excited”, for example, may be received as the edited data corresponding to the first and the second situation data conditions, together with the same inquiry ID as transmitted at step S800 (Yes at S810). The received edited data may be stored into the edited data storage area (not shown) of the RAM 220 (S820). The information about the icon may include image data of the icon or icon identification information to identify the icon. In the first embodiment, it may be assumed that ID for identifying the icon is included as the information about the icon.

Subsequently, the content storage area 283 of the hard disk drive 280 and the edited data storage area (not shown) of the RAM 220 may be referenced, and the edited data received at step S810 may be added to the content being analyzed (S830). In Example 3, the icon included in the edited data acquired at step S810 may be added to the content that corresponds to the inquiry ID, and the content to which the edited data is added may be stored into the content storage area 283 (S830). The icon may be added, for example, by directly adding image data of the icon, or inserting a predetermined tag specifying the icon to be inserted by icon identification information. In Example 3, a predetermined tag may be added to the content.

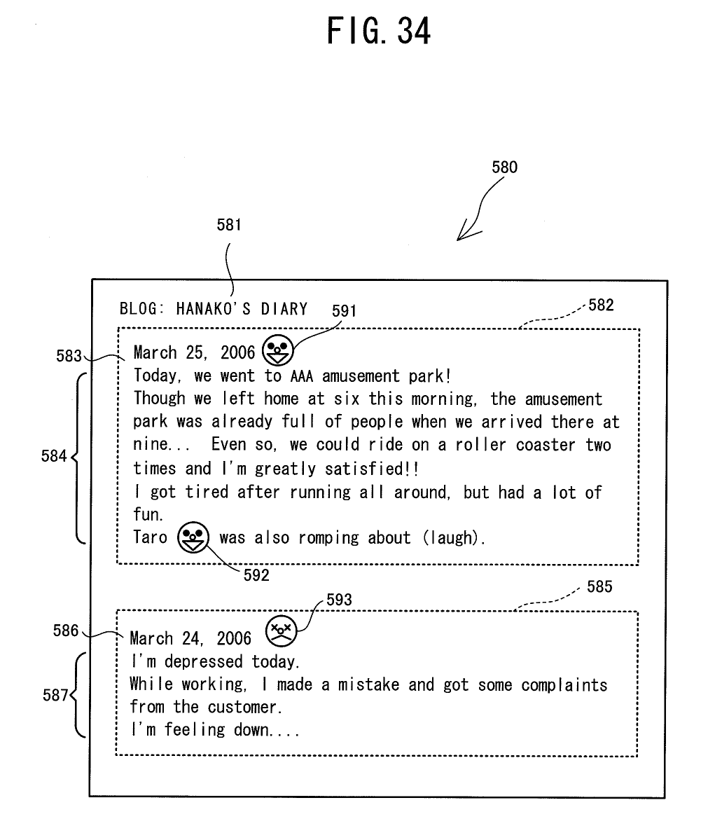

A screen 580 displayed on a browser will be described with reference to FIG. 34. The screen 580 may show the content of Example 3, to which the edited data has been added in the processing at step S830. The screen 580 in FIG. 34 may be displayed on a terminal such as the PC 2 used by a reader, based on information presented (transmitted) by the content server 300. As shown in FIG. 34, a title 581 of a Weblog content and entries 582 and 585 may each be displayed in the screen 580 displayed on the browser. The entries 582 and 585 may have titles 583 and 586 and text 584 and 587, respectively. An icon may be inserted after each of the titles 583 and 586 of the entries 582 and 585, and also after the character string “Taro” indicating a person who appears in the text 584 of the entry 582. The content storage area 283 may be updated with the entries 582 and 585 to which the icons are added (S830). An icon 591 may be included in the edited data corresponding to the first situation data condition, and an icon 592 may be included in the edited data corresponding to the second situation data condition.

The position to which an icon is added and the size of an icon may optionally be determined. For example, as in Example 3, an icon may be added after the title or the character string stored in the analysis dictionary with about twice the size of characters of the title. Or, an icon may be added to a position that is different from the positions in Example 3, with any size to be displayed. For example, the icon may be added before the title or the character string stored in the analysis dictionary. Subsequently, the processing may return to step S700 to repeat the processing. If the edited data received at step S810 is data indicating that no situation data satisfying the situation data condition has been extracted, the edited data may not be added to the content at step S830.

With the processing described above in detail, the edited data may be obtained by performing predetermined editing processing on the extracted situation data satisfying the situation data condition determined by analyzing the character strings in the content, and added to the updated content.

A content server according to the present disclosure is not limited to the content server 300 in the first embodiment, and may suitably be modified without deviating from the scope of the present disclosure. In the main processing shown in FIG. 26, for example, the edited data received at step S810 may be added to an analyzed content, but the present disclosure is not limited to this example. For example, instead of the edited data, the extracted situation data may be received at step S810, and may be added to the content at step S830. Further, the extracted situation data and the edited data may be received at step S810, and may be transmitted to the terminal 100 of the author of the analyzed content. In such a case, because the server is provided with a transmission device that transmits extracted situation data or edited data added to a content to the terminal 100, the user of the terminal 100 can know what information is added to the content.

Also, in the main processing shown in FIG. 26, character strings included in the content stored in the content storage area 283 of the hard disk drive 280 and character strings stored in the analysis dictionary storage area 284 may be compared in the updated data analysis processing shown in FIG. 29. Then, the position information, the time information, and the terminal identification information each corresponding to a character string in the content may be acquired (S757, S755, S753 and S759). However, the analysis method of character strings of the updated content is not limited to the method in the first embodiment. If, for example, a character string that specifies the position information, the time information, or the terminal identification information for determining the situation data condition is included in the updated content, the character string in the content and the character string stored in the analysis dictionary storage area 284 may be compared. Then, the information specified by the author of the content may be extracted. As a method of including a character string that specifies the position information, the time information, or the terminal identification information for determining the situation data condition in the updated content, for example, a method of including a predetermined tag that is not to be displayed on a browser in the content may be employed. Also, for example, a file or the like that includes a character string that specifies the position information, the time information, or the terminal identification information may be attached to the content. In the method of including a predetermined tag that is not to be displayed on a browser in the content, for example, whether or not a tag specifying the terminal identification information of the user is inserted may be determined in the updated data analysis processing in FIG. 29 (S752). Then, if it is determined that such a tag is inserted (Yes at S752), the terminal identification information of the author contained in the tag may be acquired (S753). The processing to determine whether or not the time information is contained (S754), whether or not the position information is contained (S756), or whether or not the terminal identification information of characters is contained (S758) may be performed similarly. If a file or the like containing a character string for specifying the position information, the time information, or the terminal identification information is attached to the content, the file attached to the content may be referenced to acquire the position information, the time information, or the terminal identification information.

Although in the first embodiment, an icon may be directly added to the content as the edited data, link information indicating a location of an icon may be added to a predetermined character string. A fourth modified embodiment, in which the link information indicating the location of the icon is added to the predetermined character string, will be described with reference to FIG. 35. The screen 600 in FIG. 35 may be displayed based on information presented (transmitted) from the content server 300 on a terminal such as the PC 2 used by a reader.

In the modified embodiment 4, the link information indicating the location may be added to the predetermined character string at step S830 shown in FIG. 26. The predetermined character string may optionally be determined. The title or the character string corresponding to the terminal identification information, the time information, or the position information acquired in the updated data analysis processing shown in FIG. 29 may be employed as the predetermined character string. In Example 3, for example, as shown in FIG. 35, a title 601 and entries 602 and 605 of a Weblog content may each be displayed in the screen 600 displayed on the browser. The entries 602 and 605 may have titles 603 and 606 and text 604 and 607, respectively. Among these, link information indicating the location of an icon 609 corresponding to a first situation data condition may be added to the title 603 of the entry 602. Also, link information indicating a location of an icon corresponding to the second situation data condition may be added to the character string “Taro” corresponding to the terminal identification information of a person who appears in the text 604. Similarly, link information indicating a location of an icon 593 in FIG. 34 may be added to the title 606 of the entry 605. Then, for example, if the title 603 is clicked (an operation indicated by an arrow 611), the icon 609 may be displayed.

In the first embodiment, a Weblog content containing an entry, a comment, and a trackback is described as an example, but a content stored in the content server 300 is not limited to a Weblog content. For example, a Web page may be adopted as a content. Also, in the first embodiment, an update of an entry of a Weblog content is described as an example. However, when a comment is updated, like when a content is an entry described in the first embodiment, edited data may be added to the comment and the comment may be stored, as in a fifth modified embodiment below. Or, for example, the edited data may be added and stored only when the updated Weblog content is an entry.

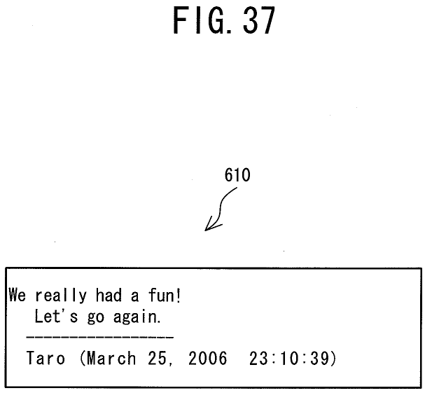

Comment processing performed in the content server 300 when a comment of a Weblog content is updated will be described with reference to FIGS. 36 to 38 as the fifth modified embodiment. As Example 4 to describe the fifth modified embodiment, a case in which a comment 610 shown in FIG. 37 is updated as a comment on the entry 582 shown in FIG. 34 in Example 3 will be described. A server program for the processing of the content server 300 in the fifth modified embodiment shown in FIG. 36 may be stored in the ROM 230 and executed by the CPU 210 shown in FIG. 8.

The comment processing shown in FIG. 36 may be the same with the main processing shown in FIG. 26, basically. First, it may be determined whether a comment has been posted (S900). If it is determined that no comment has been posted (No at S900), the processing may not proceed to the next step until it is determined that a comment has been posted. Whether the updated content is an entry or a comment may be determined, for example, based on identification information added to the content. If it is determined that a comment has been posted (Yes at S900), the posted comment is stored into the content storage area 283 of the hard disk drive 280 (S903). Then, terminal identification information of a user who posted the comment and position information and time information included in the comment may be acquired (S905). The above information may be acquired, for example, by performing processing similar to the updated data analysis processing shown in FIG. 29. In Example 4, after character strings in the comment shown in FIG. 37 are analyzed, the terminal identification information “Taro” of the user who posted the comment and the time information “2006/03/25” may be acquired. Then, a situation data condition may be determined by combining the information acquired at step S905 (S910). With this processing, for example, a combination of the terminal identification information “Taro” and the time information “2006/03/25” may be determined as the situation data condition in Example 4. The situation data condition in Example 4 is the same as the second situation data condition in Example 3 described above, and hereinafter, the situation data condition in Example 4 may be called as third situation data condition. The method of determining the situation data condition may be changed depending on whether the content is an entry or a comment, or may be the same regardless of a type of the content. Then, the situation data condition determined at step S910 may be stored into the situation data condition storage area (not shown) in the RAM 220 (S915). Then, the situation data condition determined at step S910 and an inquiry ID may be transmitted to the management server 200 via the communication device 290 (S920).

Subsequently, it may be determined whether edited data has been received in response to the inquiry at step S920 (S925). The edited data may be transmitted in the second main processing of the management server 200, which will be described later with referenced to FIG. 40. If it is determined that no edited data has been received (No at S925), the processing may not proceed to the next step until it is determined that the edited data has been received (Yes at S925). If it is determined that edited data has been received (Yes at S925), the edited data may be stored into the edited data storage area (not shown) of the RAM 220 (S930). In Example 4, the same icon as that corresponding to the second situation data condition, for example, may be received as the edited data corresponding to the third situation data condition. Then, the edited data stored at step S930 may be added to the comment corresponding to the inquiry ID (S935). With this processing, for example, in Example 4, the icon may be added to the end of the comment, and the comment to which the icon is added may be stored into the content storage area 283 of the hard disk drive 280 (S930). Then, the processing may return to step S900 to repeat the processing.

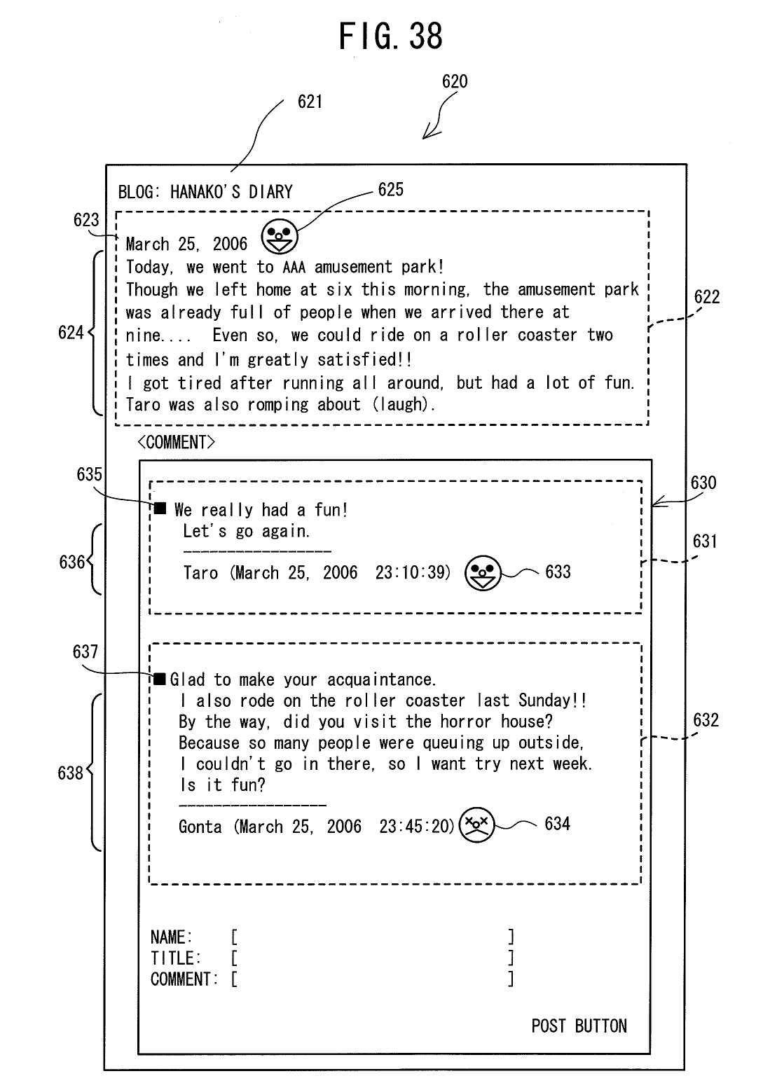

A screen 620 displayed on a browser will be described with reference to FIG. 38. The screen 620 may show to show the content of Example 4, to which the icon has been added in the processing at step S930. The screen 620 in FIG. 38 may be displayed on a terminal such as the PC 2 used by a reader, based on information presented (transmitted) from the content server 300. As shown in FIG. 38, a title 621 of a Weblog content, an entry 622, and comments 630 posted on the entry 622 may each be displayed in the screen 620 displayed on the browser. The entry 622 may have a title 623 and text 624. Moreover, the entry 622 may have an icon 625 added thereto. The comments 630 may include a comment 631 and a comment 632, and the comments 631 and 632 may each contain titles 635 and 637 and text 636 and 638, respectively. Among these, an icon 633 received at step S925 may be added to the end of the text 636 regarding the comment 631 corresponding to Example 4. Also, an icon 634 received at step S925 may be added to the end of the text 638 by similar processing regarding the comment 632. The position to which an icon may be added and the size of an icon may optionally be determined.

According to the situation presentation system 1 in the fifth modified embodiment, information about emotions of the user who posted a comment or the environment around the terminal of the user may be added to the comment by analyzing character strings of the updated comment. Thus, a substance of the comment can also be conveyed to readers more realistically.

Next, the first and second main processing performed by the management server 200 will be described with reference to FIGS. 39 to 42. In the first main processing of the management server 200, the situation data transmitted from the terminal 100 may be received and stored into the situation data storage area 182. In the second main processing of the management server 200, the situation data that satisfies the situation data condition may be extracted as the extracted situation data in accordance with an inquiry from the content server 300. Then, after performing predetermined editing processing on the extracted situation data, processing to transmit the data to the content server 300 may be performed. A server program for various kinds of processing to be performed in the management server shown in FIGS. 39 to 42 may be stored in the ROM 130 and executed by the CPU 110 shown in FIG. 7.

First, the first main processing will be described with reference to FIG. 39. In the first main processing shown in FIG. 39, various settings of the management server 200 may be initialized (S75). Then, it may be determined whether the situation data transmitted from the terminal 100 has been received via the communication device 190 (S80). This processing may be performed to have the situation data stored into the situation data storage area 182 of the hard disk drive 180 when the situation data is received. If it is determined that no situation data has been received (No at S80), the processing may not proceed to the next step until it is determined that the situation data has been received (Yes at S80). If, on the other hand, it is determined that the situation data has been received (Yes at S80), the situation data may be stored into the situation data storage area 182 of the hard disk drive 180 (S85). In the processing to store the situation data in the situation data storage area 182, for example, the situation data may be classified by the terminal identification information before being stored into separate sub-areas or may be stored in order of reception by the management server 200. If the situation data of Example 1 and Example 2 is received as the situation data, the situation data may be stored in the situation data management table 550 as shown in FIG. 25 in the situation data storage area 182 of the management server 200. In the situation data management table 550 shown in FIG. 25, each piece of the situation data may be stored in order of reception by the management server 200 for each piece of the terminal identification information. Then, the processing may return to step S80 to repeat the processing. With the first main processing, the situation data transmitted from the terminal 100 may be stored into the situation data storage area 182 at any time.

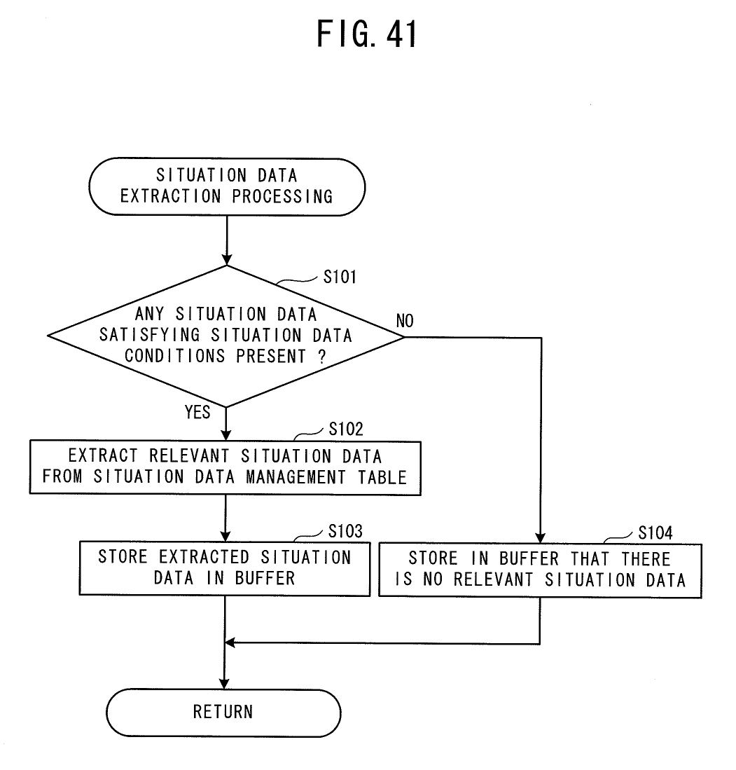

Next, the second main processing will be described with reference to FIGS. 40 to 42. In the second main processing shown in FIG. 40, it may be determined whether any inquiry has been received from the content server 300 (S90). The inquiry may be transmitted at step S800 in the main processing of the content server 300, as described above with reference to FIG. 26. Information in the inquiry may include the situation data condition and the inquiry ID. Therefore, whether the information received via the communication device 190 is an inquiry from the content server 300 or the situation data transmitted from the terminal 100 may be determined, for example, based on whether or not any inquiry ID is contained. If it is determined that no inquiry has been received from the content server 300 (No at S90), the processing may not proceed to the next step until it is determined that an inquiry has been received (Yes at S90). If, on the other hand, it is determined that an inquiry has been received from the content server 300 (Yes at S90), the inquiry information may be stored into an inquiry information storage area (not shown) of the RAM 120 (S95). Then, situation data extraction processing may be performed (S100). In the situation data extraction processing, the situation data that satisfies the situation data condition included in the inquiry information may be extracted from the situation data storage area 182. The situation data extraction processing will be described with reference to FIG. 41 by taking the first situation data condition and the second situation data condition of Example 3 as an example. The first situation data condition of Example 3 determined at step S760 in FIG. 29 is a combination of the terminal identification information “100” of the author of the content and the time information “2006/03/25”. The second situation data condition is a combination of the terminal identification information “120” of the person who appears in the content and the time information “2006/03/25”.

In the situation data extraction processing shown in FIG. 41, first, the inquiry information storage area (not shown) of the RAM 120 and the situation data storage area 182 of the hard disk drive 180 may be referenced. Then, for each situation data condition, it may be determined whether any situation data that satisfies the situation data condition is stored in the situation data storage area 182 (S101). Here, the determination may be made by publicly known search processing using one of or a combination of two or more of the position information, the time information, and the terminal identification information specified by the situation data condition as a keyword. If the situation data condition requires exact matching of the position information or the time information, the conditions may be too restrictive. Thus, if any situation data is determined to include position information indicating a position within a predetermined range of the specified position in the position information included in the situation data condition, the situation data may be extracted. Similarly, if any situation data is determined to include time information indicating a time within a predetermined range of the specified time in the time information included in the situation data condition, the situation data may be extracted. The predetermined range can arbitrarily be determined. For the position information, for example, the predetermined range may be within a 1-km radius. For the time information, for example, the predetermined range may be within 30 minutes before and after the specified time. For Examples 1 and 2, the situation data whose position information indicates a position within a 1-km radius of the specified position may be extracted. With respect to the time information, since the time information in Examples 1 and 2 is specified by date, the situation data acquired on the date “2006/03/25” may be extracted without setting any predetermined range.

At step S101, it may be determined whether any situation data that satisfies the first situation data condition and the second situation data condition of Example 3 is stored, with reference to the situation data management table 550 shown in FIG. 25. In this example, it may be determined that a situation data group 553 is stored as the situation data satisfying the first situation data condition (Yes at S101) and that situation data 554 is stored as the situation data satisfying the second situation data condition (Yes at S101). Then, all information pieces of the situation data group 553 may be extracted as the situation data satisfying the first situation data condition (S102), and the extracted situation data may be stored into a buffer (not shown) of the RAM 120 (S103). Similarly, the situation data 554 may be extracted as the situation data satisfying the second situation data condition (S102), and the extracted situation data may be stored into the buffer (not shown) of the RAM 120 (S103). At this point, the extracted situation data for each situation data condition may be stored in the buffer distinguishably with each other. If it is determined that no situation data that satisfies the situation data condition is stored in the situation data storage area 182 (No at S101), information indicating that there is no situation data that satisfies the situation data condition may be stored in the buffer (not shown) of the RAM 120 (S104). Subsequent to step S103 or S104, the situation data extraction processing may terminate to return to the second main processing shown in FIG. 40.

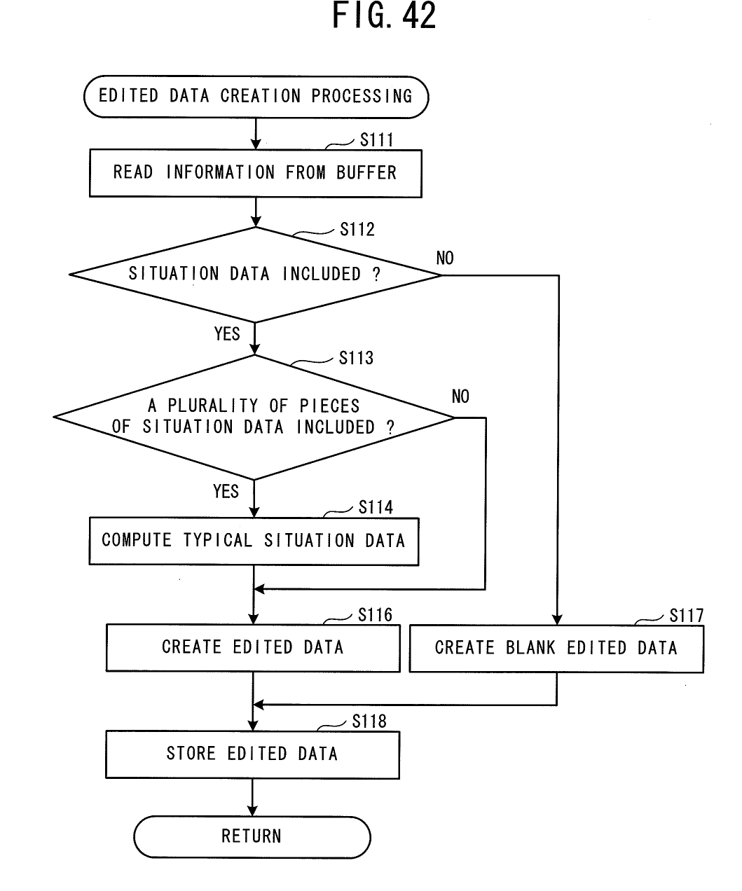

Subsequent to step S100 in FIG. 40, edited data creation processing may be performed (S110). In the edited data creation processing, predetermined editing processing may be performed on the extracted situation data. The edited data creation processing will be described with reference to FIG. 42. In the edited data creation processing shown in FIG. 42, first, the buffer (not shown) of the RAM 120 may be referenced, and the information stored in the buffer may be read (S111). In Example 3, the situation data group 553 may be read as the extracted situation data satisfying the first situation data condition, and the situation data 554 may be read as the extracted situation data satisfying the second situation data condition. Then, it may be determined whether the information read at step S111 includes the situation data (S112). If the buffer of the RAM 120 includes no situation data (No at S112), blank edited data may be created as edited data to be transmitted to the content server 300 (S117). The blank edited data may indicate that no situation data that satisfies the situation data condition has been extracted. Then, the blank edited data may be stored into the edited data storage area (not shown) of the RAM 120 (S118).

If it is determined that, like the case of Example 3, the information stored in the buffer includes the situation data (Yes at S112), it may be determined whether there are a plurality of pieces of extracted situation data for one situation data condition (S113). If the plurality of pieces of extracted situation data are stored in the buffer for one situation data condition (Yes at S113), typical situation data may be computed from the plurality of pieces of situation data (S114). As for Example 3, because a plurality of pieces of extracted situation data for the first situation data condition are stored (Yes at S113), typical situation data, which is representative situation data, may be computed from the plurality of pieces of extracted situation data. The processing to compute the typical situation data may be an example of statistical processing. If the extracted situation data is represented as numerical values, such as measured values of the various sensors 12 to 17 and emotion inference values included in the emotion information, for example, a computational typical value or a positional typical value may be computed as the typical situation data. Examples of the computational typical value may include an arithmetic mean, a geometric mean, a harmonic mean, and a square mean. Examples of the positional typical value may include a median value, a mode, and a p-quartile. If, on the other hand, the situation data is data that is not represented as numerical values, for example, the mode may be computed. In the first embodiment, an average value of the emotion inference values included in the extracted situation data may be computed as the typical situation data. In particular, it may be assumed that a value 2 corresponding to a status “excited” is computed as the average value the of emotion inference values of the situation data group 553, which is the extracted situation data for the first situation data condition of Example 3 (S114). On the other hand, the extracted situation data for the second situation data condition of Example 3 includes only one piece of data, that is, the situation data 554 (No at S113). Thus, the processing to compute the typical situation data may not be performed.

Subsequent to step S114 or S113, edited data may be created (S116). The edited data may be obtained by performing predetermined editing processing on the typical situation data computed at step S114 or on one or a plurality of pieces of the extracted situation data. Examples of the editing processing may include graph creation processing to create a graph and table creation processing to create a table, each based on one or a plurality of pieces of the extracted situation data, and also icon determination processing to determine an icon or icons corresponding to one or a plurality of pieces of the extracted situation data or the typical situation data. Which editing processing to be performed may be determined in advance and stored in the hard disk drive 180 or the like, or predetermined instructions to instruct editing processing contained in contents may be followed. In the first embodiment, the icon determination processing may be performed to determine an icon or icons corresponding to one or a plurality of pieces of the extracted situation data or the typical situation data computed at step S114.

In the icon determination processing, if the first situation data condition is used, the typical situation data computed at step S14 and the icon table storage area 183 of the hard disk drive 180 may be referenced to determine an icon corresponding to the typical situation data (S116). The icon may be obtained by comparing the extracted situation data and the icon table. The extracted situation data used here may be data extracted as the situation data satisfying the situation data condition, or the extracted situation data on which the statistical processing has been performed. The icon table to be referenced in this processing may be similar to an icon table 575 stored in the content server 300. Thus, as shown in FIG. 33, the icon table may include a correspondence between the emotion information, which may be the edited data, and an icon. In Example 3, an icon 576 shown in FIG. 33 may be determined as an icon corresponding to the typical situation data “excited” for the first situation data condition. The icon 576 may be stored into the edited data storage area (not shown) of the RAM 120, associated with the first situation data condition (S118). Similarly, the icon 576 shown in FIG. 33 may be determined as an icon corresponding to the extracted situation data “excited” for the second situation data condition, and stored into the edited data storage area (not shown) of the RAM 120, associated with the second situation data condition (S118).

Subsequently, the edited data creation processing may terminate to return to the second main processing shown in FIG. 40. Subsequent to step S110, the inquiry information storage area (not shown) and the edited data storage area (not shown) of the RAM 120 may be referenced, and the edited data may be transmitted to the content server 300 (S120). In the first embodiment, the icon 576 may be transmitted to the content server 300 as the edited data together with the inquiry ID. Then, the processing may return to step S90 to repeat the processing.

With the processing described above in detail, the situation data transmitted from the terminal 100 may be received and stored into the situation data storage area 182. Also, the situation data that satisfies the situation data condition may be extracted as the extracted situation data in accordance with an inquiry from the content server 300. Then, the extracted situation data may be subjected to predetermined editing processing and then transmitted to the content server 300.

A management server according to the present disclosure is not limited to the management server 200 in the first embodiment and can suitably be modified without deviating from the scope of the present disclosure. For example, at step S116 in FIG. 42, an icon table identical to the icon table 575 shown in FIG. 33 stored in the content server 300 may be referenced to determine an icon to be added to the content analyzed at step S750. The icon table to be referenced at this step may need only to allow a determination of an icon from the extracted situation data and is not limited to the icon table 575 shown in FIG. 33. The icon table 575 in FIG. 33 may define a correspondence between emotion information and an icon. Instead, for example, the icon table may define a correspondence between an icon and one of the emotion information, the body information, the surrounding information, and the environment information. The icon table may also define a correspondence between an icon and a combination of two or more of the emotion information, the body information, the surrounding information, and the environment information. Further, different icon tables may be referenced depending on the author or a category of the content. Further, types of the icons can be changed as necessary.

According to the situation presentation system 1 in the first embodiment described above in detail, the emotion information that is determined using the body information of the user and the environment information that is determined using the surrounding information of the terminal 100 may be accumulated as the situation data in the management server 200. Accordingly, such information may be acquired or referenced any number of times. In addition, such information may automatically be added to a content.

According to the situation presentation system 1 in the first embodiment, a server may be divided into two servers, that is, the content server 300 that stores contents and the management server 200 that stores the situation data. Thus, server loads can be distributed.

According to the situation presentation system 1 in the first embodiment, the emotion information of the user may be inferred from the body information acquired from the various sensors 12 to 17 provided in the terminal 100 (S30 in FIG. 9). Thus, by adding the emotion information to a content, for example, the emotion of the user who stores the content in a server or the like, that is, how the user felt about an event described in the content or the like may be recorded more thoroughly and more correctly. Therefore, the substance of the content can be conveyed to readers more realistically through the emotion of the person who appears in the content. Also, the environment information around the terminal 100 may be inferred from the surrounding information obtained from the various sensors 12 to 17 provided in the terminal 100 (S35 in FIG. 9). Thus, by adding the environment information to a content, for example, surrounding situations such as what the environment was like when an event described in the content occurred may be recorded more thoroughly and more correctly. Therefore, the substance of the content may be conveyed to the readers more realistically through the surrounding situations of the place described in the content.

According to the situation presentation system 1 in the first embodiment, the emotion information of the user or the environment information around the terminal 100 may be added to a content as follows. The situation data corresponding to a character strings in the content may be extracted and added to the content. More specifically, a character string in the content and a character string in the various analysis dictionaries 571 to 573 may be compared to extract any of the position information, the time information, and the terminal identification information from the content in the main processing shown in FIG. 26. Then, the situation data condition may automatically be determined using one piece of the position information, the time information, and the terminal identification information, or a combination of two or more pieces of the above information (S750). The situation data extracted in accordance with these situation data condition may represent in what situation an article in the content was described, or how the user who stored the content felt about an event described in the article and the like. Then, according to the situation presentation system 1 in the first embodiment, an icon corresponding to the situation data extracted in accordance with the situation data condition, that is, an icon representing the emotion of the user or the environment around the terminal 100 may be added to the content (S830). Thus, the emotion of the user or the like who stored the content in the server or the environment around the terminal 100 may visually be conveyed. Also, the content may be made friendlier to the readers when compared with a content consisting of letters only. If, in the edited data creation processing shown in FIG. 42, a plurality of pieces of situation data are extracted (Yes at S113), typical situation data may be computed from the plurality of pieces of extracted situation data (S114). Then, an icon representing one of the emotions of the user and the environment around the terminal 100 may be determined based on the typical situation data (S116). Thus, the emotion of a representative user or a representative environment around the terminal 100 can be expressed by the icon even when a plurality of pieces of situation data is extracted.

A Weblog content including an entry, a comment, and a trackback may be used as a content to be processed. Therefore, in the situation presentation system 1 in the first embodiment, as described above, the situation data suitable to the Weblog content may be added without work of selecting suitable information or registering the information by a user. Also, when compared with a Weblog content consisting of letters only, in what situation an article in the Weblog content was described, how the user who stored the Weblog content felt about an event described in the article and the like may be recorded more thoroughly and more correctly. Thus, the substance of the Weblog content may be conveyed to the readers more realistically.

The situation presentation system according to the present disclosure is not limited to the situation presentation system 1 in the first embodiment and can suitably be modified without deviating from the scope of the present disclosure. For example, the situation presentation system 1 may be provided with the management server 200 and the content server 300 as servers, but servers are not limited to the management server 200 and the content server 300. For example, the management server 200 and the content server 300 may be configured as one server. Also, for example, in addition to the management server 200 and the content server 300, another server that takes charge of a part of the functions of the management server 200 or the content server 300 may be provided. For example, while processing to determine an icon may be performed by the management server 200 in the first embodiment, the processing may be performed by the content server 300, for example, based on the extracted situation data transmitted from the management server 200.

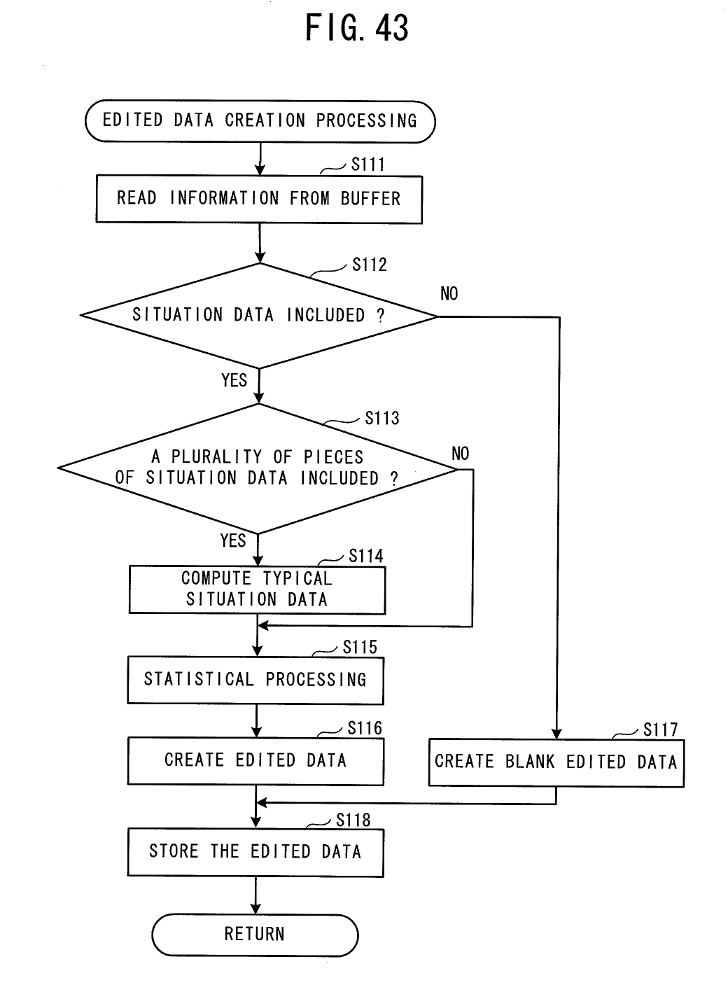

Next, the second embodiment will be described with reference to FIGS. 43 to 45. In the second embodiment, the icon determination processing and graph creation processing may be performed as predetermined editing processing. Because the physical configuration and the electrical configuration of the situation presentation system 1 in the second embodiment may be the same as those in the first embodiment, a description thereof will be omitted. In the second embodiment, the edited data creation processing in FIG. 42 performed by the management server 200 may be different from the edited data creation processing in the first embodiment, while other processing may be the same as that in the first embodiment. Therefore, a description of the processing identical to the processing in the first embodiment will be omitted and the edited data creation processing that is different from that in the first embodiment will be described below with reference to FIG. 43. A server program for the edited data creation processing in the second embodiment shown in FIG. 43 may be stored in the ROM 130 and executed by the CPU 110 shown in FIG. 7. In FIG. 43, to those steps at which processing similar to that in the first embodiment in FIG. 42 is performed, the same step numbers are respectively attached.

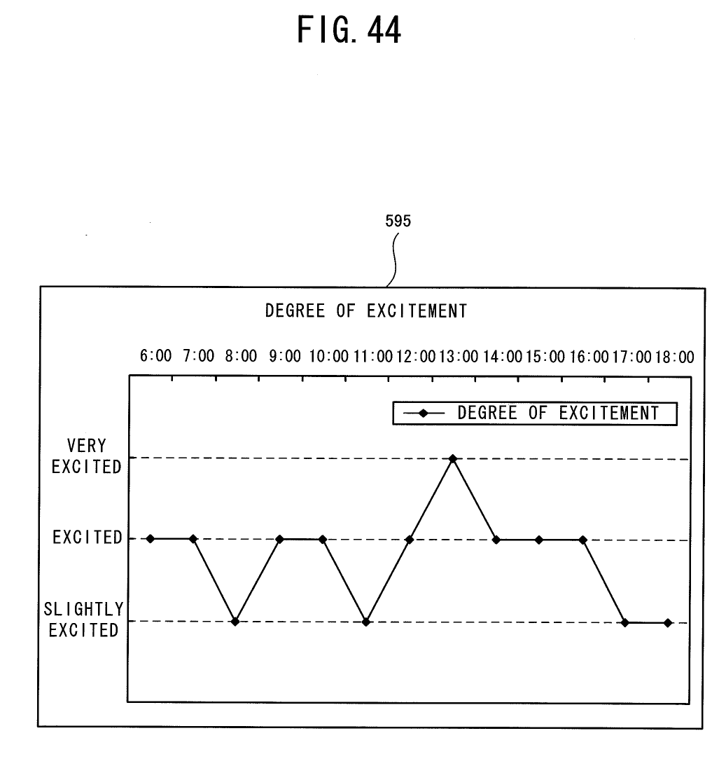

As shown in FIG. 43, the edited data creation processing in the second embodiment may be different from the edited data creation processing in the first embodiment shown in FIG. 42 in that statistical processing on a plurality of extracted situation data may be performed between steps S114 and S116 (S115). At step S115 that is different from the first embodiment, for example, the plurality of pieces of the extracted situation data corresponding to the first situation data condition of Example 3 may be rearranged in chronological order to compute typical situation data for each time by statistical processing. Then, based on the extracted situation data obtained through the statistical processing at S115, a graph may be created (S116). The type of the graph created at this step may be any graph such as a bar graph, a pie graph, a line graph, an area chart, a scatter diagram, and a radar graph. For example, a predetermined type of graph may be created or the type of graph may be changed depending on the extracted situation data or the situation data condition. If a content is configured to allow insertion of an instruction to specify the type of graph, the instruction may be followed. A line graph showing changes with time of a degree of excitement of a user of the terminal 100 with terminal identification information 100 may be created like a graph 595 shown in FIG. 44, based on the plurality of pieces of the extracted situation data corresponding to the first situation data condition of Example 3. The graph, an icon may be transmitted as the edited data together with an inquiry ID from the management server 200 to the content server 300 in the second main processing shown in FIG. 40.

Meanwhile, at step S810 of the main processing shown in FIG. 26 performed by the content server 300, the graph, the icon, and the inquiry ID may be received from the management server 200 as the edited data (S810). The received edited data may be stored into the edited data storage area (not shown) of the RAM 220 (S820). Then, the content storage area 283 of the hard disk drive 280 may be referenced, and the graph may be added to the content corresponding to the inquiry ID, together with the icon contained in the edited data acquired at step S810 (S830). A position to which the graph is added may be set arbitrarily. For example, the graph may be added before or after the text.

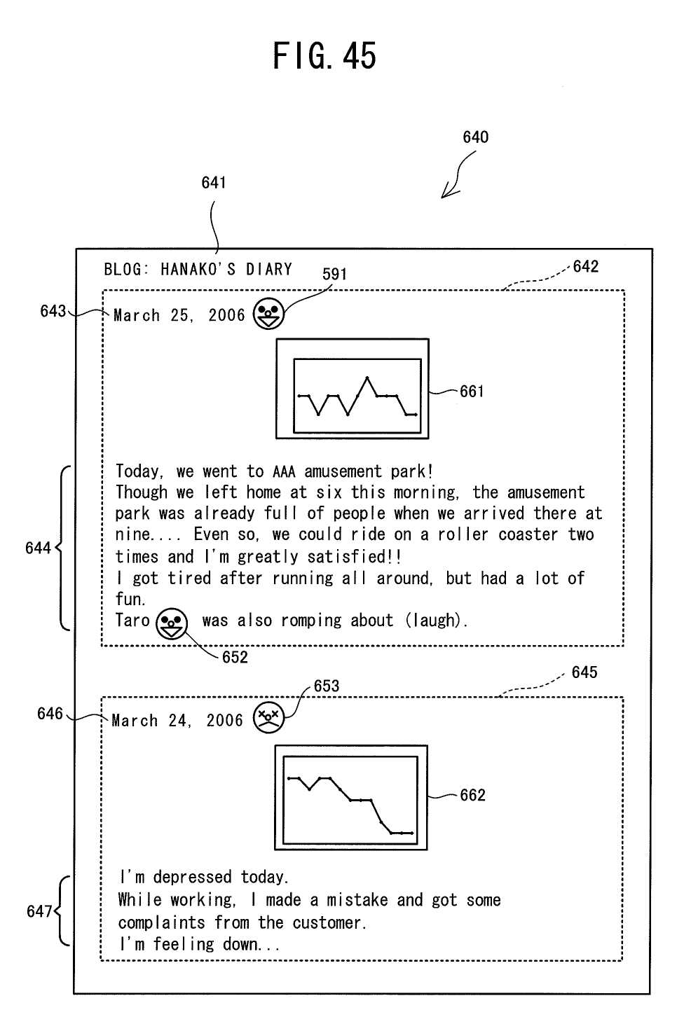

A screen 640 displayed on the browser will be described with reference to FIG. 45. The screen 640 may show the content of Example 4, to which the graph has been added as the edited data in the processing at step S830 (See FIG. 26) in the second embodiment. The screen 640 in FIG. 45 may be displayed on a terminal such as the PC 2 used by a reader, based on information presented (transmitted) by the content server 300. As shown in FIG. 45, a title 641 of a Weblog content and entries 642 and 645 may each be displayed in the screen 640 displayed on the browser. The entries 642 and 645 may have graphs 661 and 662 respectively displayed between a title 643 and text 644 and between a title 646 and text 647, in addition to icons 651, 652, and 653. Of these graphs 661 and 662, the graph 661 may be included in the edited data corresponding to the first situation data condition as described above. By thus adding the graphs 661 and 662 showing changes in emotions of the author of the content, the substance of the content may be conveyed to readers more realistically, compared with a case a content consisting of letters only.

According to the situation presentation system in the second embodiment, if a plurality of pieces of the situation data are extracted (Yes at S113 in FIG. 43), a graph may be created based on the extracted situation data (S116 in FIG. 43). Then, the graph may be added to the content to update the content (S830 in FIG. 26). Thus, like Example 3, changes in emotions of the author of the content and changes in the environment of the terminal may visually be displayed more plainly. Moreover, when compared with a content consisting of letters only, the substance of the content can be conveyed to readers more realistically.

The situation presentation system of the present disclosure is not limited to the situation presentation system 1 in the second embodiment and can suitably be modified without deviating from the scope of the present disclosure.

In the second embodiment, for example, a graph as edited data may directly be added to a content, but link information indicating a location of the graph may be added to a predetermined character string. A sixth modified embodiment, in which the link information indicating the location of the graph may be added to the predetermined character string, will be described. In the sixth modified embodiment, at step S830 shown in FIG. 26, instead of adding the graph to the content, the link information indicating the location of the graph may be added to the predetermined character string. A case will be described using Example 3, in which a combination of the time information “2006/03/25” and the position information “latitude: xx° 25′ 8.609″; longitude: xxx° 15′ 19.402″” has been determined as the third situation data condition at step S760 shown in FIG. 29. In this case, the third situation data condition may not include any terminal identification information of a user or a person who appears in the content. Therefore, in the processing by the management server 200 at step S102 shown in FIG. 41, the situation data obtained from the terminal 100 that was present at a time specified by the time information and at a place specified by the position information may be acquired widely. A plurality of pieces of situation data may be extracted at step S102 and then, at step S116 shown in FIG. 42, a graph showing a distribution of emotions of the user of the terminal 100 satisfying the third situation data condition may be created, based on the plurality of extracted situation data. The user of the terminal 100 satisfying the third situation data condition may be a user of the terminal 100 determined to be in the “AAA amusement park” positioned at “latitude: xx° 25′ 8.609″; longitude: xxx° 15′ 19.402″” on the day specified by the time information “2006/03/25”. In this case, at step S830 in the processing of on the content server 300 shown in FIG. 26, the link information indicating the location of the graph may added to the predetermined character string, instead of the graph itself being added to the content.

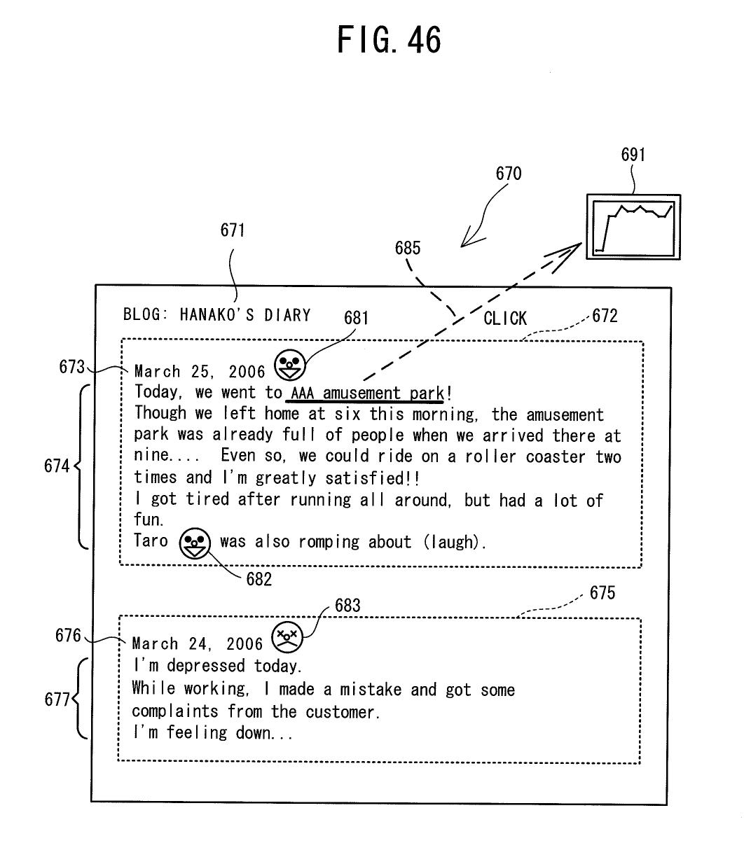

A screen 670 displayed on the browser will be described with reference to FIG. 46. The screen 670 may show the content of Example 3, to which the link information of the graph has been added. The screen 670 in FIG. 46 may be displayed on a terminal such as the PC 2 used by the reader, based on information presented (transmitted) by the content server 300. As shown in FIG. 46, a title 671 of a Weblog content and entries 672 and 675 may each be displayed in the screen 670 displayed on the browser. The entries 672 and 675 may include titles 673 and 676, texts 674 and 677 and icons 681, 682 and 683, respectively. The link information indicating the location of a graph 691 may be added to the string “AAA amusement park” contained in the text 674 of the entry 672. The link information may be added to the content by a predetermined tag being added like enclosing the character string “AAA amusement park”, and the content to which the link information is added may be stored in the content storage area 283 (S830). When the character string “AAA amusement park” is clicked (an operation indicated by an arrow 685) in the screen 670, the graph 691 may be displayed.

According to the sixth modified embodiment, as described above, the link information of the graph 691 may be inserted to the character string “AAA amusement park”. Accordingly, when the content is acquired, an amount of acquired information may be reduced for readers who need not reference emotions of other users linked to the “AAA amusement park”. On the other hand, readers who wish to reference the emotions of the other users linked to the “AAA amusement park” may reference the detailed edited data shown as a graph. Thus, the content may be made friendlier with improved convenience in accordance with preferences of readers. If the position information and the time information is included in a character string of the content, the situation data of users other than the user who stored the content may widely be extracted by defining a combination of the position information and the time information as a situation data condition. In such a case, in Example 3, emotions of visitors of the “AAA amusement park” other than the user who created the content or situations around the “AAA amusement park” may be displayed. Therefore, when compared with a content consisting only of information submitted by the user, the substance of the content may be conveyed to readers more objectively.

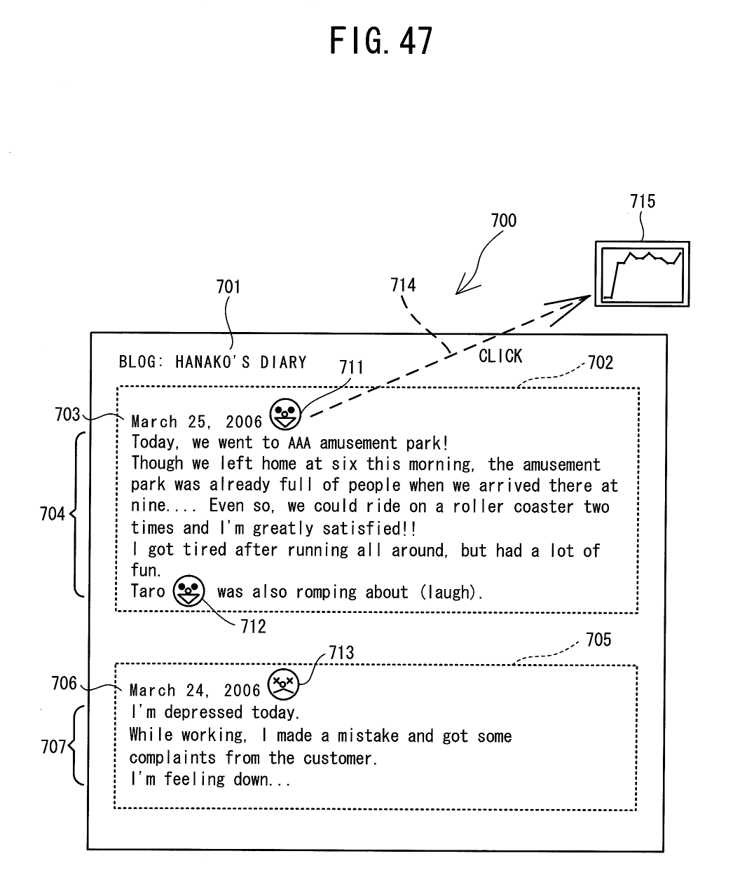

While the link information indicating the location of the graph may be added to a predetermined character string in the sixth modified embodiment, the link information indicating the location of the graph may be added to an icon added to the content. A seventh modified embodiment will be described with reference to FIG. 47. A screen 700 in FIG. 47 may be displayed on a terminal such as the PC 2 used by the reader, based on information presented (transmitted) by the content server 300. In the seventh modified embodiment, for example, at step S830 shown in FIG. 26, an icon is added, and link information indicating a location of a graph may be added to the icon. In Example 3, as shown in FIG. 47, an icon 711 may be added after the title as the edited data corresponding to the first situation data condition, and a graph 715 may be linked to the icon 711 also as the edited data corresponding to the first situation data condition.

The screen 700 displayed on the browser will be described with reference to FIG. 47. The screen 700 may show the content of Example 3, to which the link information indicating the location of the graph 715 has been added to the icon 711 as the edited data. As shown in FIG. 47, a title 701 of a Weblog content and entries 702 and 705 may each be displayed in the screen 700 displayed on the browser. The entries 702 and 705 may have icons 711, 712, and 713 added thereto, in addition to titles 703 and 706 and text 704 and 707, respectively. Further, the link information indicating the location of the graph 715 may be added to the icon 711. The link information may be added to the content by a predetermined tag being added like enclosing the icon 711. When the icon 711 is clicked (an operation indicated by an arrow 714) in the screen 700, the graph 715 may be displayed. In such a case, by inserting the link information of the graph 715 into the icon 711, when the content is acquired, an amount of acquired information may be reduced for readers who need not reference detailed changes of emotion. On the other hand, readers who wish to reference the detailed changes of the emotions may reference the detailed edited data shown as a graph. Thus, the content may be made friendlier with improved convenience in accordance with preferences of readers.

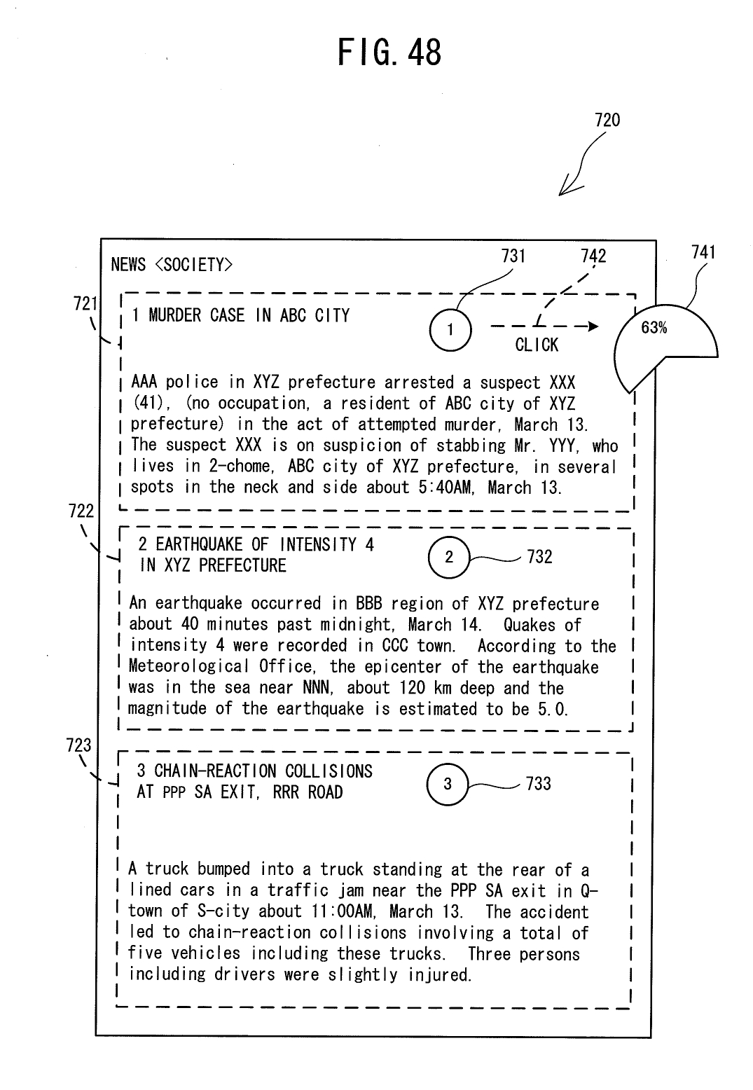

As another example of seventh modification, a case in which a content including news articles are updated will be described with reference to FIG. 48. The screen 720 in FIG. 48 may be displayed on a terminal such as the PC 2 used by the reader, based on information presented (transmitted) by the content server 300. The content including the news articles may often include position information and time information about an event making news. Therefore, when a news article is updated as a content, the position information and the time information about the event making the news may be acquired in the updated data analysis processing shown in FIG. 29 performed in the content server 300 (S755, S757). Subsequently, a combination of the position information and the time information may be determined as a situation data condition (S760). Then, in the processing at step S102 shown in FIG. 41 performed in the management server 200, like the above example, situation data obtained from the terminal 100 that was present at a time specified by the time information and at a place specified by the position information may be widely acquired. A plurality of pieces of situation data may be extracted at step S102. Then, at step S116 shown in FIG. 43, a graph showing a distribution of emotions of the user of the terminal 100 determined to be at a place specified by the position information and on a date specified by the time information may be created, based on the plurality of extracted situation data. Then, at step S830 shown in FIG. 26 performed in the content server 300, a predetermined icon may be added, and link information indicating a location of a graph may be added to the icon. The predetermined icon may correspond to the extracted situation data as described in the first embodiment, may not have any predetermined correspondence to the extracted situation data. Specifically, the icon may represent a category of an article, a display order, or the like.

An example of a screen in which link information indicating the location of a graph may be added to an icon in a content including news article will be described with reference to a screen 720 shown in FIG. 48. In FIG. 48, news articles 721 to 723 may be displayed in the screen 720. A plurality of pieces of situation data may be extracted from the news articles 721 to 723 based on situation data condition (S760 in FIG. 29) obtained by analyzing character strings when the news articles 721 to 723 are updated (S102 in FIG. 41). Graphs corresponding to the respective news articles 721 to 723 may be created based on the extracted situation data (S116 in FIG. 43). Link information indicating locations of the graphs may be added to each of icons 731 to 733 representing display numbers of the news articles 721 to 723, respectively (S860 in FIG. 26). Thus, for example, when the icon 731 shown in FIG. 48 is clicked (an operation indicated by an arrow 742), a graph 741 linked to the icon 731 may be displayed.

Thus, when the content includes news articles, a combination of the position information and the time information contained in the new articles may be determined as the situation data condition. Accordingly, emotions of users of the terminal 100 who were near a scene of the event described in the news articles and state of the environment of the terminal 100 may be displayed together with the news articles. In the example in FIG. 48, a distribution of emotions, such as a ratio of users who were shocked by an event in the news article 721 among users who were near the scene of the event when occurred, may be displayed. Thus, when compared with an article consisting of letters only, the content may be conveyed to readers more realistically. In the example of the news articles shown in FIG. 48, texts of the articles may be displayed in the screen 720. If only the titles of the news articles are displayed and details of the news article is displayed when the title thereof is clicked, processing exemplified below may be performed. For example, the edited data may be created by analyzing character strings contained in the details of the news article linked to the title (S116 in FIG. 43), and link information of the edited data may be added to an icon that is added before or after the title.

According to the seventh modified embodiment, even if a plurality of pieces of situation data are extracted, emotions of a representative user or the environment around a terminal may be expressed by an icon. In addition, a graph based on the extracted situation data may be displayed by selecting the icon. Therefore, when the content is acquired, an amount of acquired information may be reduced for readers who do not need detailed information. On the other hand, readers who wish to reference detailed information may reference the detailed edited data shown as a graph. Thus, the content may be made friendlier with improved convenience in accordance with preferences of readers.

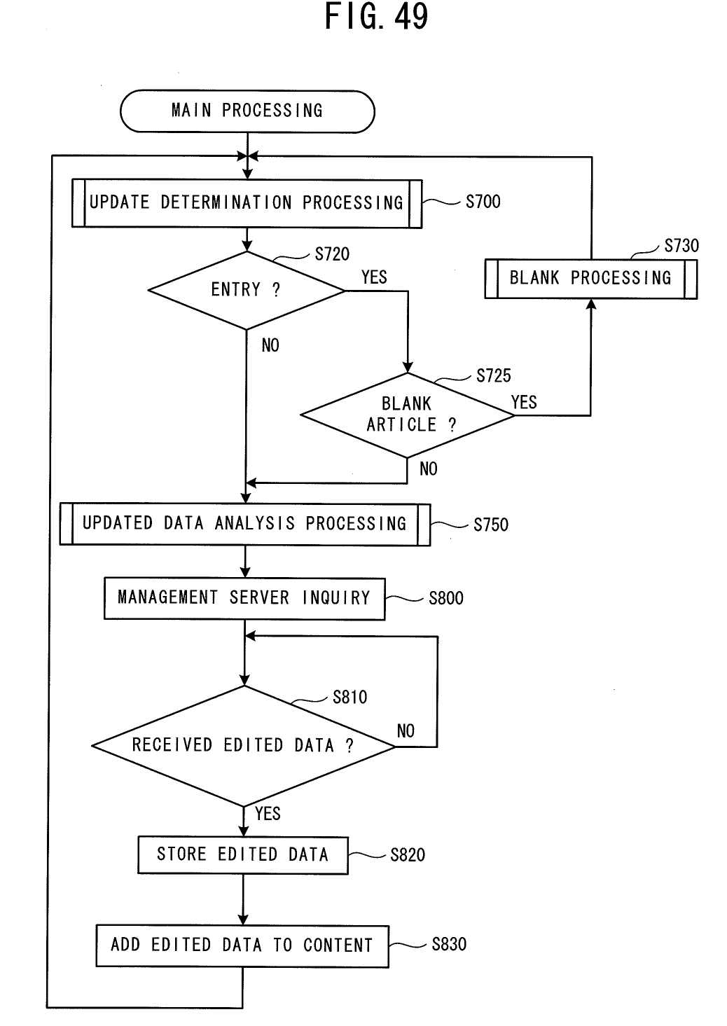

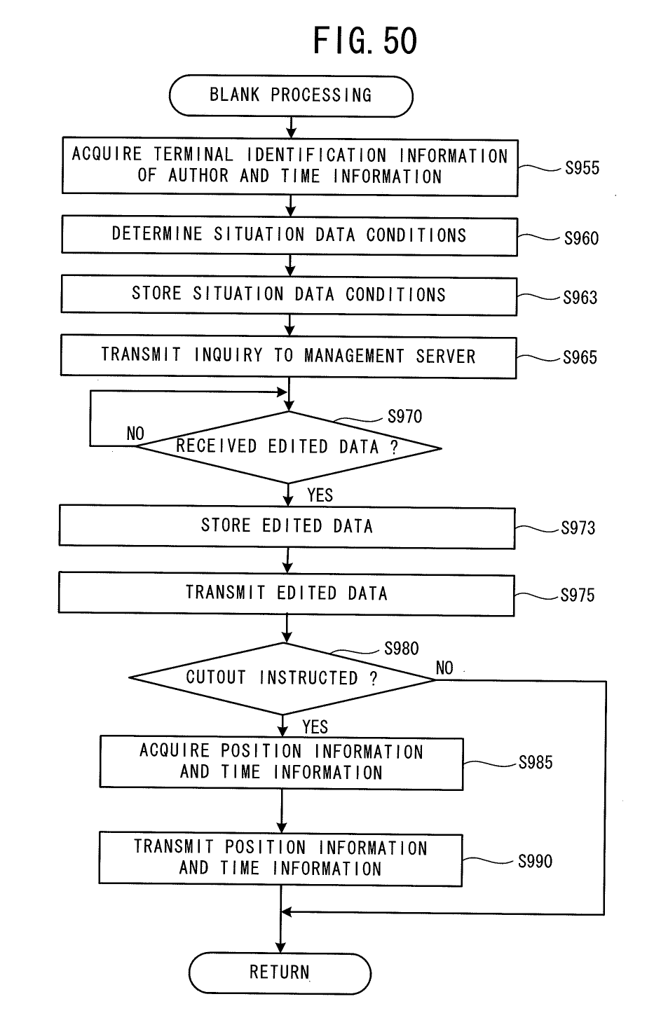

Next, the third embodiment will be described with reference to FIGS. 49 to 53. In the third embodiment, if an entry of an updated Weblog content is analyzed to include a predetermined substance, time information indicating a time within a predetermined time from the time at which the Weblog content is stored in the content storage area 283 of the content server 300 may be determined as a situation data condition. Also, terminal identification information stored in the analysis dictionary storage area 284 corresponding to the Weblog content may be determined as a situation data condition. Then, extracted situation data that satisfies the situation data condition may be transmitted to a communication terminal specified by the author who created the Weblog content. The third embodiment will be described in detail with reference to FIGS. 49 to 53. The physical configuration and the electrical configuration of the situation presentation system 1 of the third embodiment may be the same as those in the first embodiment and thus, a description thereof will be omitted. A server program for blank processing in the third embodiment shown in FIG. 50 may be stored in the program storage area 281 of the hard disk drive 280 and executed by the CPU 210 shown in FIG. 8. In FIG. 49, to those steps at which processing similar to that in main processing of the content server 300 in the first embodiment in FIG. 26 may be performed, the same step numbers are attached.

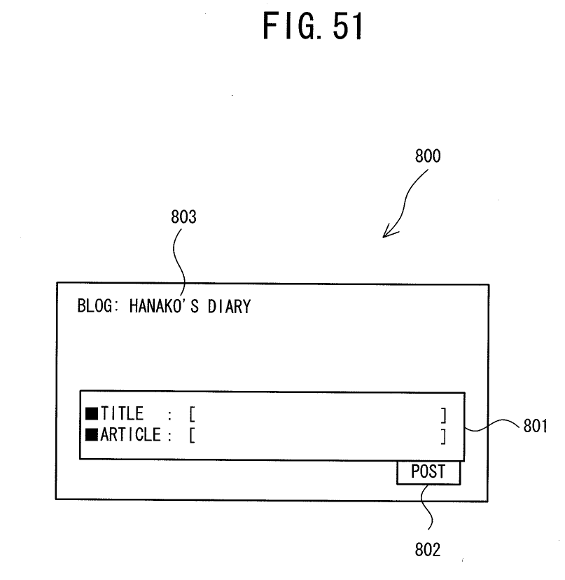

In the third embodiment, if an entry for a Weblog content is posted with a blank article, that is, the article has no substance, time information indicating a time within 24 hours from the time at which the Weblog content was stored in the content storage area 283 of the content server 300 may be determined as a situation data condition. Also, terminal identification information stored in the analysis dictionary storage area 284 corresponding to the Weblog content may be determined as a situation data condition. Then, the extracted situation data satisfying the situation data conditions may be transmitted to a communication terminal specified by the author who created the Weblog content. As Example 5, a case will be described, in which an author of a content with a title 803 presses a post button 802 in a screen 800 shown in FIG. 51, while an article 801 is blank.

Main processing of the content server 300 in the third embodiment may be different from the main processing of the content server 300 in the first embodiment shown in FIG. 26. Specifically, as shown in FIG. 49, the main processing of the third embodiment includes steps S720, S725, and S730 may be performed between the update determination processing (S700) and updated data analysis processing (S750). A description of processing similar to that in the first embodiment will be omitted, and processing of steps S720, S725, and S730 will be described with reference to FIGS. 49 to 53.

First, subsequent to step S700 shown in FIG. 49, the content storage area 283 of the hard disk drive 280 may be referenced to determine whether the updated content is an entry (S720). If the content is not an entry but a comment, for example (No at S720), the updated data analysis processing may be performed (S750). If, on the other hand, the content is determined to be an entry (Yes at S720), the content storage area 283 of the hard disk drive 280 may be referenced to determine whether the article is blank (S725). If it is determined that the article is not blank (No at S725), the updated data analysis processing may be performed (S750). If, it is determined that the article is blank (Yes at S725), then blank processing may be performed (S730). In Example 5, the article is determined to be blank (Yes at S725), and the blank processing may be performed (S730).

The blank processing will be described with reference to FIG. 50. As shown in FIG. 50, first, the content storage area 283 and the analysis dictionary storage area 284 of the hard disk drive 280 may be referenced to acquire time information and terminal identification information of the author of the content (S955). An ID to identify the author of the content may be attached to the entry, and the update date and time may be recorded when the entry is stored (S702 in FIG. 17). The terminal analysis dictionary in the analysis dictionary storage area 284 may include a correspondence between an ID for identifying the author of the content and the terminal identification information of the author. Then, the terminal identification information of the author may be acquired based on the ID attached to the entry to identify the author and the analysis dictionary (S955). Also, the time information may be acquired from the update date and time, which is the time when the entry is stored into the content storage area 283 (S955). In Example 5, a value “100” may be acquired as the terminal identification information of the author and “2006/03/26/20/11” may be acquired as the time information. Then, a combination of the terminal identification information of the author and the time information acquired at step S955 may be stored in the situation data condition storage area (not shown) in the RAM 220 as a situation data condition (S960, S963). In Example 5, a combination of the terminal identification information “100” and time information indicating a time within 24 hours from the time specified by the time information “2006/03/26/20/11” may be stored as the situation data condition (S960). Then, the situation data condition storage area (not shown) in the RAM 220 may be referenced, and an inquiry ID and the situation data condition created at step S960 may be transmitted to the management server 200 via the communication device 290 (S965). Through this processing, an inquiry may be made at the management server 200 about whether the situation data satisfying the situation data condition stored at step S960 is stored in the management server 200. The inquiry ID may be used to identify the content from which the situation data condition is obtained by analyzing the contents.

Subsequently, it may be determined whether edited data has been received in response to the inquiry at S965 (S970). The edited data may be transmitted in the second main processing of the management server 200, as described with referenced to FIG. 36. If it is determined that no edited data has been received (No at S970), the processing may not proceed to the next step until it is determined that the edited data has been received (Yes at S970). Like step S810 shown in FIG. 26, even if no situation data satisfying the situation data condition is extracted, information indicating that no situation data has been extracted may be transmitted to the content server 300 also in the main processing of the management server 200 shown in FIG. 36. Thus, a response to the inquiry at step S965 may always be received. If it is determined that the edited data has been received (Yes at S970), the edited data may be stored into the edited data storage area (not shown) of the RAM 220 (S973). In Example 5, a graph that shows changes with time in the emotion information which was obtained from the terminal with the terminal identification information “100” within 24 hours from the time indicated by the time information “2006/03/26/20/11” may be received as the edited data (Yes at S970).

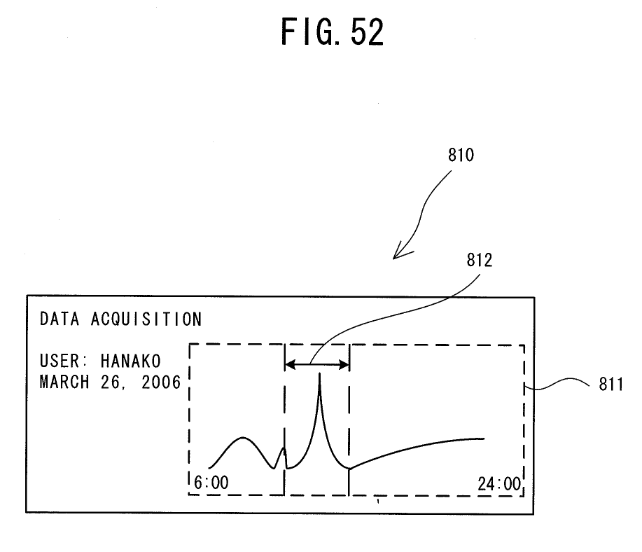

Subsequently, the edited data storage area (not shown) of the RAM 220 may be referenced, and the edited data received at step S970 may be transmitted to the communication terminal specified by the content author (S975). The communication terminal to which the edited data may be transmitted may be associated with the author of the content in advance and stored in the ROM 230 or the hard disk drive 280, so that a storage area thereof may be referenced when the edited data is transmitted. Or, information specifying the communication terminal to which the edited data may be transmitted may be attached to the content, so that the information may be referenced. The edited data of Example 5 may be a graph 811 showing changes with time of the emotions of the user of the terminal 100 whose terminal identification information is “100”. The graph 811 may be created based on the situation data including the time within 24 hours from the time indicated by the time information “2006/03/26/20/11” obtained from the terminal 100 whose terminal identification information is “100”. Then, the graph 811 may be transmitted to the communication terminal specified by the author of the content (S975). Then, the graph 811 may be displayed in a screen 810 of the communication terminal, for example, as shown in FIG. 52. Thus, for example, if a user wishes to edit a diary while reflecting on changes in emotions in a day or changes in the environment in a day, by updating the content with a blank entry, the user may cause the content server 300 to transmit the extracted situation data or the edited data within 24 hours from the time of the entry update.

Subsequently, it may be determined whether any cut-out instruction has been received (S980). The cut-out instruction herein refers to an instruction to perform processing to cut out a part of the edited data received at step S970. If it is determined that no cut-out instruction has been received when a predetermined time passes after the edited data was transmitted to the predetermined communication terminal (No at S980), the blank processing may be terminated to return to step S700 of the main processing shown in FIG. 49 to repeat the processing. If, on the other hand, it is determined that a cut-out instruction has been received, position information and time information corresponding to the specified part of the edited data may be acquired (S985). In Example 5, a cut-out instruction to cut out a portion of the edited data shown in FIG. 52 may be received (No at S980). The portion may be specified from 9 am to 12 pm as indicated by an arrow 812, where changes of emotions may be recognized. In such a case, the edited data storage area (not shown) of the RAM 220 may be referenced to acquire the position information corresponding to the time information indicating a time in the portion for which cut-out is instructed (S985). If the position information corresponding to the time information is not contained in the edited data received at step S970, an inquiry may be transmitted to the management server 200 again, with a combination of the time information of the portion for which cut-out is instructed and the terminal identification information as a situation data condition.

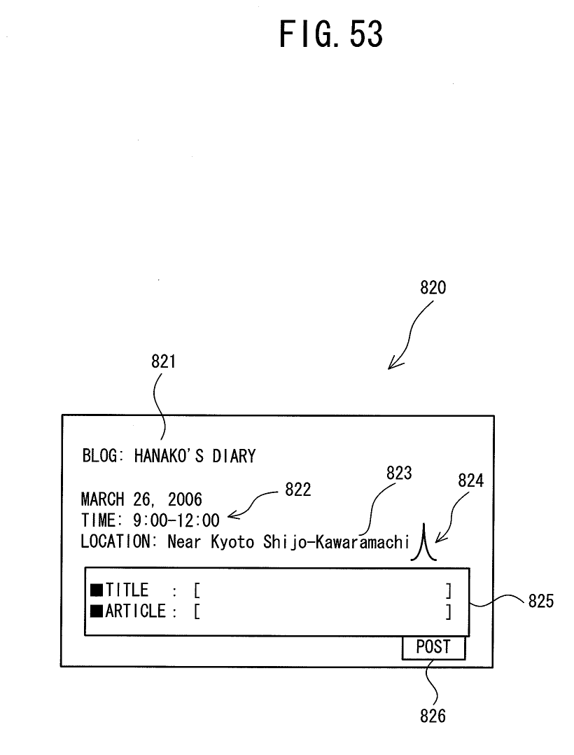

In Example 5, the position information may be contained in the edited data and “vicinity of Kyoto Shijokawaracho” may be acquired as the position information corresponding to the cut out time information (S985). Then, the position information and the time information acquired at step S980 may be transmitted to the same communication terminal as that at step S975 (S990). In Example 5, the position information and the time information may be transmitted to the communication terminal specified by the author of the content (S990). Then, the position information and the time information may be displayed in a screen of the communication terminal, like the screen 820 shown in FIG. 53. In the screen 820 shown in FIG. 53, time information 822 instructed to cut out and position information 823 corresponding to the time information 822 may be displayed, together with a graph 824 obtained by extracting information of a time zone instructed to cut out from the graph 811 in FIG. 810. With this processing, in Example 5, information about where the user was in the time zone when emotions remarkably changed may be obtained as the position information. Therefore, a new entry 825 of the Weblog content corresponding to the title 821 may be created with the screen 820 as a clue to remember an event that occurred in the time zone. If a post button 826 in FIG. 53 is selected, a new content including the entered title and article information may be transmitted to the content server 300. Then, the blank processing may be terminated to return to step S700 in the main processing shown in FIG. 49 to repeat the processing.

According to the situation presentation system in the third embodiment, if a blank entry is stored in the content server 300, the content server 300 may transmit to a communication terminal the situation data condition that instructs extraction of situation data of the content author within a predetermined time from the time when the entry is stored. Thus, if a user wishes to edit a diary reflecting on changes of emotions in a day or changes of the environment in a day, an update may be performed with a blank entry. Accordingly, the situation data within 24 hours from the update time may be transmitted from the server. Thus, the user may edit the diary can while referencing the extracted situation data.

The situation presentation system according to the present disclosure is not limited to the situation presentation system 1 in the third embodiment and may suitably be modified without deviating from the scope of the present disclosure. In the third embodiment, for example, if a blank entry is stored in the content server 300, the blank processing shown in FIG. 50 may be performed. However, a substance of an entry as a criterion for determining whether to perform the blank processing may need to be only a predetermined substance and is not limited to a case of the third embodiment. Thus, for example, the blank processing may be performed when a predetermined character string is contained in the content.

In the first to third embodiments described above, only if the content is updated, a character string of a content may be analyzed to add edited data such as an icon. However, in a case where situations of a person are displayed with an icon in real time, for example, character strings in the content may periodically be analyzed without an update, and the edited data such as an icon may be renewed periodically.

According to the situation presentation system according to the present disclosure, as described above, situation data containing at least one of body information of a user, emotion information inferred from the body information, surrounding information of a terminal, and environment information inferred from the surrounding information may be stored in a server via communication. A character string included in a content stored in the server may be analyzed to determine a situation data condition, which is a condition for extracting situation data related to the content. Then, situation data satisfying the situation data condition may be extracted from the situation data stored in the server. The extracted situation data or edited data obtained by performing editing processing on the extracted situation data by a predetermined method may be added to the content, and the content may be updated automatically. Thus, by storing the body information and the emotion information of the user, and the surrounding information and the environment information of the terminal in the server, such information may be acquired or referenced any number of times. In addition, such information may automatically be added to the content. Thus, situation data suitable to a content may be added to the content without complicated work by the user, such as selecting and registering suitable information.

Further, a character string included in a content may be analyzed and situation data satisfying a preset situation data condition may be extracted and added to the content. Accordingly, when compared with a content consisting of letters only, in what situation an article in the content was described, how a user who stored the content felt about an event described in the article, and the like may be recorded more thoroughly and more correctly. Thus, when compared with a content consisting of letters only, the substance of the content may be conveyed to readers more realistically.

Further, in the situation presentation system according to the present disclosure, the server may be divided into two servers, that is, a content server to store contents and a management server to store situation data, for example. In such a case, server loads may be distributed.

Further, in the situation presentation system in the present disclosure, a character string in a content and a character string in an analysis dictionary may be compared to extract from the content any of position information, time information, and terminal identification information. Then, a situation data condition may automatically be determined by one of the above information, or a combination of two or more pieces of the above information. By extracting situation data using the situation data condition, the suitable situation data in accordance with the character string in the content may automatically be added to the content. Thus, the situation data suitable to the content may be added without work of a user selecting or registering suitable information.

Further, in the situation presentation system according to the present disclosure, if character strings in a content include position information and time information, a combination of the position information and the time information may be defined as a situation data condition. Accordingly, situation data of users other than the user who stored the content may widely be extracted. Thus, for example, an article of holiday event news as a content is stored in a server, and position information of a site of the holiday event and time information of a time when the holiday event is held may be extracted. In such a case, situation data of users who participated in the holiday event may be acquired from the server as the extracted situation data. Then, at least one of the extracted situation data and edited data obtained by performing editing processing on the extracted situation data by a predetermined method may be added to the content. In such a case, for example, emotions of the participants in the holiday event and the situations around the site may be displayed. Therefore, when compared with a news article of the holiday event consisting of letters only, the substance of the content may be conveyed to readers more realistically. Also, a diary of a user who participated in the holiday event is stored in the server as a content, and position the information of the site of the holiday event and the time information of the time when the holiday event was held may be extracted from the contents. In such a case, the situation data of other users who participated in the holiday event may also be acquired. Then, such extracted situation data and the edited data may be added to the content. In such a case, for example, emotions of the participants in the holiday event other than the user who wrote the diary and the situation around the event site may be displayed. Therefore, when compared with a case of a diary about a holiday event consisting of only information submitted by the user, the substance of the content may be conveyed to readers more objectively.

Further, in the situation presentation system according to the present disclosure, when a plurality of pieces of situation data are extracted, statistical processing may be performed on the plurality of pieces of situation data. In such a case, at least one of the plurality of pieces of situation data obtained by performing the statistical processing and the edited data obtained by performing predetermined editing processing on the situation data obtained by performing statistical processing may be added to a content.

Further, in the situation presentation system according the present disclosure, the terminal may transmit situation data to the server each time the situation data acquisition device acquires the situation data. In such a case, the latest situation data may be stored into the server situation data storage device.

Further, in the situation presentation system in the present disclosure, when a predetermined number of pieces of situation data that has not been transmitted is stored in the terminal storage device, the terminal may transmit such situation data to the server. In such a case, the situation data may be stored into the server situation data storage device at a suitable timing by determining the predetermined number in accordance with a frequency of acquiring the situation data, a storage capacity of the terminal situation data storage device, and the like.

Further, in the situation presentation system according to the present disclosure, when an inquiry whether or not situation data that has not yet been transmitted is stored is received from the server, the terminal may transmit the situation data that has not yet been transmitted. In such a case, the situation data may be stored into the server situation data storage device at a suitable timing needed by the server.

Further, in the situation presentation system according to the present disclosure, the terminal may transmit situation data to the server each time a predetermined time passes. In such a case, the latest situation data may be stored into the server situation storage device each time a predetermined time passes.

Further, in the situation presentation system in the present disclosure, emotion information of a user of the terminal may be determined by comparing body information and an emotion information table. In such a case, the emotion information may be inferred from the body information. Thus, for example, by adding the emotion information to a content, emotions such as how a user who stored the content in the server felt about an event described in the content and the like may be recorded more thoroughly and more correctly. Therefore, when compared with a content to which no emotion information is added, a substance of the content may be conveyed to readers more realistically.

Further, in the situation presentation system in the present disclosure, environment information around the terminal may be determined by comparing surrounding information and an environment information table. The environment information around the terminal may be inferred from the surrounding information. Thus, for example, by adding the environment information to a content, surrounding situations such as how surroundings looked like when an event described in the content occurred and the like may be recorded more thoroughly and more correctly. Therefore, when compared with a content to which no environment information is added, a substance of the content may be conveyed to readers more realistically.

Further, in the situation presentation system in the present disclosure, at least one of an emotion of the user and an environment around the terminal may be inferred from situation data, and icons representing the emotion of the user or the environment around the terminal may be added to a content. In such a case, the emotion of the user who stored the content in the server or the environment around the terminal may visually be conveyed. Moreover, the content may be made friendlier to readers when compared with a content consisting of letters only.

Further, in the situation presentation system according to the present disclosure, when a plurality of pieces of situation data are extracted, typical situation data may be computed from the plurality of pieces of situation data. Then, based on the typical situation data, an icon representing at least one of an emotion of the user and an environment around the terminal may be determined. Further, a graph that is created based on the plurality of pieces of situation data may be linked to the icon. In such a case, even if the plurality of pieces of situation data is extracted, an emotion of a representative user or a representative environment around the terminal may be represented by the icon. Further, by selecting the icon, the graph based on the situation data may be displayed. For example, a diary of a user who participated in a holiday event may be stored as a content in the server, and a plurality of pieces of situation data may be acquired in a time zone in which the user participates in the holiday event and stored in the server. In such a case, an icon representing an emotion of the user or an environment around the terminal may be displayed in the content stored by the user in the server. Then, by selecting the icon, a graph showing changes with time in emotions of the user or in the environment around the terminal in the time zone of the event may be displayed. Also in this case, an emotion of the representative user or the representative environment around the terminal may be visually conveyed by the icon. If a reader selects the icon, the graph may be displayed to visually show the emotions of the representative user or in the environment around the terminal in more detail. Thus, an amount of acquired information when the content is acquired may be reduced for readers who do not need detailed information. On the other hand, readers who wish to reference detailed information may reference the detailed situation data shown as a graph. Therefore, the content may be made friendlier with improved convenience in accordance with preferences of readers.

Further, in the situation presentation system according to the present disclosure, link information indicating a location of an icon representing the inferred emotion of the user or environment around the terminal may be added to a predetermined character string contained in a content. In such a case, by selecting a character string, a user may cause the icon representing the emotion of the user or the environment around the terminal to be displayed. Then, the emotion of the user who stored the content in the server and the environment around the terminal may visually be conveyed. Because only interested readers may cause an icon to be displayed by selecting the character string to which a link is added, an amount of acquired information when a content is acquired may be reduced for readers who do not need to reference the icon. On the other hand, readers who wish to know the emotion of the user or the environment around the terminal may reference the icon and thus, the content may be made friendlier with improved convenience in accordance with preferences of readers.

Further, in the situation presentation system in the present disclosure, when a plurality of pieces of situation data are extracted, typical situation data, which is representative situation data, may be computed from the plurality of pieces of extracted situation data. Then, based on the typical situation data, an icon representing at least one of an emotion of the user and an environment around the terminal may be determined. In such a case, even if the plurality of pieces of situation data are extracted, emotion of the representative user or the environment around the terminal may be represented by an icon.

Further, in the situation presentation system in the present disclosure, when a plurality of pieces of situation data are extracted, a graph may be created based on the plurality of pieces of situation data, added to a content, and then the content may be updated. In such a manner, the following effects may be achieved. For example, a diary of holiday event news may be stored in the server as a content, and position information of an event site of the holiday event and time information when the holiday event is held may be extracted from the content. In such a case, situation data of users who participated in the holiday event may be acquired. Then, a graph may be created based on such situation data and added to the content. In such a case, for example, emotions of users who participated in the holiday event and surrounding situations of the event site may be displayed chronologically. Thus, in which time zone participants were excited or the event site was crowded, for example, may visually be grasped using a graph or the like. Therefore, when compared with a news article of the holiday event consisting of letters only, a substance of the content may be conveyed to readers more realistically.

Further, in the situation presentation system according to the present disclosure, when a plurality of pieces of situation data are extracted, a graph may be created based on the plurality of pieces of situation data and linked to a predetermined character string included in the content, and the content may be updated. In such a manner, the following effects may be achieved. For example, a diary of holiday event news is stored in the server as a content, and position information of an event site of the holiday event and time information when the holiday event is held are extracted from the content. In such case, situation data of users who participated in the holiday event may be acquired. Then, a graph may be created based on such situation data and linked to a predetermined character string of the content. An amount of acquired information when the content is acquired may be reduced for readers who need not reference the emotions of the users or the environment around the terminal. On the other hand, readers who wish to reference the emotions of the users or the environment around the terminal may reference the detailed situation data shown as the graph. Thus, the content may be made friendlier with improved convenience in accordance with preferences of readers.

Further, in the situation presentation system according to the present disclosure, a server transmission server transmission device that transmits extracted situation data or edited data added to a content to a terminal may be provided. In such a case, the user of the terminal may know what information is added to the content.

Further, in the situation presentation system according to the present disclosure, a Weblog content including an entry, a comment, and a trackback may be employed as a content. In such a case, information about an emotions of a user and the like and an environment around the terminal may be added to the Weblog content. Thus, a substance of the Weblog content may be conveyed to readers more realistically.

Further, in the situation presentation system according to the present disclosure, a character string of a comment may be analyzed, and information about an emotion of a user who posted the comment or an environment around the terminal may be added also to the comment. In such a case, a substance of the comment may also be conveyed to readers more realistically.

Further, in the situation presentation system according to the present disclosure, a correspondence between a Weblog content and terminal identification information of the terminal held by the author who created the Weblog content may be stored. Then, when the Weblog content is updated, a combination including the terminal identification information of the terminal held by the author may be determined as a situation data condition. Accordingly, situation data obtained from the terminal of the author may be extracted.

Further, in the situation presentation system according to the present disclosure, if an entry with a predetermined substance is stored into the server, the server may transmit situation data of the user of the content within a predetermined time from the time when the entry is stored to a communication terminal specified by the user. Thus, for example, if a user wishes to edit a diary while reflecting on changes of emotions in a day or changes of the environment in a day and updates a blank entry, situation data in the day may be transmitted from the server. Thus, the user may edit the diary while referencing the transmitted situation data.

Further, according to the server in the present disclosure, a character string of a content stored in the server may be analyzed to determine situation data condition, which is a condition for extracting situation data of a content. Then, situation data satisfying the situation data condition may be extracted from the situation data stored in the server, and the extracted situation data or edited data obtained by performing editing processing on the extracted situation data by a predetermined method may be added to the content. Thus, body information and emotion information of the user and surrounding information and environment information of the terminal may automatically be added to the content. Therefore, situation data suitable to the content may be added without a user's work such as selecting and registering suitable information.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A situation presentation system comprising a terminal and a server that accumulates information transmitted from the terminal, wherein:
the terminal includes:
a situation data acquisition device that acquires situation data including at least one of body information of a user holding the terminal, emotion information inferred from the body information, surrounding information of the terminal, and environment information inferred from the surrounding information; and
a terminal transmission device that transmits the situation data acquired by the situation data acquisition device and terminal identification information to the server, the terminal identification information being information to distinguish the terminal from other terminals, and
the server includes:
a server situation data storage device that stores the situation data transmitted from the terminal transmission device;
a content storage device that stores a content including a character string;
a condition determination device that analyzes the character string included in the content stored in the content storage device to determine a situation data condition, the situation data condition being an extraction condition for extracting the situation data;
a situation data extraction device that extracts the situation data that satisfies the situation data condition determined by the condition determination device as extracted situation data from the situation data stored in the server situation data storage device;
a content update device that stores the content analyzed by the condition determination device into the content storage device after adding at least one of edited data and the extracted situation data extracted by the situation data extraction device to the content, the edited data being obtained by performing editing processing on the extracted situation data by a predetermined method; and
a presentation device that presents the content stored in the content storage device.

2. The situation presentation system according to claim 1, wherein:
the server includes a content server and a management server;
the content server includes:
the content storage device;
the condition determination device; and
a situation data condition transmission device that transmits the situation data condition determined by the condition determination device to the management server, and
the management server includes:
the server situation data storage device;
a situation data condition reception device that receives the situation data condition transmitted from the content server;
the situation data extraction device that extracts the situation data that satisfies the situation data condition received by the situation data condition reception device as the extracted situation data from the situation data stored in the server situation data storage device; and
an extracted situation data transmission device that transmits the extracted situation data extracted by the situation data extraction device to the content server, and
the content server further includes:
an extracted situation data reception device that receives the extracted situation data transmitted from the management server;
the content update device that stores the content analyzed by the condition determination device into the content storage device after adding at least one of the edited data and the extracted situation data received by the extracted situation data reception device to the content; and
the presentation device.

3. The situation presentation system according to claim 1, wherein:
the server further includes an analysis dictionary storage device that stores at least one of a correspondence between a character string and position information, a correspondence between a character string and time information, and a correspondence between a character string and the terminal identification information; and
the condition determination device includes:
an information extraction device that compares the character string included in the content stored in the content storage device and the character string stored in the analysis dictionary storage device to extract any of the position information, the time information, and the terminal identification information that corresponds to the character string included in the content; and
a situation data determination device that determines the situation data using at least one of the position information, the time information, and the terminal identification information extracted by the information extraction device.

4. The situation presentation system according to claim 3, wherein the combination device determines a combination of the position information and the time information as the situation data condition, if the position information and the time information are extracted by the information extraction device.

5. The situation presentation system according to claim 1, wherein
the server includes a statistical processing device that performs statistical processing on the extracted situation data extracted by the situation data extraction device, if a plurality of pieces of the situation data are extracted by the situation data extraction device as the extracted situation data; and
the content update device includes a statistical processing addition device that stores the content analyzed by the condition determination device into the content storage device after adding at least one of the edited data and the extracted situation data on which the statistical processing has been performed by the statistical processing device to the content.

6. The situation presentation system according to claim 1, wherein the terminal transmission device transmits the situation data to the server each time the situation data acquisition device acquires the situation data.

7. The situation presentation system according to claim 1, wherein:
the terminal includes a terminal situation data storage device that stores the situation data acquired by the situation data acquisition device; and
the terminal transmission device transmits a predetermined number of pieces of the situation data that have not yet been transmitted to the server, if the predetermined number of pieces of the situation data that have not yet been transmitted are stored in the terminal situation data storage device.

8. The situation presentation system according to claim 1, wherein:
the terminal includes a terminal situation data storage device that stores the situation data acquired by the situation data acquisition device;
the server includes a non-transmission inquiry device that makes an inquiry about whether or not the situation data that has not yet been transmitted to the server is stored in the terminal situation data storage device; and
the terminal transmission device transmits the situation data stored in the terminal situation data storage device that has not yet been transmitted to the server, if the inquiry is received from the non-transmission inquiry device of the server.

9. The situation presentation system according to claim 1, wherein:
the terminal includes a terminal situation data storage device that stores the situation data acquired by the situation data acquisition device; and
the terminal transmission device transmits the situation data that is stored in the terminal situation data storage device and that has not yet been transmitted each time a predetermined time passes.

10. The situation presentation system according to claim 1, wherein:
the terminal further includes:
a body information acquisition device that acquires the body information of the user holding the terminal;
an emotion information table storage device that stores an emotion information table that associates the body information acquired by the body information acquisition device and the emotion information of the user inferred from the body information; and
an emotion information determination device that compares the body information acquired by the body information acquisition device and the emotion information table stored in the emotion information table storage device to determine the emotion information of the user inferred from the body information, and
the situation data acquisition device acquires at least the emotion information of the user determined by the emotion information determination device as the situation data.

11. The situation presentation system according to claim 1, wherein
the terminal further includes:
a surrounding information acquisition device that acquires the surrounding information around the terminal;
an environment information table storage device that stores an environment information table that associates the surrounding information acquired by the surrounding information acquisition device and the environment information around the terminal inferred from the surrounding information; and
an environment information determination device that compares the surrounding information acquired by the surrounding information acquisition device and the environment information table stored in the environment information table storage device to determine the environment information around the terminal inferred from the surrounding information, and
the situation data acquisition device acquires at least the environment information around the terminal determined by the environment information determination device as the situation data.

12. The situation presentation system according to claim 1, wherein:
the server further includes:
an icon storage device that store an icon table that associates the extracted situation data and an icon representing at least one of an emotion of the user and an environment around the terminal; and
an icon determination device that compares the extracted situation data extracted by the situation data extraction device and the icon table stored in the icon storage device to determine the icon corresponding to the extracted situation data, and
the content update device includes an icon addition device that stores the content into the content storage device after adding the icon determined by the icon determination device to the content as the edited data.

13. The situation presentation system according to claim 12, wherein:
the server includes a graph creation device that creates a graph based on a plurality of pieces of the extracted situation data, if the plurality of pieces of the extracted situation data are extracted by the situation data extraction device; and
the content update device includes a graph link device that stores the content to which the icon is added by the icon addition device into the content storage device after adding link information indicating a location of the graph created by the graph creation device to the icon.

14. The situation presentation system according to claim 1, wherein:
the server includes:
an icon storage device that stores an icon table that associates the extracted situation data and an icon representing at least one of an emotion of the user and an environment around the terminal; and
an icon determination device that compares the extracted situation data extracted by the situation data extraction device and the icon table stored in the icon storage device to determine the icon corresponding to the extracted situation data, and
the content update device includes an icon link device that stores the content into the content storage device after adding link information indicating a location of the icon determined by the icon determination device to a predetermined character string included in the content.

15. The situation presentation system according to claim 12, wherein:
the server includes an computation device that computes typical situation data based on a plurality of pieces of the extracted situation data, if the plurality of pieces of the situation data are extracted by the situation data extraction device as the extracted situation data, the typical situation data being representative extracted situation data, and
the icon determination device compares the typical situation data computed by the computation device and the icon table stored in the icon storage device to determine the icon corresponding to the typical situation data.

16. The situation presentation system according to claim 1, wherein:
the server includes a graph creation device that creates a graph based on a plurality of pieces of the extracted situation data, if the plurality of pieces of the extracted situation data are extracted by the situation data extraction device; and
the content update device includes a graph addition device that stores the content into the content storage device after adding the graph created by the graph creation device to the content as the edited data.

17. The situation presentation system according to claim 1, wherein:
the server includes a graph creation device that creates a graph based on a plurality of pieces of the extracted situation data, if the plurality of pieces of the extracted situation data are extracted by the situation data extraction device; and the content update device includes graph link device that stores the content into the content storage device after adding link information indicating a location of the graph created by the graph creation device to a predetermined character string included in the content.

18. The situation presentation system according to claim 1, wherein the server includes a first server transmission device that transmits at least one of the extracted situation data and the edited data added to the content by the content update device to the terminal.

19. The situation presentation system according to claim 1, wherein the content stored in the content storage device is a Weblog content including an entry, a comment and a trackback.

20. The situation presentation system according to claim 19, wherein:
the condition determination device analyzes the character string included in the comment of the Weblog content stored in the content storage device to determine the situation data condition, and
the content update device stores the comment analyzed by the condition determination device into the content storage device after adding at least one of the edited data and the extracted situation data extracted by the situation data extraction device to the comment.

21. The situation presentation system according to claim 19, wherein:
the server includes a terminal identification information storage device that stores a correspondence between the Weblog content and the terminal identification information of the terminal held by an author who created the Weblog content; and
the condition determination device determines the terminal identification information corresponding to the Weblog content stored in the terminal identification information storage device as the situation data condition.

22. The situation presentation system according to claim 19, wherein:
the server includes a terminal identification information storage device that stores a correspondence between the Weblog content and the terminal identification information of the terminal held by an author who created the Weblog content;
the condition determination device determines time information that indicates a time within a predetermined time from a time when the Weblog content was stored in the content storage device and the terminal identification information corresponding to the Weblog content stored in the terminal identification information storage device as the situation data condition, if the condition determination device analyzes that the entry of the Weblog content has includes a predetermined substance; and
the server includes a second server transmission device that transmits the extracted situation data extracted by the situation data extraction device to a communication terminal specified by the author who created the Weblog content.

23. A server that accumulates information transmitted from a terminal, comprising:
a situation data storage device that stores situation data transmitted from the terminal, the situation data including at least one of body information of a user holding the terminal, emotion information inferred from the body information, surrounding information of the terminal, and environment information inferred from the surrounding information;
a content storage device that stores a content including at least a character string;
a condition determination device that analyzes the character string included in the content stored in the content storage device to determine at least one situation data condition, the situation data condition being an extraction condition for extracting the situation data;
a situation data extraction device that extracts the situation data that satisfies the situation data condition determined by the condition determination device as extracted situation data from the situation data stored in the server situation data storage device;
a content update device that stores the content analyzed by the condition determination device after adding at least one of edited data and the extracted situation data extracted by the situation data extraction device, the edited data being obtained by performing editing processing on the extracted situation data by a predetermined method; and
a presentation device that presents the content stored in the content storage device.

24. A computer program product comprising a computer-readable medium storing computer readable instructions, wherein execution of the computer readable instructions causes a controller of a server that accumulates information transmitted from a terminal to perform the steps of:
analyzing a character string included in a content stored in a content storage device to determine at least one situation data condition, the situation data condition being an extraction condition for extracting situation data from a situation data storage device, the situation data storage device storing situation data transmitted from the terminal, the situation data including at least one of body information of a user holding the terminal, emotion information inferred from the body information, surrounding information of the terminal, and environment information inferred from the surrounding information;
extracting the situation data that satisfies the determined situation data condition as extracted situation data from the situation data stored in the situation data storage device;
storing the analyzed content after adding at least one of edited data and the extracted situation data, the edited data being obtained by performing editing processing on the extracted situation data by a predetermined method; and
presenting the content stored in the content storage device.
